(19) United States
(12) Patent Application Publication
(10) Pub. No.: US 2015/0310179 A1
(43) Pub. Date: Oct. 29, 2015

(54) SYSTEM AND METHOD THAT APPLIES RELATIONAL AND NON-RELATIONAL DATA STRUCTURES TO MEDICAL DIAGNOSIS

(71) Applicant: Vipindas Chengat, St. Louis, MO (US)

(72) Inventors: Vipindas Chengat, St. Louis, MO (US); Gayatri Vengayil, St. Louis, MO (US); Sunjith Parapurath Sukumaran, Kochi (IN)

(73) Assignee: Vipindas Chengat, St. Louis, MO (US)

(21) Appl. No.: 14/694,214

(22) Filed: Apr. 23, 2015

Related U.S. Application Data
(60) Provisional application No. 61/982,964, filed on Apr. 23, 2014.

(51) Int. Cl. G06F 19/00

(52) U.S. Cl. CPC G06F 19/345

(57) ABSTRACT

A medical diagnosis system comprises one or more databases configured to store a plurality of relational tables within a relational data structure and a non-relational table within a non-relational data structure. The plurality of relational tables comprise a symptom table configured to associate a plurality of symptoms having symptom name fields with a corresponding plurality of symptom identifier fields (Symptom ID). A cause table is configured to associate a plurality of causes having caused name fields with a corresponding plurality of cause identifier fields (Cause ID). A symptom-cause relational table is linked to the symptom table and the cause table to associate the plurality of cause identifier fields with the plurality of symptom identifier fields. The plurality of symptom identifier fields comprise first foreign keys that link the symptom table to the symptom-cause relational table. The plurality of symptom identifier fields comprise second foreign keys that link the cause table to the symptom-cause relational table. One or more processors provide interfaces for receiving one or more symptom names and presenting one or more cause names based on associations of symptom names and cause names in the non-relational table. The associations of symptom names and cause names in the non-relational table are derived from mapping the plurality of cause name fields in the cause table and the plurality of symptom name fields in the symptom table into the non-relational table. The mapping being based on the association of the plurality of cause identifier fields with the plurality of symptom identifier fields in the symptom-cause relational table.

### CROSS-REFERENCE TO RELATED APPLICATION

This application claims priority to U.S. Provisional Appl. No. 61/982,964 filed Apr. 23, 2014, which is hereby incorporated by reference in its entirety.

### FIELD OF THE INVENTION

The present disclosure generally relates to medical diagnostic systems and, more specifically, to a system that enables optimal clinical decision-making.

### BACKGROUND OF THE INVENTION

When a patient interacts with a physician, a patient typically presents a multitude of symptoms. Some symptoms are more indicative than others of a certain cause, diagnosis, diseases or disorder, which are used interchangeably in the present specification. Patient specific demographic characteristics or markers, e.g., age, sex, geographical location, past medical history, etc., can also influence the meaning and weight of certain symptoms. Furthermore, many diseases/causes present similar symptoms. Indeed, one symptom could be linked to a large number of causes, and likewise one cause could be associated with a large number and combination of varying symptoms. Thus, it is important for physicians to be able to distinguish between the symptoms that are absolutely necessary to consider a cause versus the symptoms that are merely distractions.

Differential diagnosis, also known as DDx, is a method of distinguishing a particular disease from others that present similar symptoms. Differential diagnostic procedures are used by physicians and other trained medical professionals to diagnose the specific disease in a patient, or, at least, to eliminate any imminently life-threatening conditions. For example, bronchitis could be a differential diagnosis in the evaluation of a cough that ends up with a final diagnosis of common cold.

More generally, a differential diagnostic procedure is a systematic diagnostic method used to identify the presence of a cause where multiple alternatives are possible. This method is essentially a process of elimination or at least a process of obtaining information that shrinks the “probabilities” of candidate conditions to negligible levels, by using evidence such as symptoms, patient history, and medical knowledge to adjust epistemic confidences in the mind of the diagnostician. A more comprehensive description of DDx is found in http://en.wikipedia.org/wiki/Differential_diagnosis.

Various computerized or computer-assisted diagnosis systems and methods are known. For example, US Patent Publication No. 2010/0017225 issued to Oakley et al. discloses a diagnostician customized medical diagnostic apparatus using a digital library. US Patent Publication No. 2011/0124975 issued to Thompson discloses a method for medical diagnosis utilizing PDA software robots. U.S. Pat. No. 8,337,409 issued to Iliff discloses a computerized medical diagnostic system utilizing list-based processing. US Patent Publication No. 2013/0268203 issued to Pyloth discloses a system and method for disease diagnosis through iterative discovery of symptoms using matrix based correlation engine. U.S. Pat. No. 8,949,136 issued to Heyman et al. discloses a method for on-line prediction of medical diagnosis. U.S. Pat. No. 9,005,119 issued to Iliff discloses computerized medical diagnostic and treatment advice system including network access.

The direct or indirect relationships between symptoms and causes are used for determining what the most probable causes are for a given patient's symptoms. However, the vast amount of medical information available makes it extremely difficult, if not impossible, for physicians to maintain it in their memory, process it, and apply it all at the point of care when diagnosing a patient. Moreover, in practice, physicians are at risk of cognitive errors in clinical decision-making. For example, premature closure errors are common when physicians make a quick diagnosis, often based on pattern recognition such as choosing the statistically common cause among a population based on set of symptoms, rather than considering what is most likely for the specific individual who is presenting with the symptoms. Studies suggest that more medical errors involve cognitive error rather than lack of knowledge or information. The search for improved systems for diagnosing patients is constant. Ultimately the known systems appear improvable such as in terms of the efficiency, data processing structure and versatility.

Accordingly, there exists a need for a medical diagnosis system, which can process data associated with a very large number of patients, e.g., millions, in efficient and scalable manner to provide accurate diagnosis.

### BRIEF DESCRIPTION OF THE DRAWINGS

FIG. 1 shows a block diagram of a Software As A Service (SaaS) platform offering diagnosis service embodying various features of the present invention.

FIG. 2 shows a block diagram of a system that processes diagnosis and treatment information based on relational and non-relational data structures.

FIGS. 3A-3C show diagrams of relational and non-relational data structures.

FIG. 4 shows the relational and non-relational database structures applied to questions asked from patients based on their symptoms.

FIG. 5 is a screen shot of the first input page of the user interface where a user can enter a symptom in the search plugin.

FIG. 6 is the first input page of the user interface described in FIG. 1, which shows a drop down list of symptom suggestions as a user is typing a symptom in the search plugin.

FIG. 7 is the second input page of the user interface, where the user inputs additional symptom, symptom characteristic (duration), and markers (age, sex, location, and past medical history) once a symptom is selected.

FIG. 8 is the output page of the user interface, which lists all possible causes for the symptoms, based on user input and presents various feedback buttons for every symptom.

FIG. 9 is the output page of the user interface described in FIG. 4, which shows a pop-up feedback screen when the user clicks on the “Train the system” feedback button.

FIG. 10 is the output page of the user interface described in FIG. 4, which shows a pop-up feedback screen when the user clicks on the “Train the system” feedback button for a specific symptom.

FIG. 11 is the output page of the user interface described in FIG. 4, which shows a pop-up feedback screen when the user clicks on the “Translation or synonyms” feedback button.

FIG. 12 is the output page of the user interface described in FIG. 4, which shows a pop-up feedback screen when the user clicks on the “Problem-list” feedback button.

FIG. 13 is the output page of the user interface described in FIG. 4, which shows a pop-up feedback screen when the user clicks on the “This is one of the diseases I expected” feedback button.

FIG. 14 is a screen shot of the home page of the administrative interface.

FIG. 15-17 are screenshots of the administrator interface where an administrator can create and edit symptoms for user selection, synonyms of symptoms, and categorize them.

FIG. 18-20 are screenshots of the administrator interface where an administrator can create and edit symptom-cause relations as well as symptom-cause exclusions.

FIG. 21-22 are screenshots of the administrator interface where an administrator can create and edit questions, identify symptom-question relations, as well as question exclusion rules.

FIG. 23 is a screenshot of the administrator interface where an administrator can create and edit replacement rules for symptoms in accordance to user answers.

FIG. 24 is a screenshot of the administrator interface where an administrator can create and edit a likelihood ratio for a cause when a particular symptom is absent.

FIG. 25 is a screenshot of the administrator interface where an administrator can create and edit durations available for symptoms and their relations.

FIG. 26-28 are screenshots of the administrator interface where an administrator can create and edit causes, synonyms of causes, categorize them, mark them as life threatening, and link them to any symptom it represents.

FIG. 29 is a screenshot of the administrator interface where an administrator can create and edit parent-child relation of causes for organizing the causes in a hierarchy.

FIG. 30 is a screenshot of the administrator interface where an administrator can create and edit questions, identify cause-question relations, and mark questions high risk if necessary.

FIG. 31-32 are screenshots of the administrator interface where an administrator can specify the pre-test probability, a value between 0 and 100, for a cause when a symptom is present.

FIG. 33 is a screenshot of the administrator interface where an administrator can create and edit likelihood ratios to control how the post-test probability of a cause changes when a particular question is answered.

FIG. 34-35 are screenshots of the administrator interface where an administrator can assign scoring systems to causes.

FIG. 36 is a screenshot of the administrator interface where an administrator can assign the treatments that are available for a cause.

FIG. 37 is a screenshot of the administrator interface where an administrator can assign the surgeries that are required to be performed for a cause.

FIG. 38 is a screenshot of the administrator interface where an administrator can assign the complications associated with a cause.

FIG. 39 is a screenshot of the administrator interface where an administrator can assign the durations for causes.

FIG. 40-41 are screenshots of the administrator interface where an administrator can assign a likelihood ratio to a cause when another cause or medication exists in the past medical history of the patient.

FIG. 42-43 are screenshots of the administrator interface where an administrator can create questions that the system needs to ask, answer options for each question, and categorize them.

FIG. 44 is a screenshot of the administrator interface where an administrator can configure the answers of questions, link answers to symptoms, past medical history, family history, medication history, and sort answer order display.

FIG. 45 is a screenshot of the administrator interface where an administrator can create and edit inferences for causes.

FIG. 46-47 are screenshots of the administrator interface where an administrator can create and edit treatments and categorize them.

FIG. 48 is a screenshot of the administrator interface where an administrator links treatments to causes.

FIG. 49-51 are screenshots of the administrator interface where an administrator can create and edit surgeries, categorize them, and link them to causes.

FIG. 52-55 are screenshots of the administrator interface where an administrator can create and edit lab tests, categorize them, and enter lab costs for countries and locations for estimating lab costs.

FIG. 56-58 are screenshots of the administrator interface where an administrator can enter information regarding lab results.

FIG. 59 is a screenshot of the administrator interface where an administrator links the variation of lab result from normal values to the related symptom.

FIG. 60-61 are screenshots of the administrator interface where an administrator can create an ACLS algorithm to create an alert based on vital rules, which trigger an emergency situation.

FIG. 62-64 are screenshots of the administrator interface where an administrator can create lab rules associated with a pattern, which triggers auto-answer for particular questions when that pattern in recognized in a lab result.

FIG. 65-67 are screenshots of the administrator interface where an administrator can create and edit medications, medication trade names, and categorize them.

FIG. 68 is a screenshot of the administrator interface where an administrator enters multiple variants of a medications trade name, which shows the dosage unit.

FIG. 69 is a screenshot of the administrator interface where an administrator can enter contraindications, which disqualifies a valid medication for a condition based on age range and gender of the patient.

FIG. 70 is a screenshot of the administrator interface where an administrator can enter interactions between medication chemicals, which can be mild or severe.

FIG. 71-72 are screenshots of the administrator interface where an administrator lists corresponding medication for each cause as well as dosage formulas, which will determine the dosage of medication based on lab values.

FIG. 73 is a screenshot of the administrator interface where an administrator can enter side effects of medicines.

FIG. 74 is a screenshot of the administrator interface where an administrator can look up or create relations of the following types: result relation, question relation, inference relation, risk relation, likelihood ratio relations, and context relations.

FIG. 75 is a screenshot of the administrator interface where an administrator can create profile cause relations, which will apply a likelihood ratio to a cause in the possible cause list based on patient profile information.

FIG. 76-77 are screenshots of the administrator interface where an administrator can create physical examinations, categorize them, and link them to answers of questions.

FIG. 78 is a screenshot of the administrator interface where an administrator can create physical examination cause relations, which will apply a likelihood ratio to a cause in the possible cause list.

FIG. 79 is a screenshot of the administrator interface where an administrator can create and edit family history conditions.

FIG. 80-81 are screenshots of the administrator interface where an administrator can create and edit discharge instructions to be given to a patient at discharge time, which can be medicine, lab, activity, etc., and assign these instructions to causes with frequency and duration.

FIG. 82 is a screenshot of the administrator interface where an administrator can create and edit instructions different than discharge instructions to be given to a patient to act on when certain conditions are encountered.

FIG. 83-84 are screenshots of the administrator interface where an administrator can create and edit feedback types and options, which allow users to give feedback about the system for continual improvement.

### DETAILED DESCRIPTION OF THE INVENTION

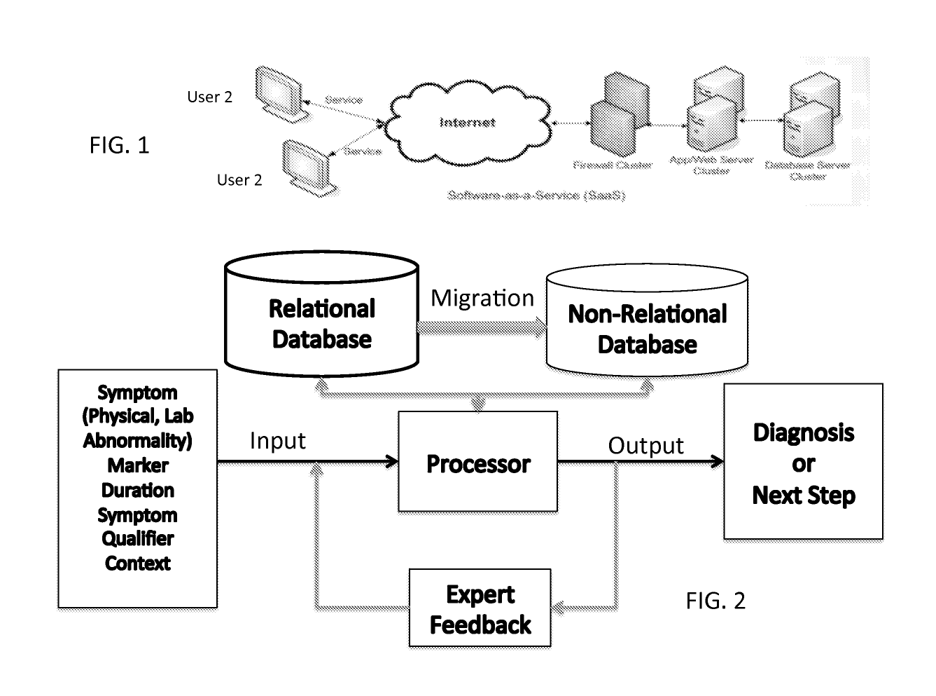

FIG. 1 shows a block diagram of a Software-As-A-Service (SaaS) platform offering medical diagnosis services embodying various features of the present invention. The SaaS platform has a back-end comprising an Application/Web Server Cluster of one or more servers, comprising one or more processors, which communicates with a Database Server Cluster of one or more relational and non-relational database structures. The SaaS platform offers a front-end used by various users, e.g., User 1 and User 2, over the Internet, preferably, via a firewall Cluster of one or more firewalls that protect privacy in exchange of medical information via various VPN and data encryption methods. The users of the SaaS platform can be individual patients, healthcare professionals, e.g., doctors and nurses, as well as system administrators, among others. In one embodiment, the SaaS platform is offered by Physician Cognition™ at the following domain: http://www.physiciancognition.com. One or more users can subscribe to the service and interface with the system via a web browser or applications software executed in user devices. Any types of suitable user devices can interface with the system, including wired or wireless personal computers, workstations, laptops, tablets, mobile devices, smart phones, etc. Any user that subscribes to the service can create its own user profile on the system. Such user profiles can include user identification information, demographics, age, sex, geographical location, medical information and history, lab results, etc., as further described below.

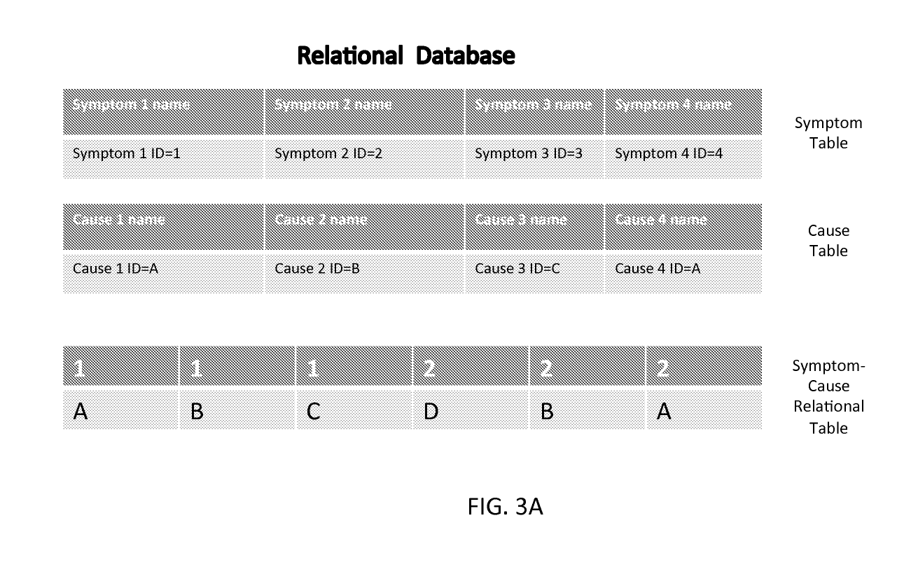

FIG. 2 shows a block diagram of a system that mimics the cognitive strategies that a physician would use to make a diagnosis and treatment. As further described below, the system applies relational and non-relational database structures to a healthcare computer algorithm (HCA) that makes diagnosis processes fast, efficient and scalable to handle millions of users per second and provide fast responses. The system can also provide application programming interface (API) access and can integrate with third party APIs to be able to collaborate with other healthcare software.

More specifically, a medical diagnosis system according to the present invention comprises one or more databases configured to store a plurality of relational tables within a relational data structure and a non-relational table within a non-relational data structure. As further described below, the plurality of relational tables comprise a symptom table configured to associate a plurality of symptom name fields with a corresponding plurality of symptom identifier fields. A cause table is configured to associate a plurality of cause name fields with a corresponding plurality of cause identifier fields. A symptom-cause relational table is linked to the symptom table and the cause table to associate the plurality of cause identifier fields with the plurality of symptom identifier fields. The non-relational table associates the symptom names and cause names. One or more processors provide interfaces for receiving one or more symptom names and presenting one or more cause names based on associations of symptom names and cause names in the non-relational table

The one or more processors also provide various interfaces, including user interfaces as will as interfaces with the one or more databases for accessing relevant information. The processors can also interface with third party data centers to securely access medical records and lab results, etc. The one or more processor (the processor) can be implemented in servers as one or more hardware, CPUs, virtual machines, threads, etc. The processor receives input comprising one ore more of symptoms, markers, symptom durations, symptom qualifiers and symptom contexts associated with a large number of individual patients. As herein used, a symptom is a physical sign, e.g., headache, or a lab abnormality, e.g., low sodium, associated with an individual patient, which requires an evaluation to look for a cause or diagnosis. Markers, some of which relate to demographics, comprise one or more of age, geography/location, sex, and past medical history of a patient, among others. A symptom qualifier is high value data related to a symptom, which can be used to make a diagnosis, for example, the worse headache in a patient's life. A symptom context is the circumstances under which a symptom occurs, for example, a headache right after being bitten by a snake.

There are various types of symptoms. A cardinal symptom is the primary or major clinical sign symptom by which a diagnosis is made. Clusters of signs or symptoms are often combined to better diagnose a specific disease, syndrome, cause or sub-cause. A specific symptom has certain characteristics, namely, it can be a localized symptom in an anatomical area, for example pain in the eye, or it can be a unique set of symptoms, for example, a seizure and leg pain together. When a symptom is specific, probabilities of all causes or sub-causes related to that symptom are higher. Other symptom characteristics are durations and patterns of symptoms, e.g., how long a symptom occurs or how many times a symptom recurs.

Absent symptoms are symptoms that are not present and could be used in diagnosis exclusion rules, as further described below. The processor accesses exclusion causes and rule tables, which contain fields for exclusion causes based on the presence or absence of one or more symptoms. For example, if a patient has normal TSH, then hypothyroidism is excluded from the evaluation. In this way, possible causes are determined by removing exclusion causes from symptom causes.

Contrary or negative symptoms are used to reduce the probability of a cause. A negative symptom is a symptom that is contrary to the given symptom. For example, Hemoglobin decrease is caused by bleeding, while Hemoglobin increase is caused by Polycythemia. When there is evaluation of “hemoglobin-decreased”, the probability of all the causes of “hemoglobin-increased” goes down. Preferably, the probability of the cause of a contrary symptom is not set to zero to account for rare conditions.

The processor outputs one or more causes or diagnosis based on inputted symptoms and likelihood/probability of relations between them. For example, symptoms 1, 2, 3, 4 can be associated with diagnoses A, B, C and D and their associated probability. If a patient has cough, fever, and muscle pain, the probability of having flu is higher than lung cancer.

The processor can find the most probable cause for the given symptoms based on patient profile parameters. The patient profile parameters could be anything that is relevant in a symptom the evaluation of the symptom, for example, gender; context of the symptom; recent activity; or geographic location, among others. If symptoms are present at the same time with specificity to a demographic marker, e.g., geography, then there can be different causes that are more or less likely. Similarly, age group marker can increase or decrease the probability of a cause.

The processor calculates the probability of a cause occurrence based on the number of symptoms that are present for a given cause or disorder and information contained within the system. For example, a cause pre-test or post-test probability can be fetched from a relevant database for determining the probability of a target disorder, before a diagnostic test result is known.

In one embodiment, the probability of causes is based on likelihood ratios for questions answered in previous steps. If a scoring system, such as Well's score or EGSYS score, is used where scores are related to any cause in the cause table, then the processor finds the questions related to the scoring system. If any cause in the cause table has relation to the absence of a symptom and that symptom is not present in the symptom table, the processor finds questions with answers related to such symptoms. The questions include questions generated based on the scoring systems; lab values; physical examinations; patient profile information; context; past medical history; medications; and family history. The processor removes questions that have an exclusion rule because certain questions are not relevant in certain conditions. For example, for hypercalcemia, the processor would present questions to determine whether it is associated with elevated parathyroid hormone or not. However, if the initial combination of symptoms/lab abnormalities are hypercalcemia and elevated Parathyroid hormone-related peptide, the initial question regarding parathyroid hormone becomes irrelevant. The processor sorts out the questions that are irrelevant and avoids them.

As stated above, tables are used in the databases of the system of FIG. 1 to structure data relationally and non-relationally based on data fields. As further described below, such tables include classic presentation symptoms table, profile cause relations table, cause inclusion and exclusions tables, symptom-questions table, question-answers table, answer table, physical signs and labs table, symptom-qualifier rules table, symptom replacement rules tables, a symptom replacement group table, medication side effects table, medication interactions table, context relation tables, geographic location to cause table, country to geographic location table, inference relations tables, cause-to-cause relation table, lab false positives and lab false negative table, negative symptom cause table, among others.

Tables are structured with data fields relating to parameters having 1) parameter names and 2) parameter identifiers. Examples of such parameters are symptoms, causes/sub-causes, questions, answers, relationships, rules, etc., each having an assigned name and an assigned identifier. Tables within the relational data structure are linked to each other based on fields that serve as candidate, primary and foreign keys and tables within the non-relational data structure are keyed based on direct index keys as further described below.

Data fields specified in the tables can be directly or indirectly related. For example, relationships between symptoms and causes can be specified by data fields that have direct or indirect relationship to each other. For example, a dry mouth symptom has a direct relationship to dehydration. However, the dehydration symptom is indirectly linked to kidney failure. In other words, if a patient has the dehydration symptom, the symptom can indirectly contribute to kidney failure. When there is indirect relationship between a symptom and a cause field, a plurality of steps are required for diagnosing the cause. In the foregoing example, the diagnosis of dehydration as a sub-cause is made first followed by diagnosis of kidney failure as cause.

Besides diagnosis or cause/sub-cause determination, the processor can output next step(s) for further evaluation of the individual patient, for example, additional questions that are answered by the patient and inputted into the system. The system of the present invention has interfaces for querying patients for their symptoms, receiving patient medical records, receiving patients' current or past lab results, receiving patient family history, age, sex, geography, questions, answers, rules, (e.g., exclusion/inclusion rules), symptom types, direct, indirect relationship types, etc. Based on such data, the processor fetches cause names and calculates the probability of a disorder or diagnosis and suggests a treatment for the disorder based on the calculated probability.

The system includes interfaces that present symptom questions to patients. Examples of symptom questions include: do you have a headache or when did your headache start? The processor finds whether there are any symptoms associated with the questions. For example, if a patient has a history of migraines, the process can determines whether any associated symptoms are present by asking relevant questions. The processor can also find out whether any lab history of the patient is present and accessible via electronic medical records stored in a local or remote database. Based on the answers, the processor executing the processor checks whether the associated symptom is a lab variation and if so, it adds the symptom to the list of symptoms.

The present invention processes medical information based on defined rules. For example, vital rules specify conditions of lab variations that are vital. As a part of diagnosis, the processor checks if any vital rule has been satisfied. If so, the processor displays the corresponding ACLS (Advanced Cardiac Life Support) algorithm. According to one feature, the processor finds variations of lab values found from patient lab history from normal values for respective labs and if there are any abnormalities, the related symptoms are added to a table of abnormal symptoms. All diagnoses or causes/sub-causes associated with a symptom are fetched based on various symptom tables, e.g., cardinal symptom table, specific symptom table, etc.

Via a feedback loop shown in FIG. 2, the processor can improve the HCA to very closely mimic the perfect clinical decision in any given clinical scenario by well defined large number of real time expert feedbacks and analysis of health care records. In one embodiment, the processor quantifies the differences in database fields that relate to opinions among experts to build an electronic health record that can recommend clinical decision-making steps in real time. Such quantification can be based on arbitrary initial scores/numbers/symbols, similar to known APGAR scoring system, which considers five (5) factors, namely, Appearance, Pulse rate, Grimace (reflex irritability) response to stimulation, Activity, Breathing effort, and assign a score of 0-2 to each one to provide child birth survival rate assessment. Based on received feedback, the processor derives at more and more objective scores from the arbitrary initial scores.

In one embodiment, the processor applies predictive analytics for clinical decision-making Such predictive analytics encompasses a variety of statistical techniques from modeling, machine learning, and data mining that analyze current and historical data for making predictions about future, or otherwise unknown, events. The predictive models exploit patterns found in historical data as well as current data to identify risks based on probabilities. These models capture relationships among relevant factors to allow assessment of risk associated with a particular set of conditions. A functional effect of these technical approaches is that predictive analytics provides a predictive score (probability) in order to determine, inform, or influence diagnosis processes that is applied across a very large numbers of patients.

The predictive analysis under the present invention defines decision points that are relevant to clinical decision-making by generating optimal pretest probabilities and likelihood ratios through analysis of information contained in a large database. The processor derives specific statistical (conditional probability) or non-statistical (pattern recognition) relations from the large database using predictive analysis. In this way, the processor converts an unstructured healthcare database to structured dataset using well-defined queries. The processor can use natural language processing to derive specific relations between symptoms, signs, labs results, diseases, rules, relationships, etc. The processor can learn accurate versus inaccurate decisions from electronic health records to rules in and rules out causes as the algorithm receives more data. In this way, clinical decision-making process is improved by having a system which any decision making errors can be converted into a universally acceptability clinical practice strategy. Indeed, the processor can access and learn from published clinical cases and have an ability to incorporate the clinical logic into the core algorithm so that the same clinical error in judgment will not happen again.

As it will become apparent below, the processor constantly processes additions, deletions, modifications or otherwise updating of system parameters, e.g., symptoms, causes, answers, questions, rules, etc. The present invention makes such processing fast, efficient and scalable using relational and non-relational data structures. The relational and non-relational data structure information and processing controls, further described below involve creating non-relational tables based on relational tables having fields relating to symptoms, diagnostics, causes/sub-causes having direct or indirect relationship with symptoms, markers, qualifiers, contexts, geography, sex, medical history, patterns, durations, lab information, results, amongst others. One or more such fields include the name or identity of a parameter, which is used as a candidate key in a table, a primary key in a relational data structure, and a foreign key that relates or otherwise links a plurality of tables to each other within a relational data structure that is efficiently and scalably updatable in order to create relational tables with fast query responses. The tables define relational fields in the relational data structure, which are used to create, convert, map or otherwise migrate to fields in a non-relational data structure that associates a plurality of relational fields to each other, for example using direct row indices.

Data migration is the process of transferring data between data structure types or formats. In a data migration, a relational data structure is mapped to a non-relational data structure utilizing suitable data extraction and data loading. Programmatic data migration may involve many phases but it minimally includes data extraction where relational data is read from the relational database and data loading where non-relational data is written to the non-relational database.

As shown in FIG. 2, the processor accesses relational and non-relational data structures containing relational and non-relational tables, which are designed based on queries, to efficiently and scalably speed up the diagnosis and cause determination process. According to this aspect of the present invention, a plurality of tables are created in a relational database structure, which are converted or otherwise migrated to a non-relational database structure to significantly decrease the amount of time required in responding to queries. In one embodiment, the processor provide interfaces for receiving one or more symptom names and presenting one or more cause names based on associations of symptom names and cause names in the non-relational table. The associations of symptom names and cause names in the non-relational table are derived from mapping the plurality of cause name fields in the cause table and the plurality of symptom name fields in the symptom table into the non-relational table. The mapping is based on the association of the plurality of cause identifier fields with the plurality of symptom identifier fields in the symptom-cause relational table, as further described below.

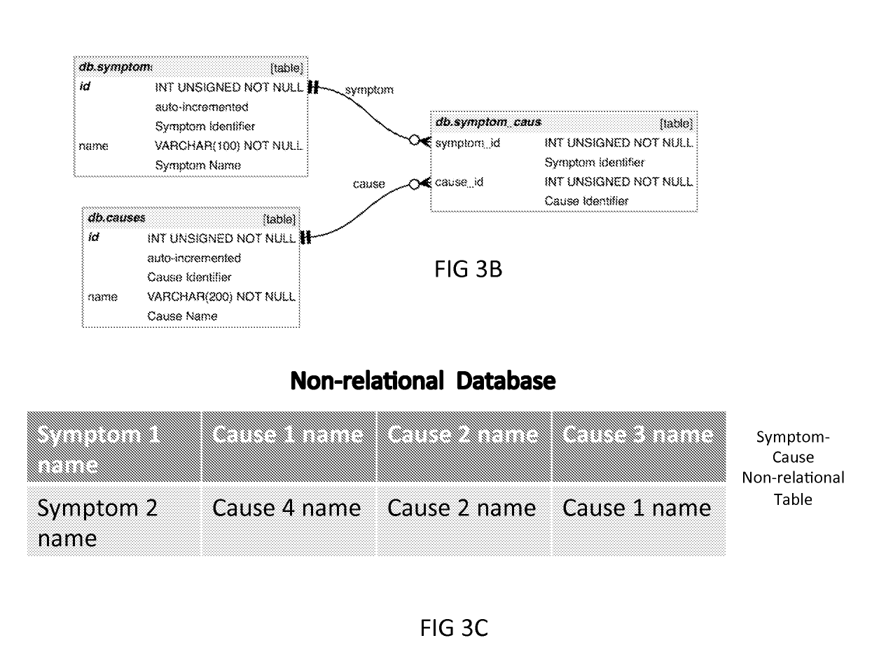

FIGS. 3A-3C show diagrams of data structures in relational and non-relational databases of the system of FIG. 2. As shown in FIG. 3A, in one example embodiment, the relational database contains three tables: 1) a symptom table, 2) a cause/diagnosis table and 3) a symptom-cause relational table. In a database, a row is a record or tuple that refers to an entry (or instance of an object) in the table. A column or field holds a value of a particular attribute of the table (or object). For example, for the symptom table, “ID” and “Name” are the names or titles of columns, as shown below:

Symptoms Table

| | Column 1 | Column 2 |
|---|---|---|
| | ID | Name |
| Row 1 | Symptom 1 ID = 1 | Symptom 1 name |
| Row 2 | Symptom 2 ID = 2 | Symptom 2 name |
| Row 3 | Symptom 3 ID = 3 | Symptom 3 name |
| Row 4 | Symptom 4 ID = 4 | Symptom 4 name |

As can be seen in FIG. 3 A, the symptom table has a number of columns fields that list symptom names values (e.g., symptoms 1 name, symptoms 2 name, symptoms 3 name and symptoms 4 name), and symptom ID values (e.g., symptoms 1 ID, symptoms 2 ID, symptoms 3 ID and symptoms 4 ID). For rows, associate or otherwise relate each symptom name with a corresponding symptom identifier. Each symptom identifier field is a candidate key in the symptom table that uniquely identifies a symptom. In the symptom table shown in FIG. 3A, number 1 identifies symptom 1, number 2 identifies symptom 2, number 3 identifies symptom 3 and number 4 identifies symptom 4. Similarly, the causes table has a number of columns that list cause names (e.g., cause 1 name, cause 2 name, cause 3 name and cause 4 name) and cause IDs. Four rows associate or otherwise relate or link each cause name with a corresponding cause identifier. Each cause identifier is a candidate key in the cause table that uniquely identifies a cause. In the cause table shown in FIG. 3A, letter A identifies cause 1, letter B identifies cause 2, letter C identifies cause 3 and letter D identifies cause 4. It would be appreciated that fields defining any parameter, e.g., symptom and cause names and identifiers, can be fields that containing any or number of letters, numbers, symbols or any combination of them as long as they can be recognized and processed by the processor of FIG. 2. In this example, the symptom identifiers and cause identifiers are the primary keys of reference throughout the relational database used for establishing relationships with other tables in the database.

As shown in FIG. 3A, the symptom-cause relation table has columns and row fields that define relations between symptom and cause identifiers. This table has a first row fields of symptom identifiers and a second row fields of cause identifiers, where symptom identifier number 1 in the first row and the first through third columns fields are related to Cause ID letters A, B and C in the second row fields. Similarly, symptom identifier number 2 in the first row and the fourth through sixth column fields is related to Cause ID letters D, B and A in the second row fields. Each symptom identifier, which is a primary key in the symptom table, is a foreign key that appears as a field in the symptom-cause relation table where the symptom table has a relationship to the symptom-cause relation table. Similarly, each cause identifier, which is a primary key in the cause table, is a foreign key that appears as a field in the symptom-cause relation table where the cause table has a relationship to the symptom-cause relation table. Under this arrangement, the relational data structure of FIG. 2 A uses B-tree indices that are optimized for reading and writing or otherwise updating large blocks of data that form a binary search tree in that a node can have no more than two children. FIG. 3B shows a schema database diagram of the relational database of FIGS. 3A and 3B. The use of rational data structure according to FIG. 3B allows for deletion, addition, modification, or updating of symptoms and causes by updating relevant relational tables. For example, addition, deletion or modification of a symptom requires updating the symptom table only. However, querying or joining three tables for determining association of a symptom with one or more causes in a relational database can be time consuming. For example, such determination in the data structure of FIG. 3B would require querying three tables. To speed up the amount of time necessary for responding to queries, the relational data structure of FIG. 3B is converted, mapped or otherwise migrated into to the non-relational database of FIG. 2.

FIG. 3C shows a symptom-cause non-relational table contained in the non-relational database, which is derived from conversion, mapping or migration of the relational database. The symptom-cause non-relational table comprises plurality of column and row field, where the first column field of the table is symptom name column listing symptom names in row fields. The remaining columns fields are cause name columns fields associated with each symptom name. As can be seen in FIG. 3C, the symptom names are highlighted because each reference a row or record in the non-relational database table. The first row field associates symptom 1 name with cause 1 name, cause 2 name and cause 3 name. The second row field associates symptom 2 name with cause 4 name, cause 2 name and cause 1 name. Under this arrangement, the symptom-cause non-relational table has a direct row key index.

By combining the relational and non-relational database structure according to FIGS. 3A, 3B and 3C, the present invention organizes data in manner that the processor can process data efficiently in a scalable manner. The direct row indexing speeds up data retrieval operations on the non-relational database tables. Indexes are used to quickly locate data without having to search every row in a database table every time the database table is accessed. In this way, the administration of data is greatly simplified by allowing easy updating of symptom-cause relationships via a relational data structure in a scalable manner, while significantly speeding up query responses using a non-relational data structure. For example, if both a child sub-cause and its parent cause are together present in the possible causes and all the considered symptoms are commonly present in both, then the child cause is removed by only updating a sub-cause table, thereby reducing complexity of calculations. The same principal applies to addition, deletion or modification of symptoms in relational tables. While tables in FIG. 3A-3C have been described name and ID for simplicity, in fact these tables can contain many more fields or columns than just ID and Name.

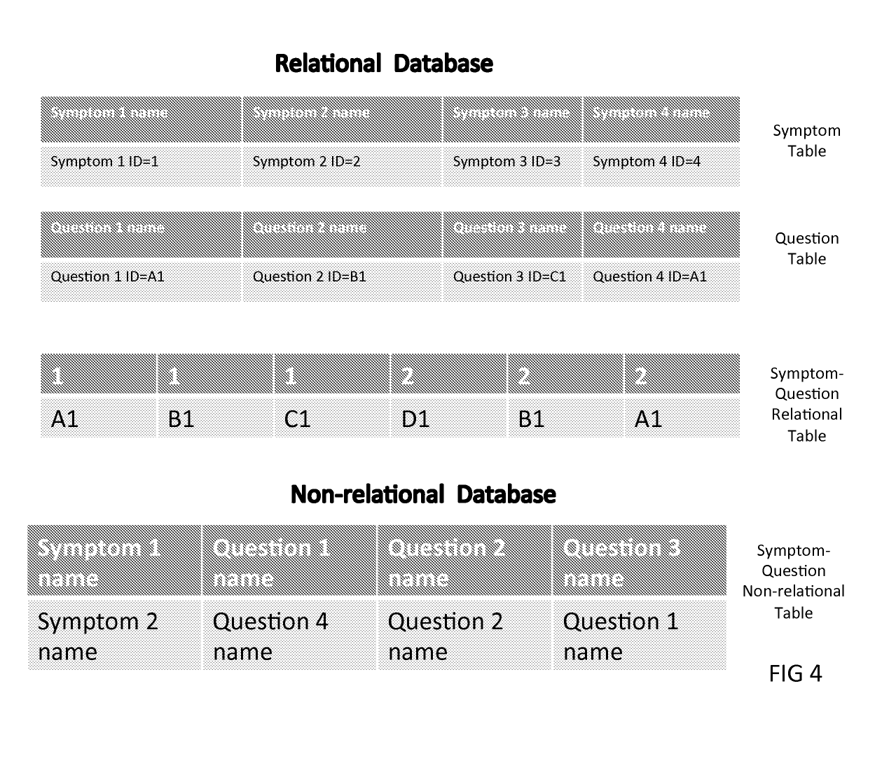

The relational/non-relational data structure conversion, mapping or migration can be applied to any table described in this specification. For example, FIG. 4 shows the relational and non-relational database structure applied to questions asked from patients based on their symptoms. By combining the relational and non-relational database structure, the present invention organizes data in manner that the processor can be used efficiently in a scalable manner to present questions to patients based on their symptoms. For example, each question is associated with a question name and a question identifier in a question table. A symptom-question relational table associates symptom identifiers with question identifiers. The relational database structure is then migrated into a symptom-question non-relational table. In this way, questions associated with symptoms can be added, deleted or modified in a scalable manner efficiently, while speeding up the process to present questions to patients based on inputted symptoms.

A method according to the present invention identifies various decision points involved in any clinical decision making by recognizing pathophysiological relations between symptoms, physical signs, lab abnormalities, radiological investigations, demographics and diseases. Specific and nonspecific symptoms are differentiated using a Boolean property named “specific” for symptoms object. The method also identifies if a group of symptoms can represent a pattern that is unique for one more a group of disease using classic presentations table in order to assign a likelihood ratio (LR) to a cause. A classic presentation symptoms table contains the classic presentation ID and the symptoms in the group for that classic presentation. Conditional probability is used in the context of relations between demographics parameters and cause based on a profile cause relations table that contains profile ID, profile value, condition (=, <, >, !=), likelihood ratio (LR) and cause ID. Demographics is patient profile such as age, gender, occupation, height, weight, smoking, alcohol use, illicit drug use, waist circumference, ethnicity, blood group etc. Profile ID is an identifier for a profile field like “Cause ID=A” for “Cause 1”, Profile ID=∝: “for “Profile 1.” For Profile name=“Age”, Profile value is the value of age for comparing using a rule condition. For example, for Age >=18, “Age” is the name of profile but referenced in the rules table using ID instead. For example, “>=” is the rule condition and “18” is the value of age. This rule would match when the patient age is entered as 20 for instance.

The method can also determine whether a symptom is directly linked to a cause or a byproduct of a complication of that cause. Under this arrangement, the method identifies the patient profile specific relations to different causes using profile based cause inclusion and exclusions tables that contains profile ID, profile value, condition and cause ID.

The method can identify all the relevant symptoms or physical signs or lab tests that are required to approach a specific symptom or a number of symptoms. A symptom-questions table contains the list of questions that are associated with or need to be asked for a symptom. A question-answer table gives the list of answers for a question. An answer table contains a symptom ID that links an answer to a symptom if the answer is the same as a symptom. If there are answers to the questions of the given symptom that are marked as another symptom, such symptoms are considered as relevant symptoms for the current diagnosis. A physical signs and labs table has a question ID field to link a question that needs to be asked to a physical sign or lab result. Those signs and labs having such relation to the questions being asked are provided as recommended labs and signs.

The method can identify various contextual relationships between symptoms and a plurality symptom contexts. More specifically, all contextual relations of each symptom are gathered and common contextual relations ones are identified. Contextual relations that are common to maximum number of symptoms are given higher priority so that the effect of combination of symptoms gets higher probability.

The method can identify a symptom qualifier, which has high immediate impact in reaching the final diagnosis. A symptom-qualifier rules table is used to assign an LR to a given symptom and qualifier.

The method can replace a symptom or group of symptoms with another symptom, which has a different diagnostic approach by identifying pattern. More specifically, the method uses symptom replacement rules tables, namely, a symptom replacement group table which contains the target symptom, duration and qualifier. A symptom replacement rules table with multiple entries of the source symptoms with their applicable durations and qualifiers is mapped to the same symptom replacement group entry.

The method can also identify the relation between diseases and various other past medical or surgical histories and quantify the relations. For example, past medical history to cause relations and past surgical history to cause relations are used to assign LR to a cause.

The method can identify the relation between medications and diseases. More specifically, interactions and side effects of medications are identified and incorporated into decision-making tree. A medication side effects table gives a list of side effect diseases for a medication. If the patient is on a particular medication, and the given symptoms are related to a cause that is a side effect of the medication, it is given higher probability. A medication interactions table also gives a list of medications that have interaction with a given medication. If a medication the patient is taking has interaction with another medication, which is suggested for the current diagnosis of the patient, that medication is avoided and an alternate medication is suggested.

The method can identify the relation between various clinical contexts with symptoms or combination of symptoms and lab abnormalities and define and quantify the relation with diseases. Context relation tables are used to track what questions need to be asked, what LR to be applied to what cause, what results or inferences need to be applied, etc., for a combination of symptoms and/or lab abnormalities etc., in the presence of a context.

The method can also identify the relation between geographic location and diseases. A geographic location to cause table gives a list of diseases more or less likely (LR) in a particular geographic location. A country to geographic location table maps what countries come under what geographic location. Based on the location of the patient, corresponding geographic location is identified and the LR is applied to respective causes.

The method can provide inference for any decision making step that the processor has made and share it with users for review. Inference relations tables give the list of inferences to be displayed when a given set of conditions (contexts, symptoms, signs, lab abnormalities, questions answered etc.) are matched.

The method can identify the relationship between various diseases. A cause-to-cause relation table gives a list of sub causes for a cause and builds a cause hierarchy.

The method can identify the performance characteristics of each test and incorporate that into the decision tree. The turnaround time, sensitivity, and specificity of lab tests are checked to make appropriate decisions of excluding and updating probabilities of causes.

The method can identify false positives or negatives and incorporate them into a decision tree. For example, a lab false positive and lab false negative table gives possible false positive and false negative for a given lab respectively.

The method can identify the causes that need to be excluded and included in a decision tree for symptoms or group of symptoms. The method can also identify a negative relation between a symptom and a disease. A negative symptom cause table gives the list of negative causes for a symptom. A negative relation means the absence of the symptom is necessary to consider the cause.

The method can identify certain labs or physical signs that can be included or excluded for analysis of symptoms or signs. The system has the ability to move forward with any new information. With the input of any further information, such as a symptom, physical sign, lab finding etc., the system re-computes probabilities with the new set of information further refining and re-prioritizing the list of possible disease.

The method can derive at recommended labs or physical signs by evaluating the specific relation between the cause and the diagnostic test. The method can define all the cognitive strategies that a physician would use and convert them into computer codes.

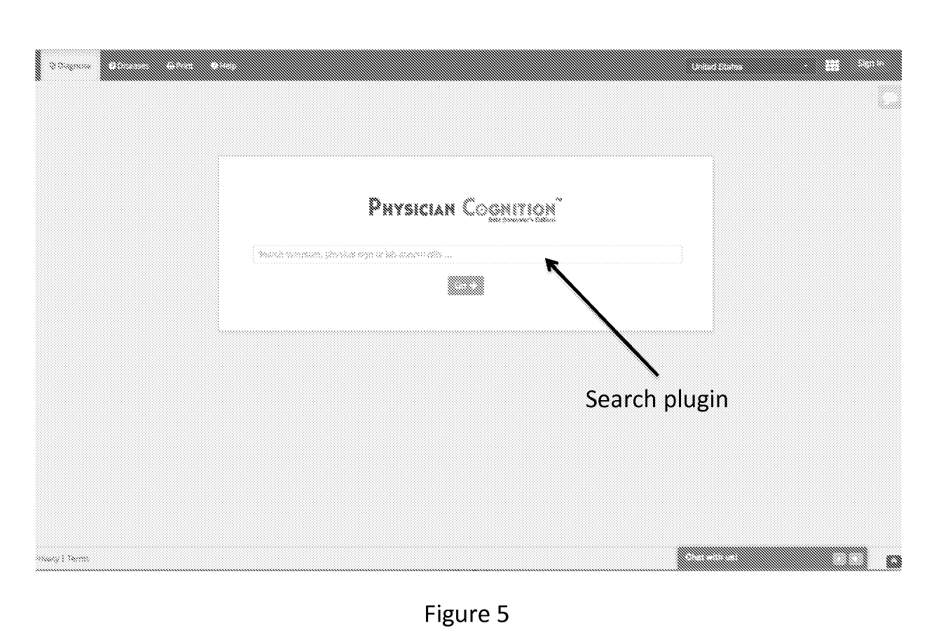

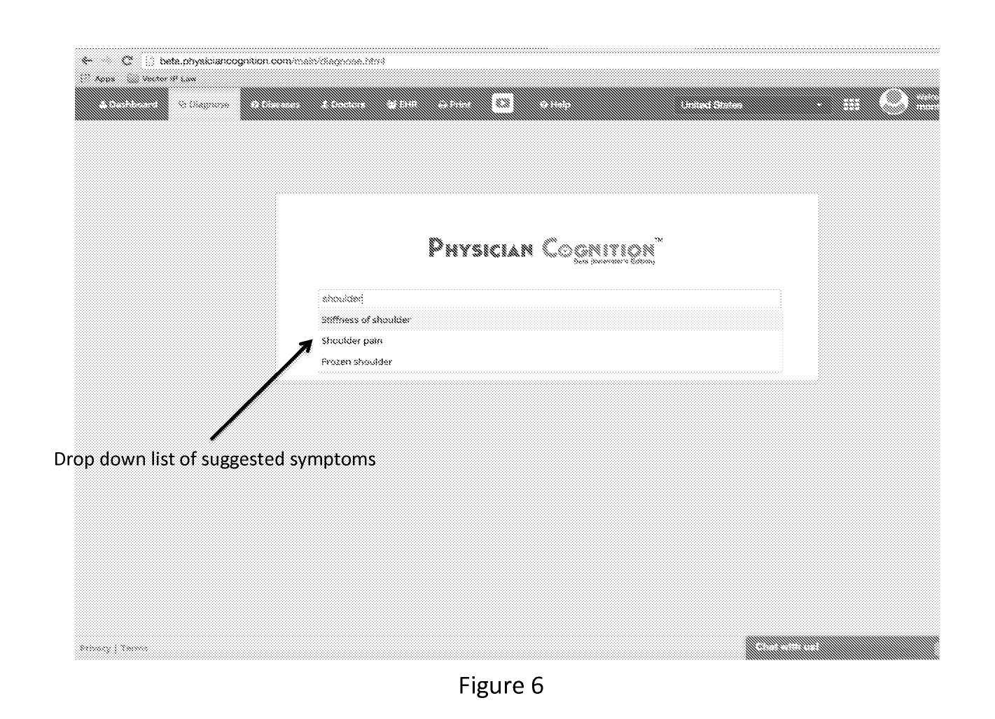

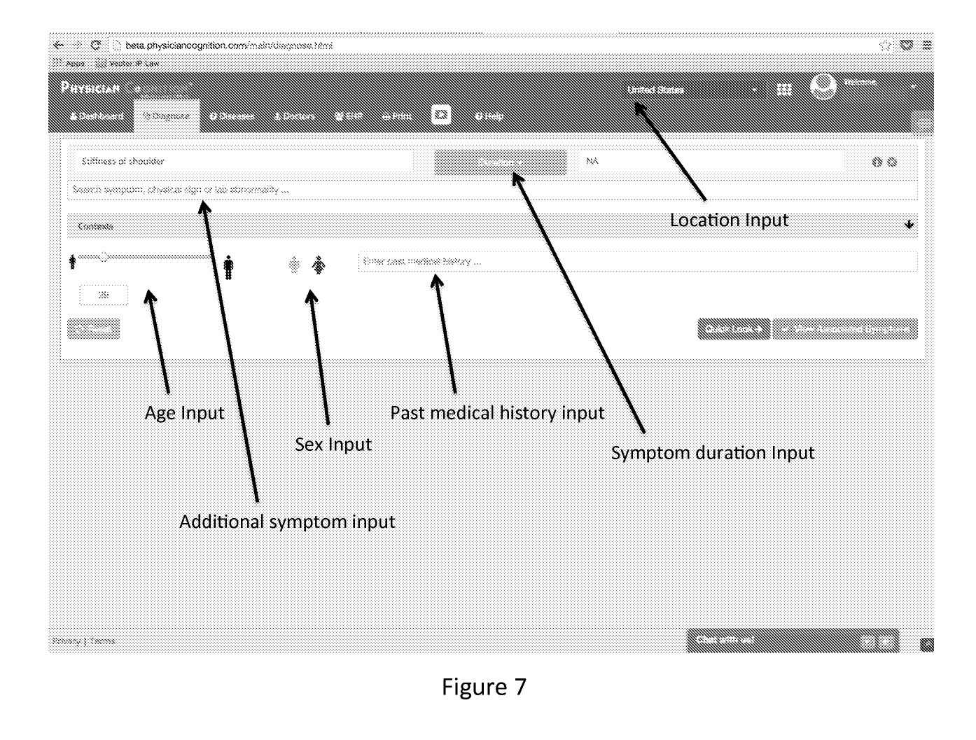

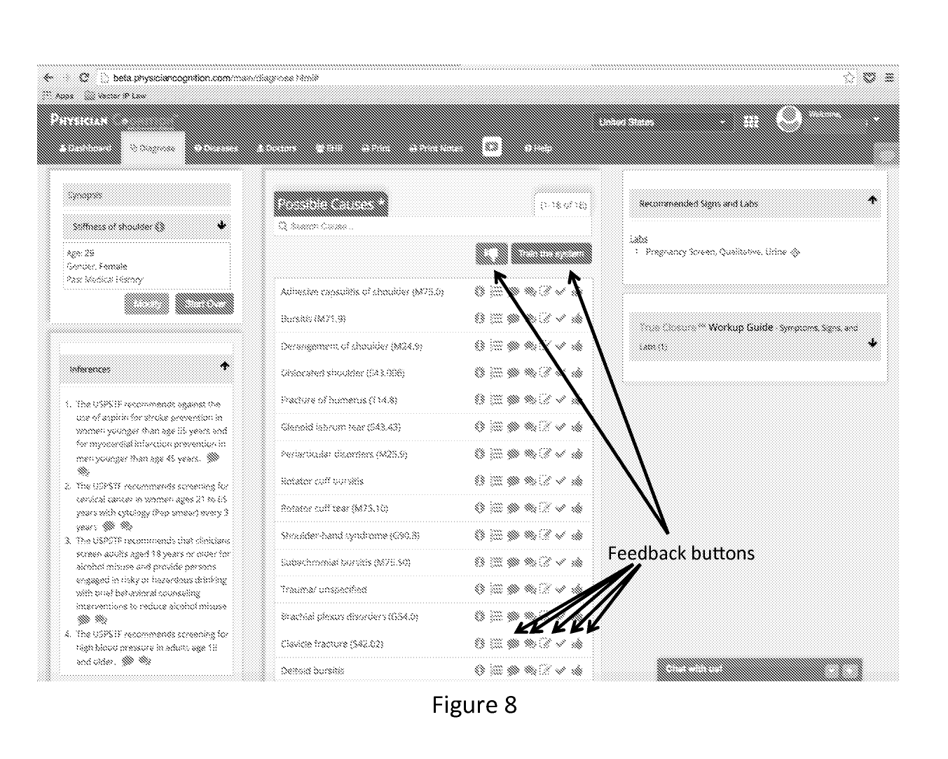

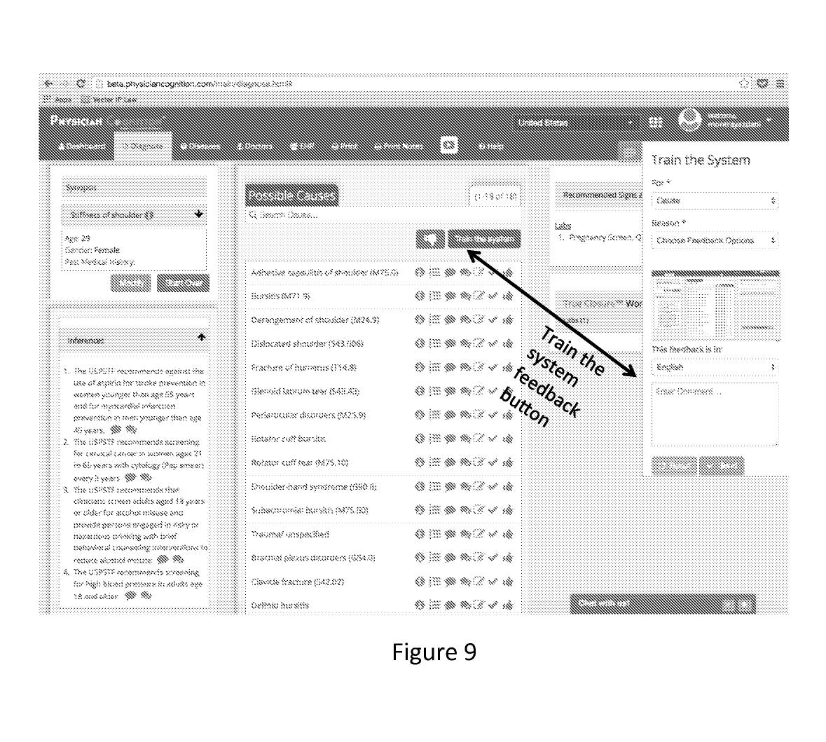

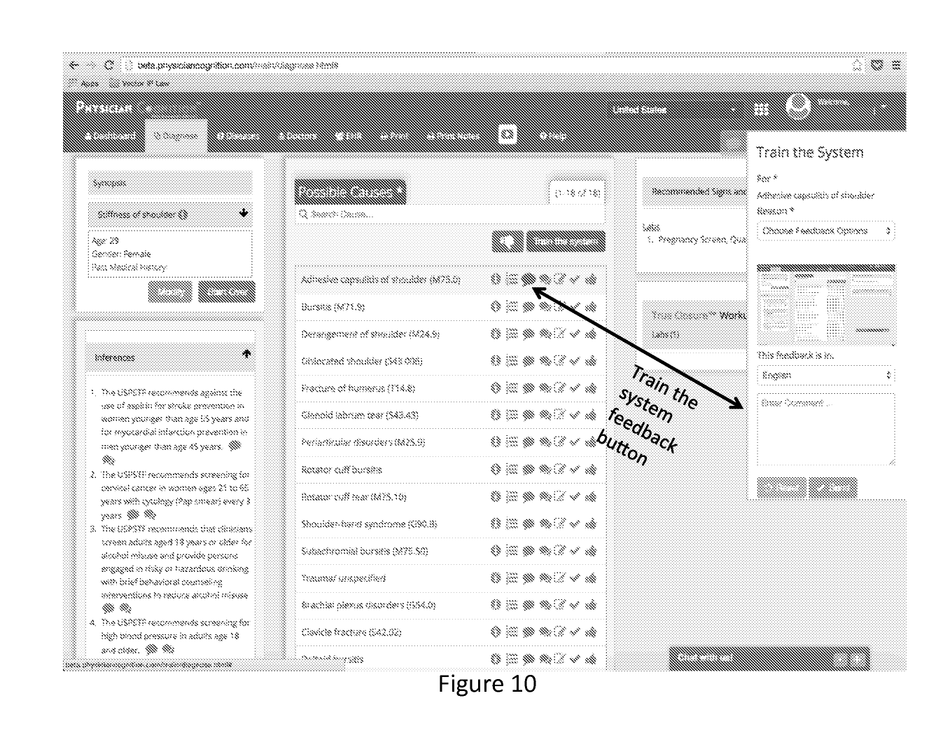

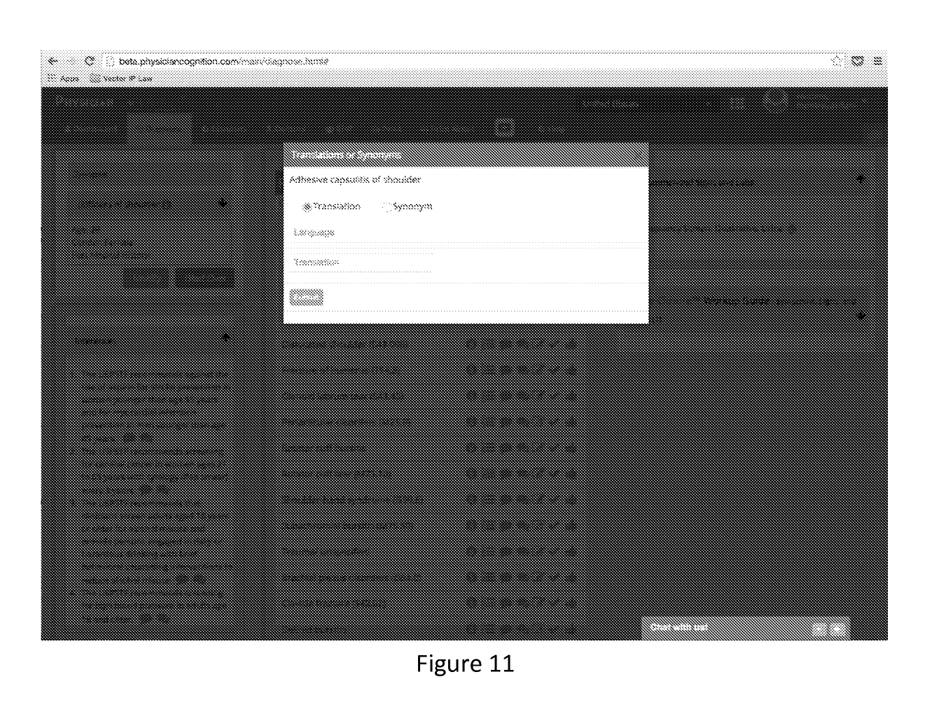

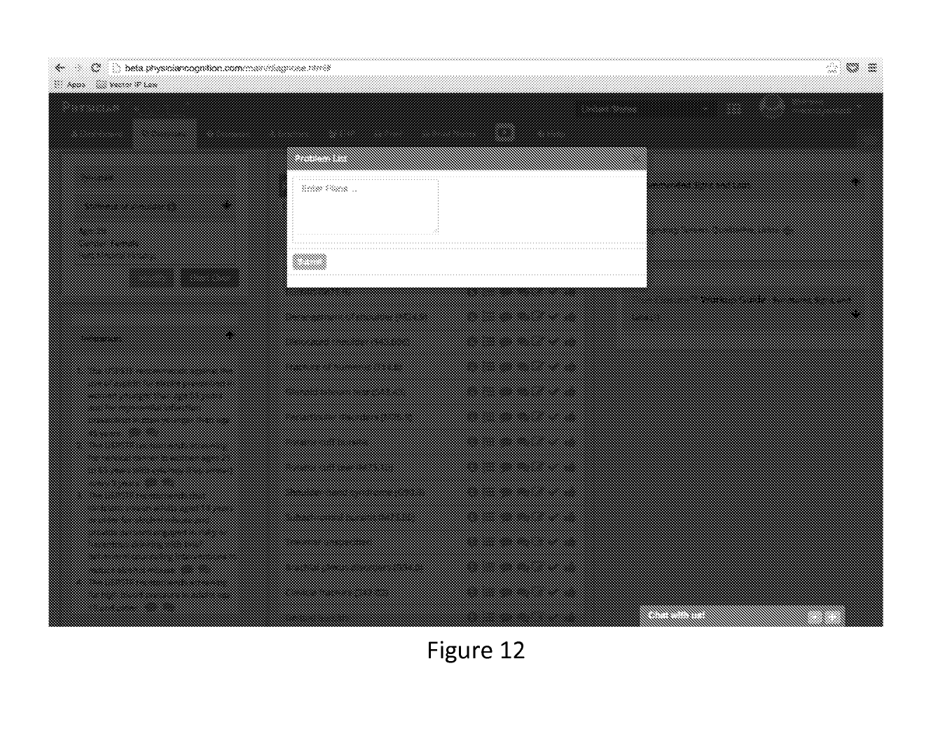

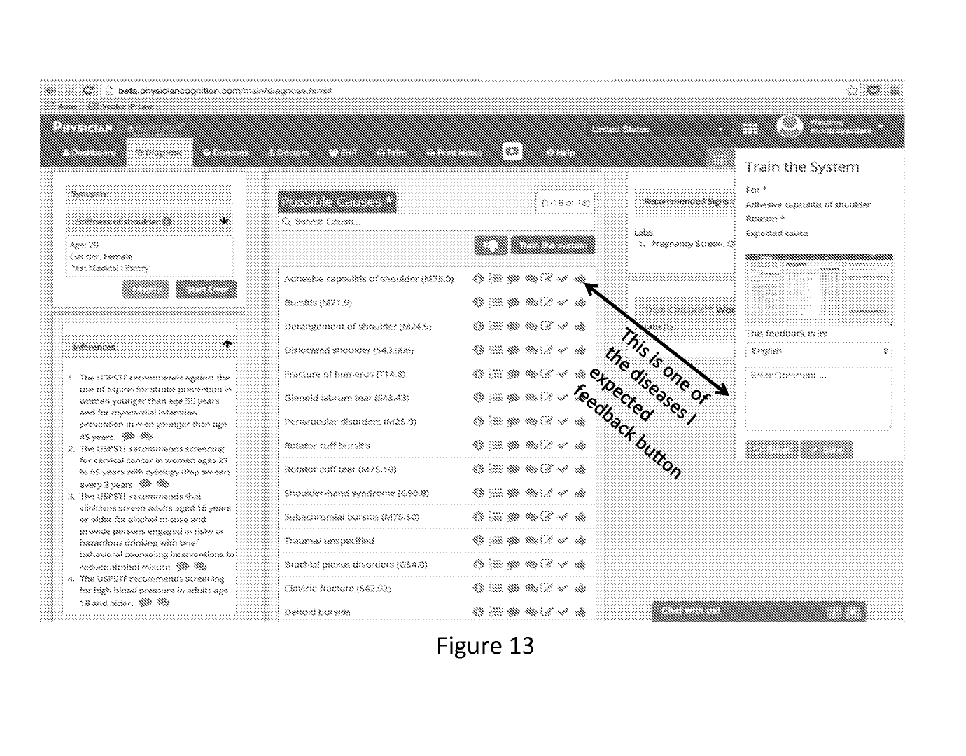

FIG. 5 shows one embodiment of the present inventions front-end user interface executed on a computer via a web-browser. After creating an account, users can begin typing any symptom in the search plugin of the diagnose page of the user interface. As shown in FIG. 6, once a user begins typing a symptom, a drop down list of suggested symptoms displays existing symptoms beginning with the letters the user has entered, which the processor fetches from the symptom database. Once a symptom has been selected, the user is directed to the set of questions illustrated in FIG. 7 where additional symptoms, age, sex, location, symptom duration, and past medical history can be input. FIG. 8 shows an example of the list of possible causes, inferences, and recommended signs and labs for a selected symptom based on the users markers, symptom duration, and past medical history. General and symptom-specific feedback buttons are presented to allow expert users to improve the system. FIGS. 9-13 illustrate examples of how expert users can use feedback buttons on the user interface to train and improve the system.

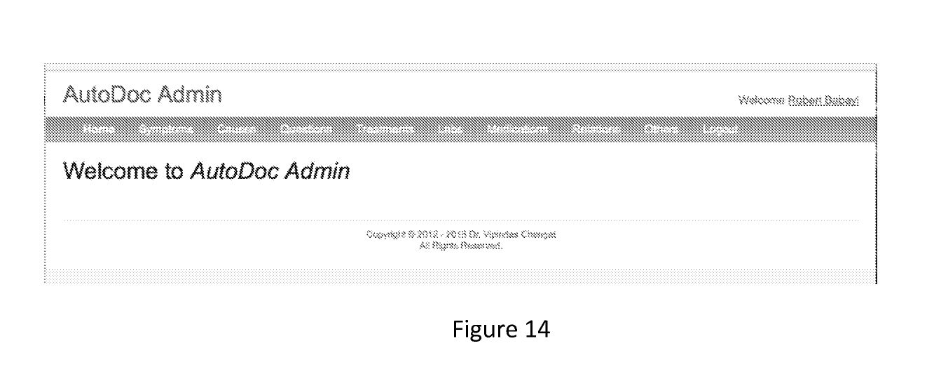

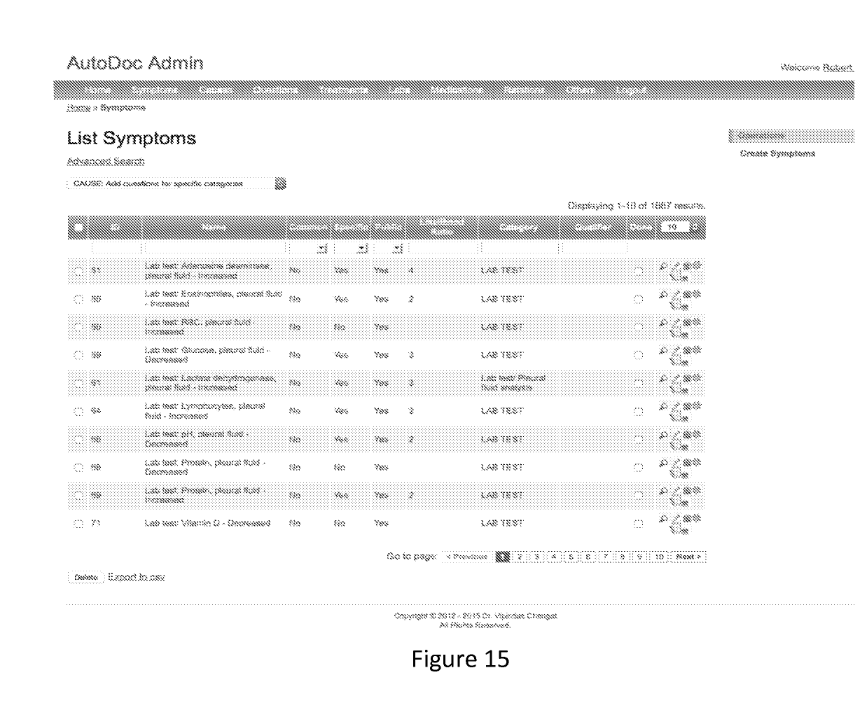

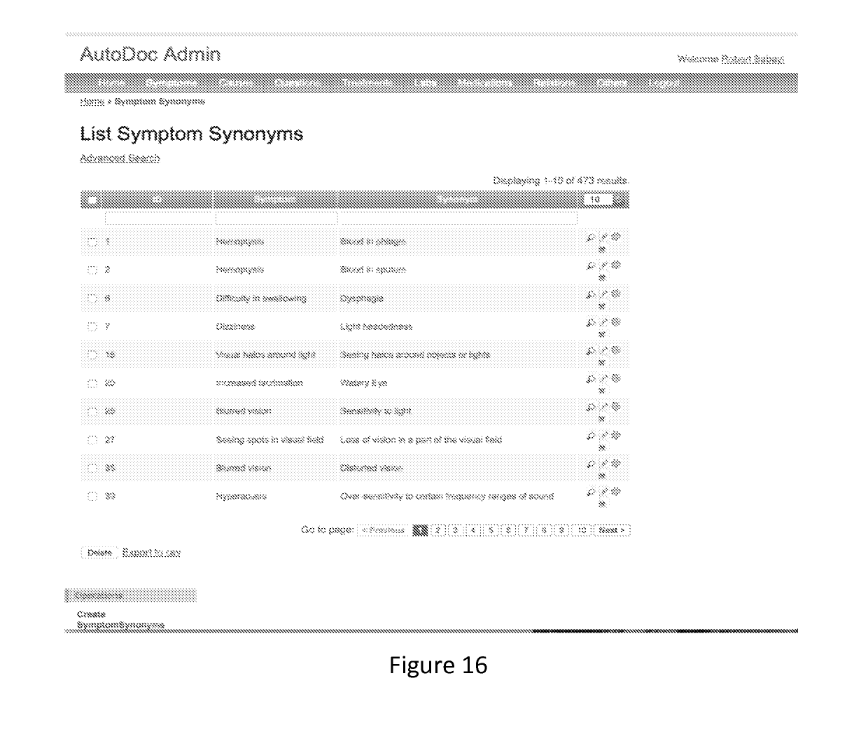

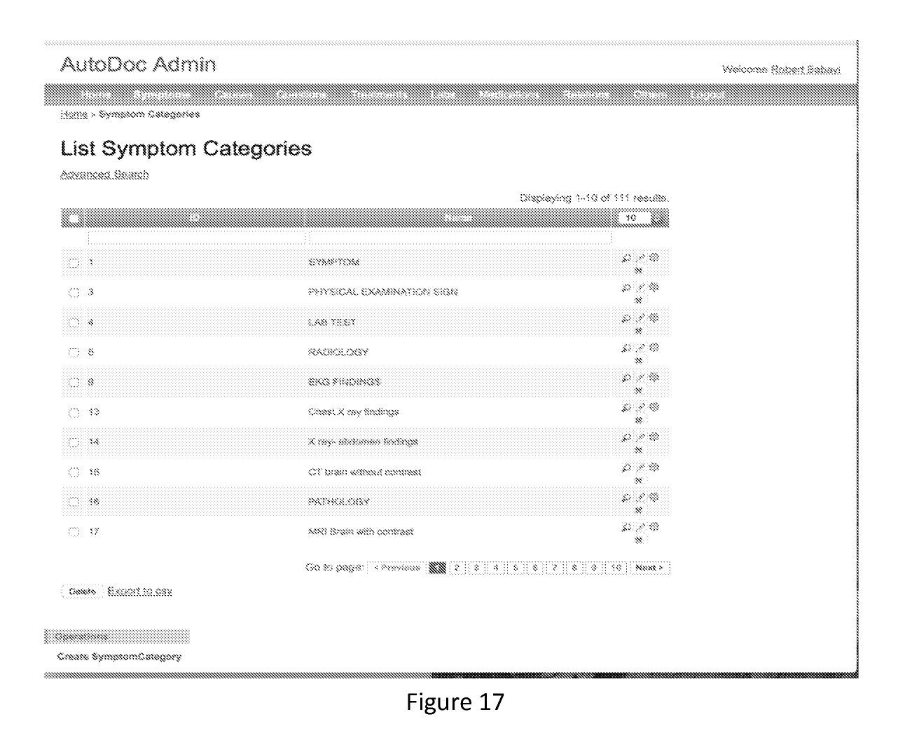

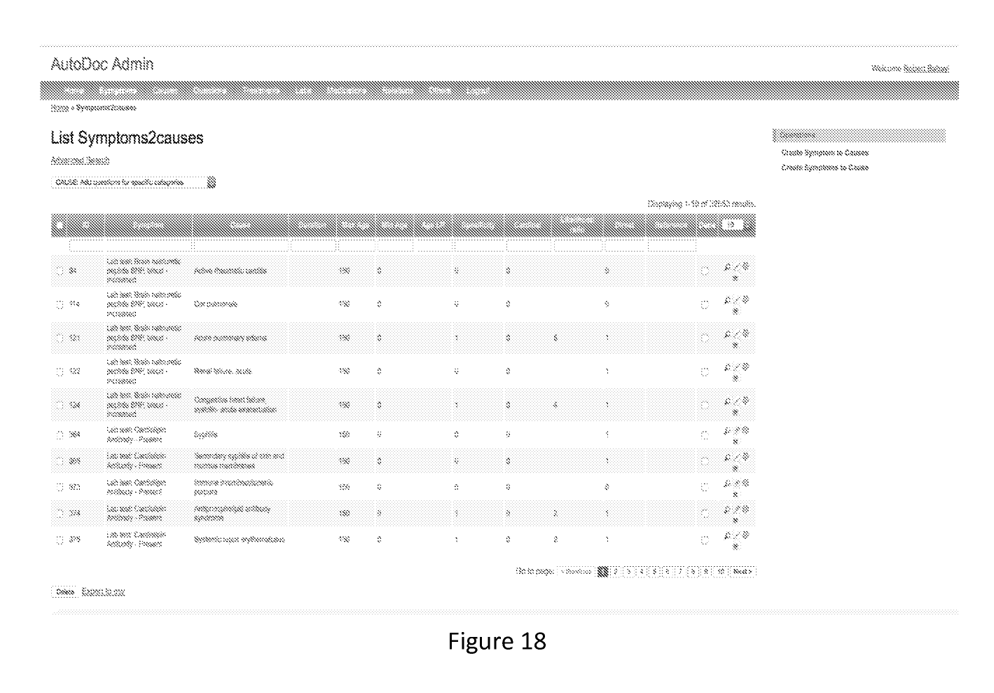

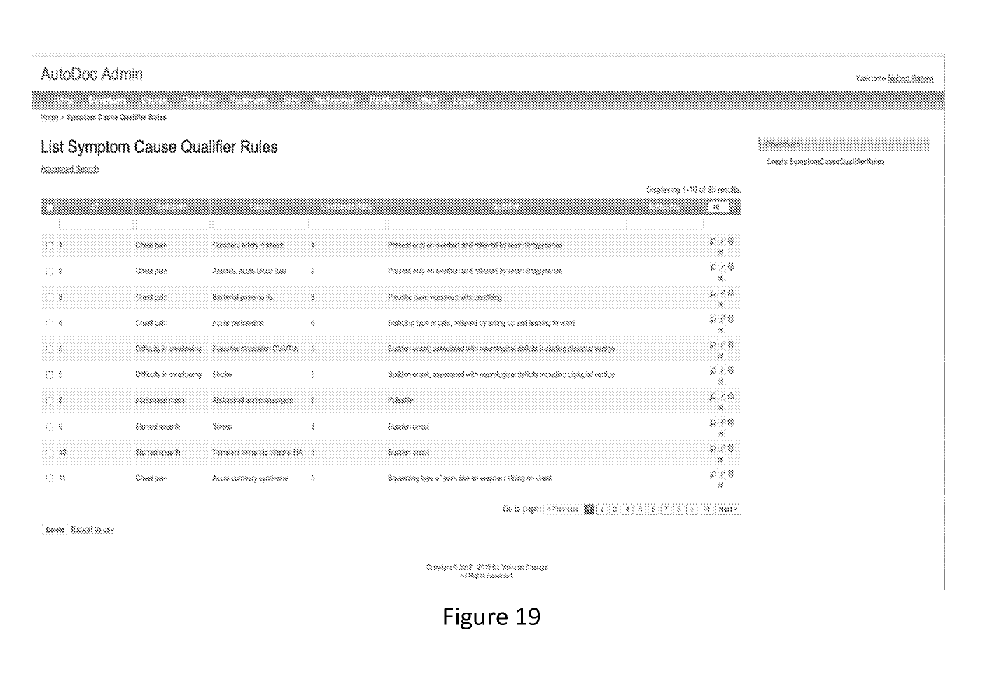

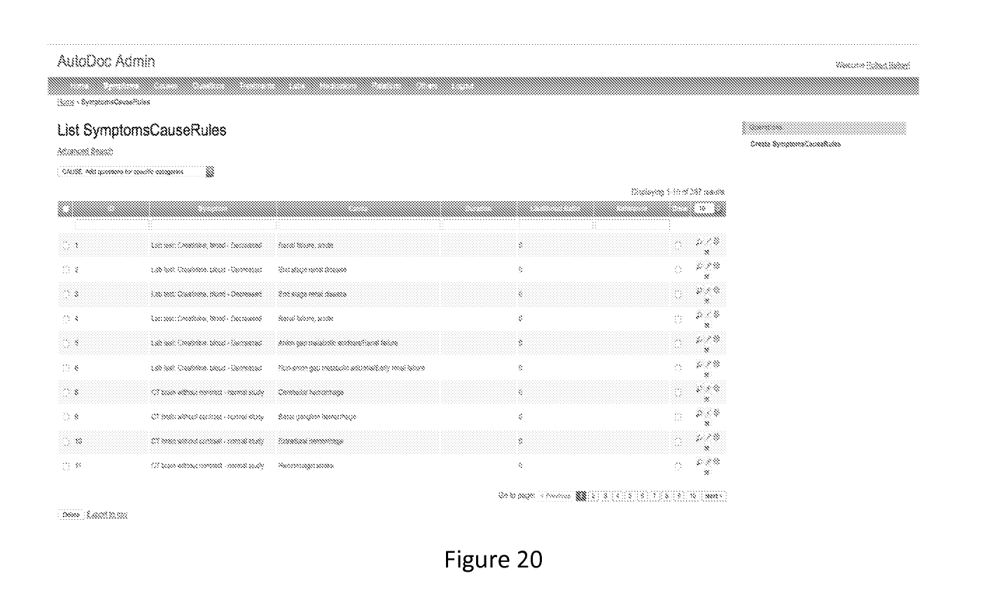

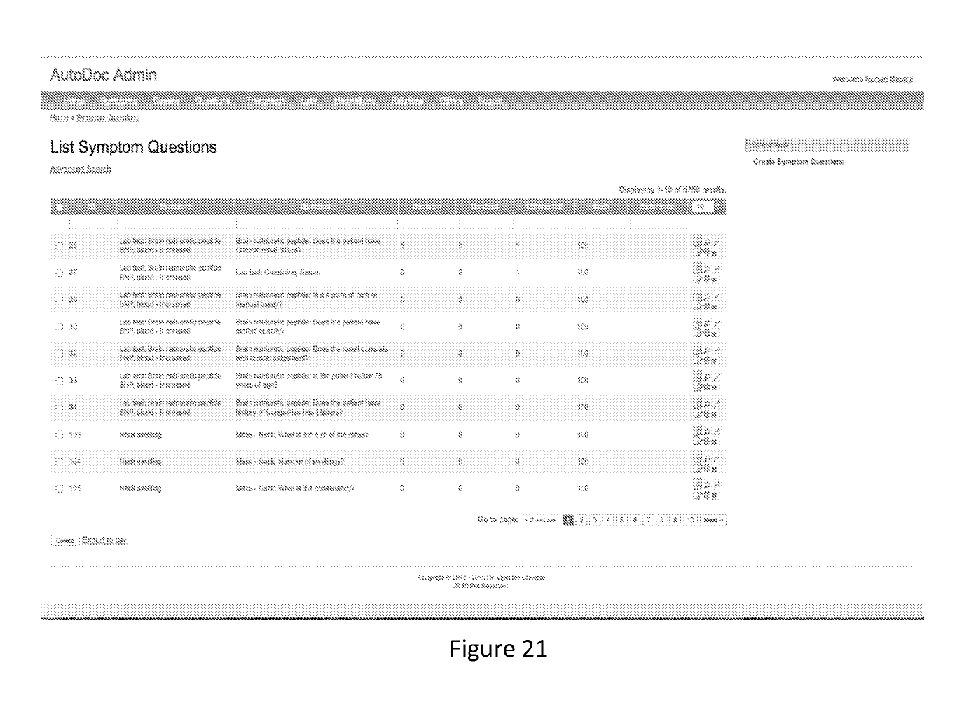

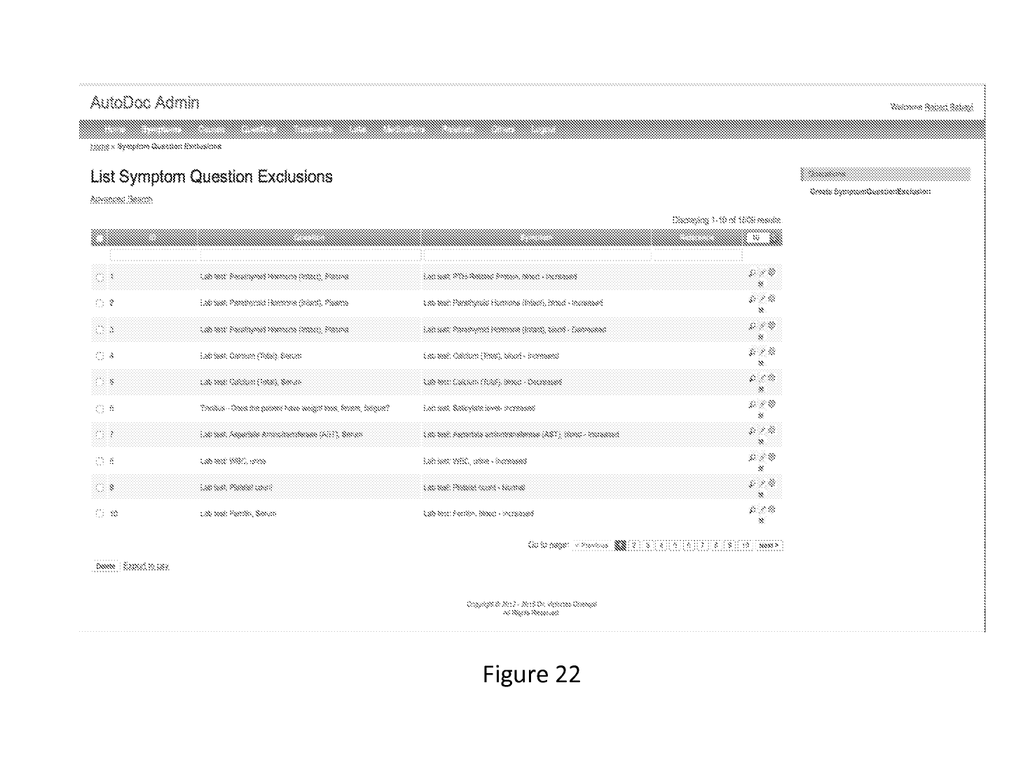

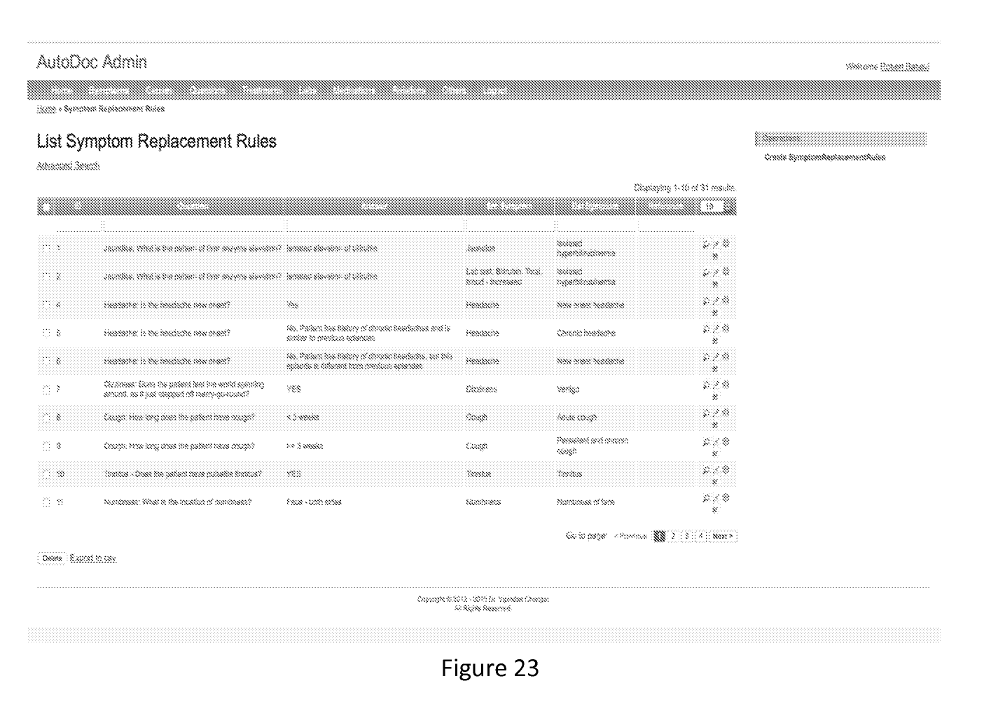

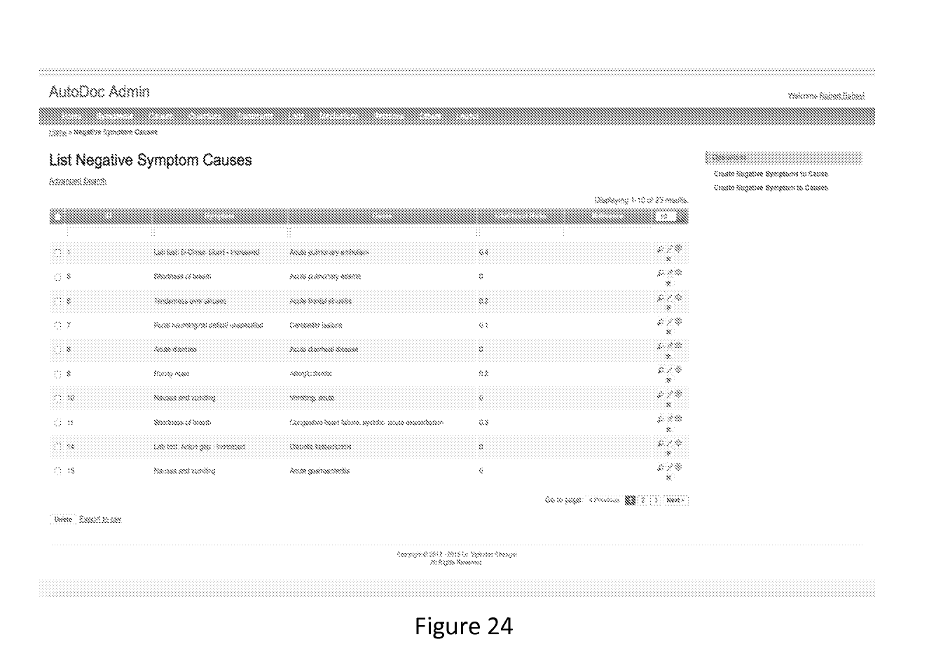

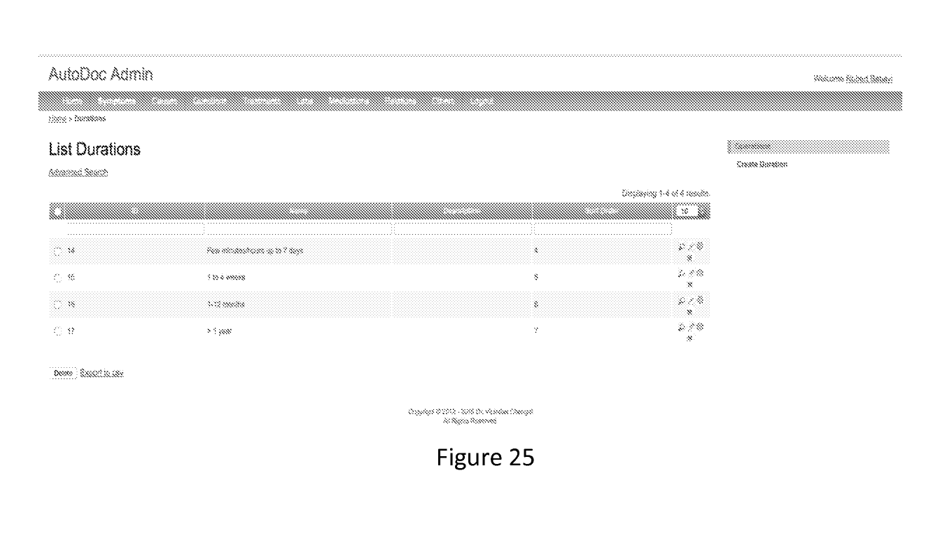

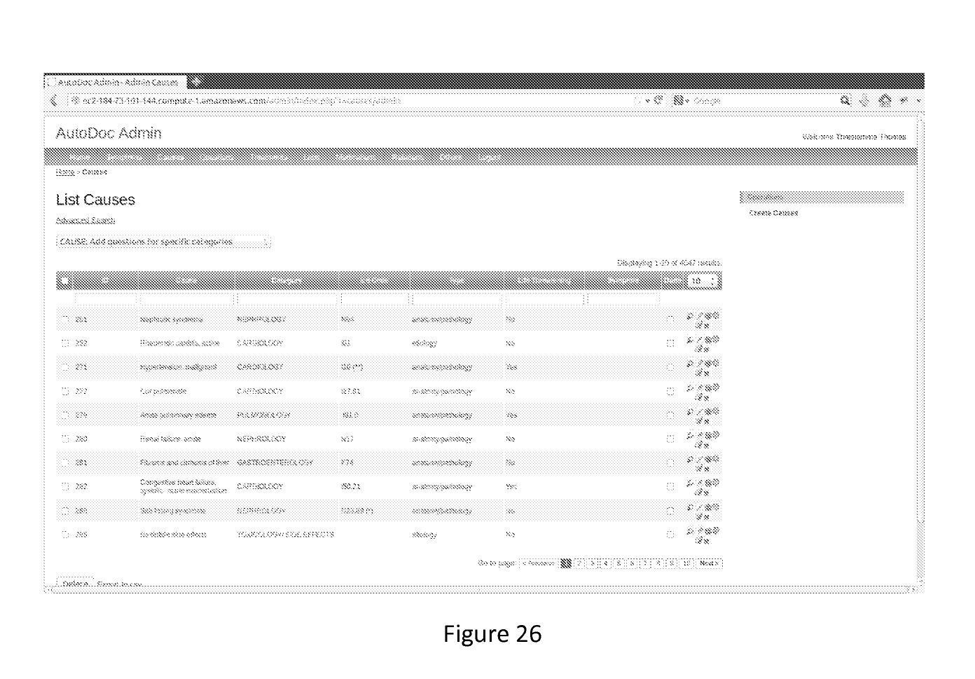

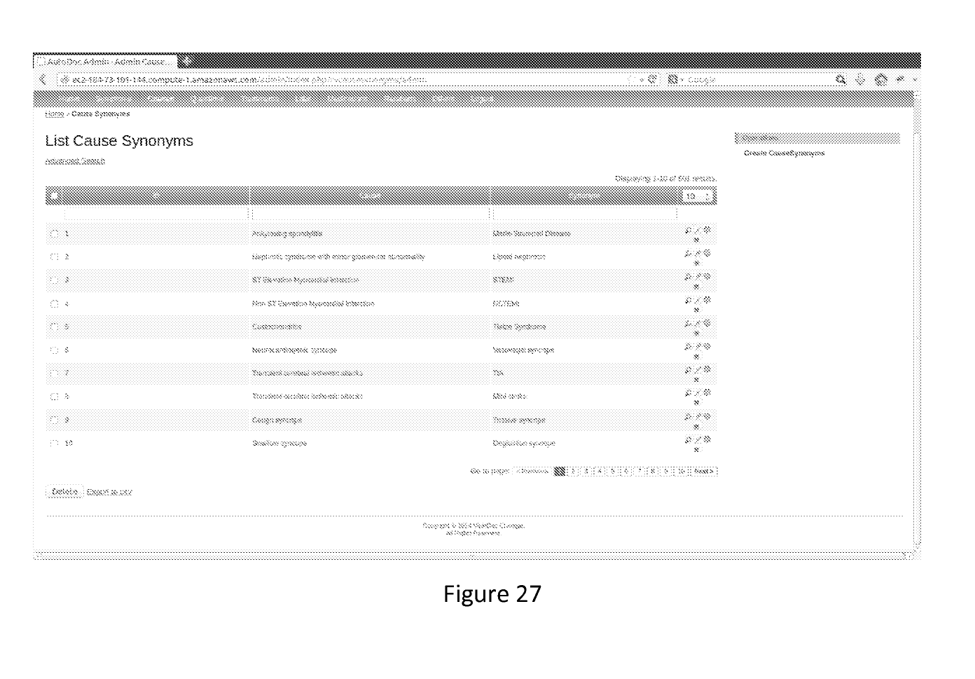

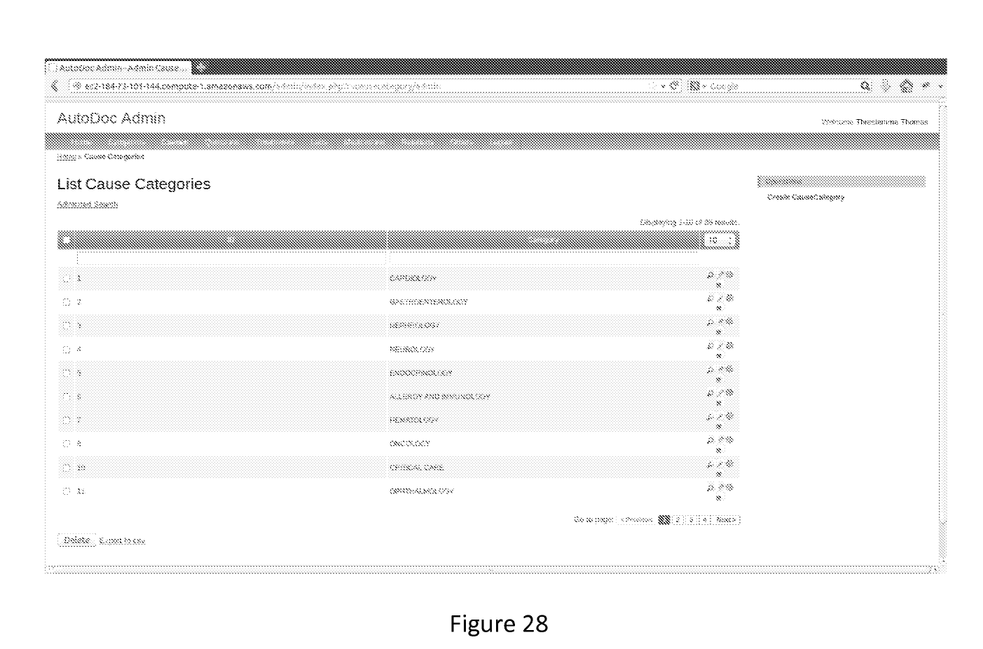

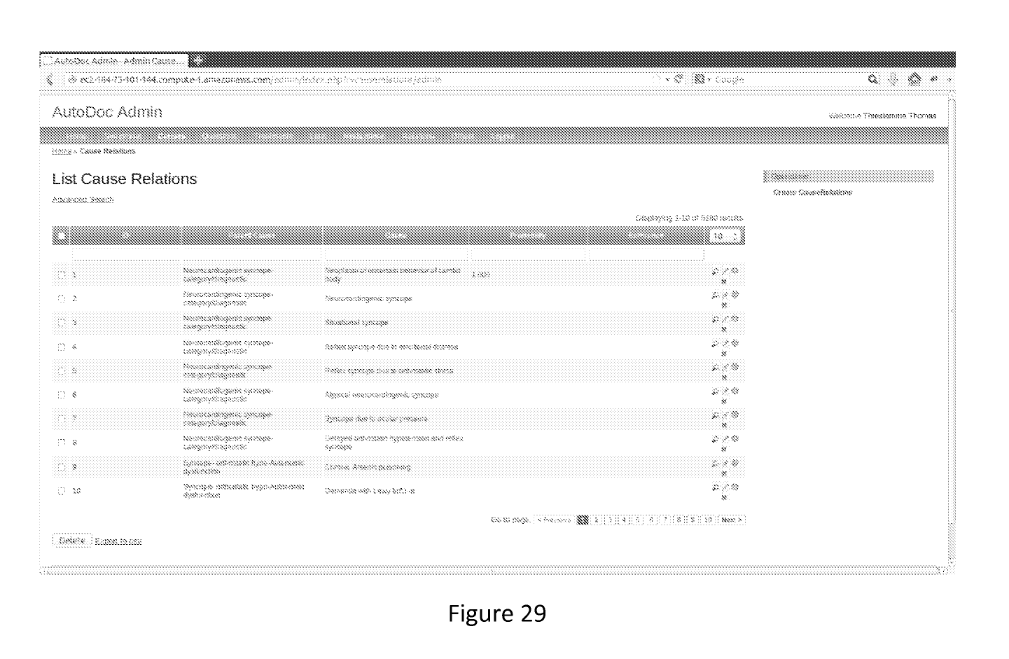

FIG. 14 shows one embodiment of the present inventions back-end administrative interface executed on a computer via a web-browser. FIG. 15-17 illustrate how an administrator can create and edit symptoms for user selection, synonyms of symptoms, and categorize them on the administrator interface. FIG. 18-20 shows how an administrator can create and edit symptom-cause relations as well as symptom-cause exclusions. FIG. 21-22 are screenshots of the administrator interface where an administrator can create and edit questions, identify symptom-question relations, as well as question exclusion rules. FIG. 23 is a screenshot of the administrator interface showing how an administrator can create and edit replacement rules for symptoms in accordance to user answers. FIG. 24 is a screenshot of the administrator interface where an administrator can create and edit a likelihood ratio for a cause when a particular symptom is absent. FIG. 25 is a screenshot of the administrator interface where an administrator can create and edit durations available for symptoms and their relations. FIG. 26-28 are screenshots of the administrator interface where an administrator can create and edit causes, synonyms of causes, categorize them, mark them as life threatening, and link them to any symptom it represents. FIG. 29 is a screenshot of the administrator interface where an administrator can create and edit parent-child relation of causes for organizing the causes in a hierarchy.

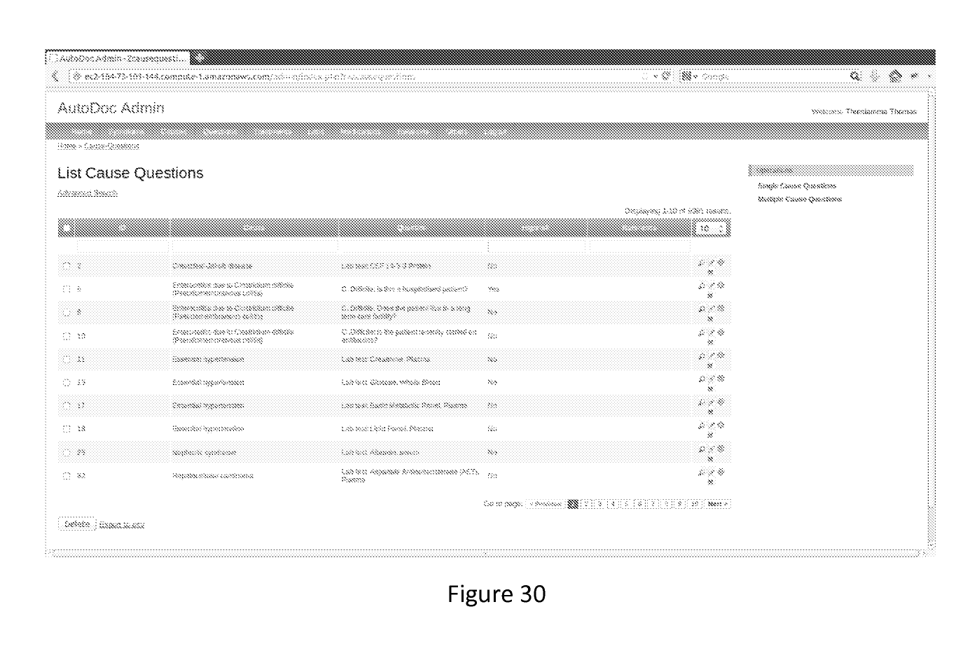

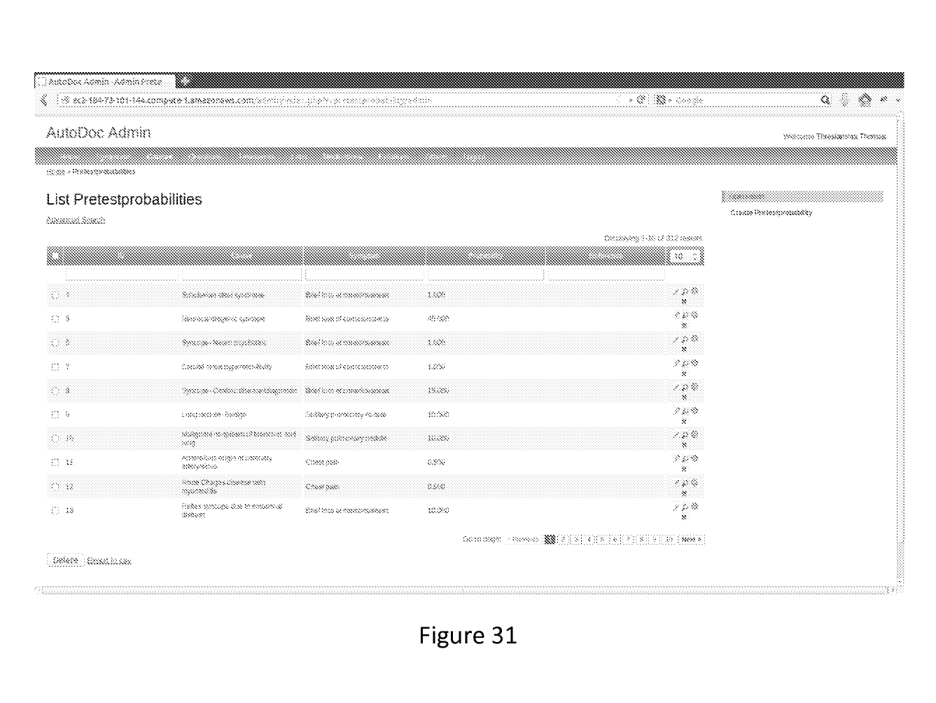

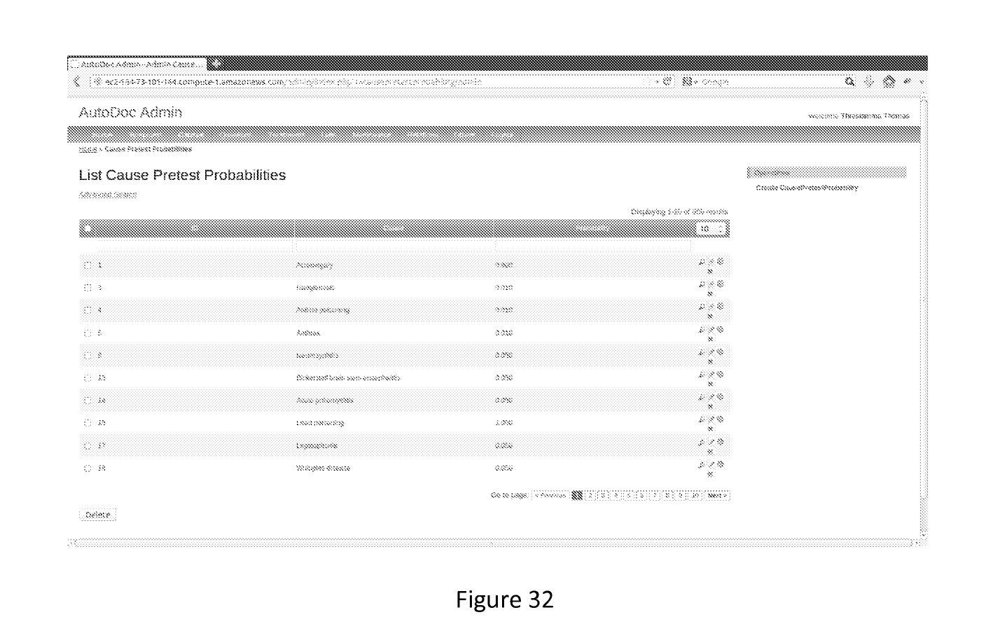

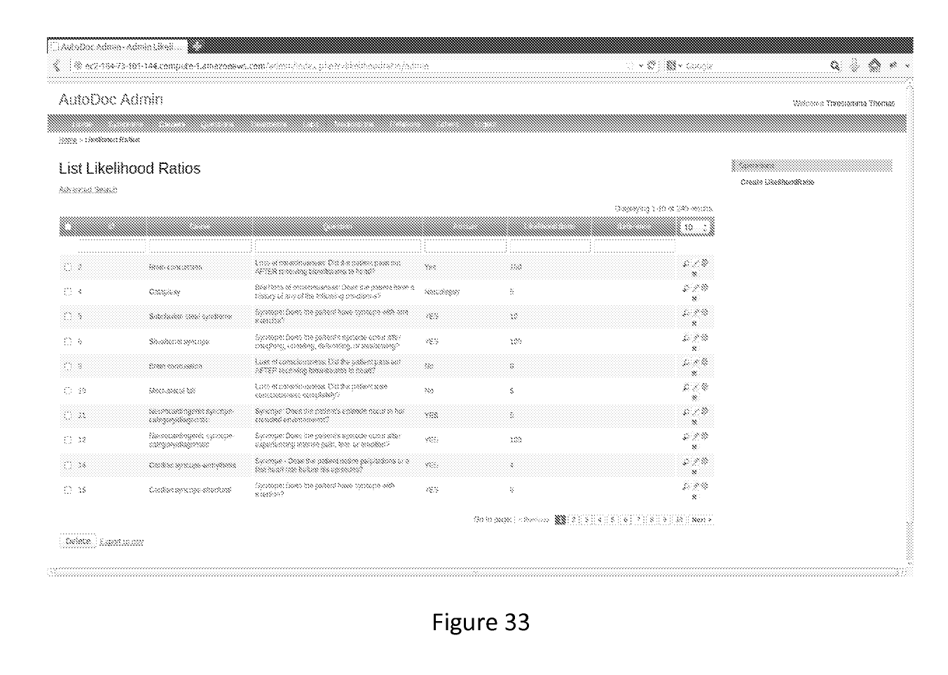

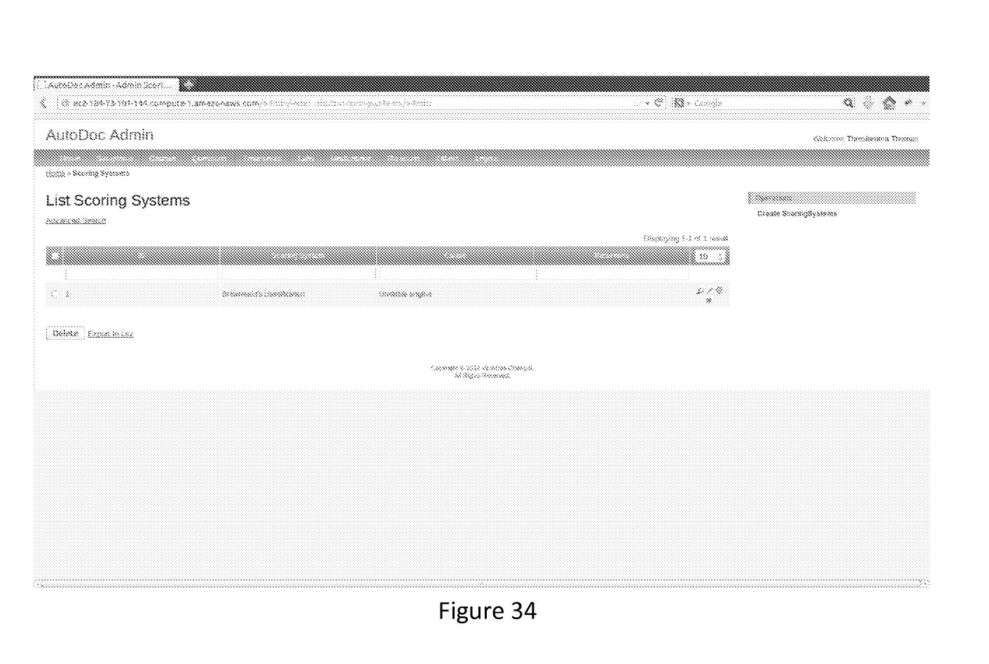

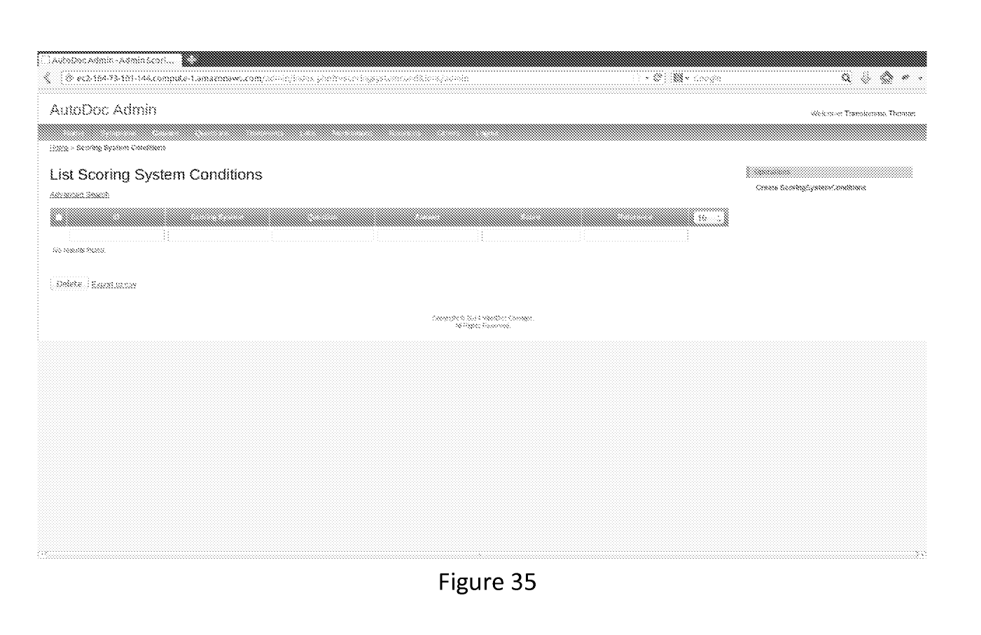

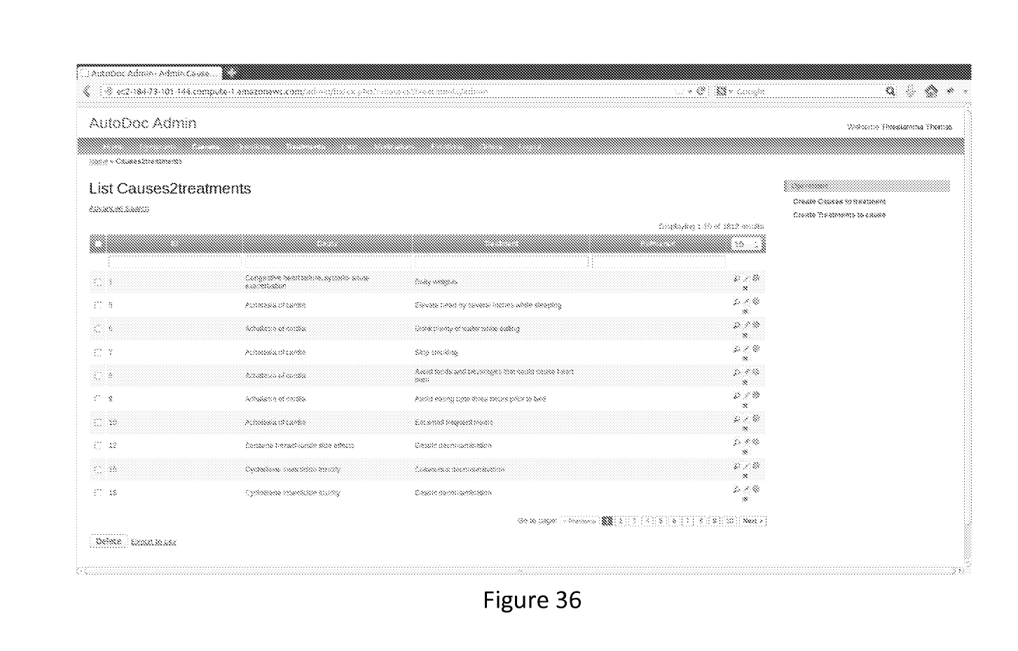

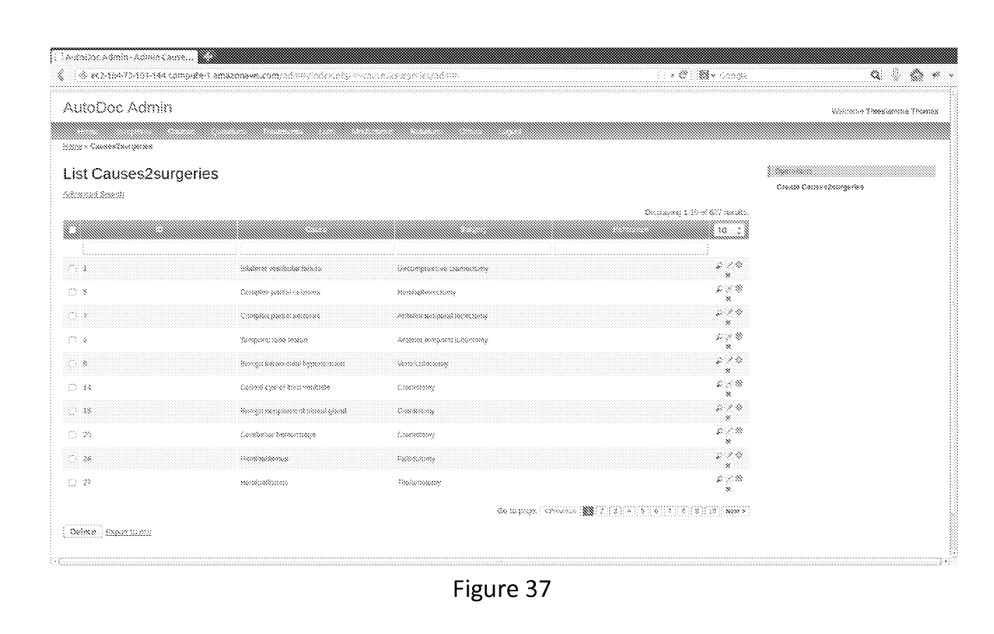

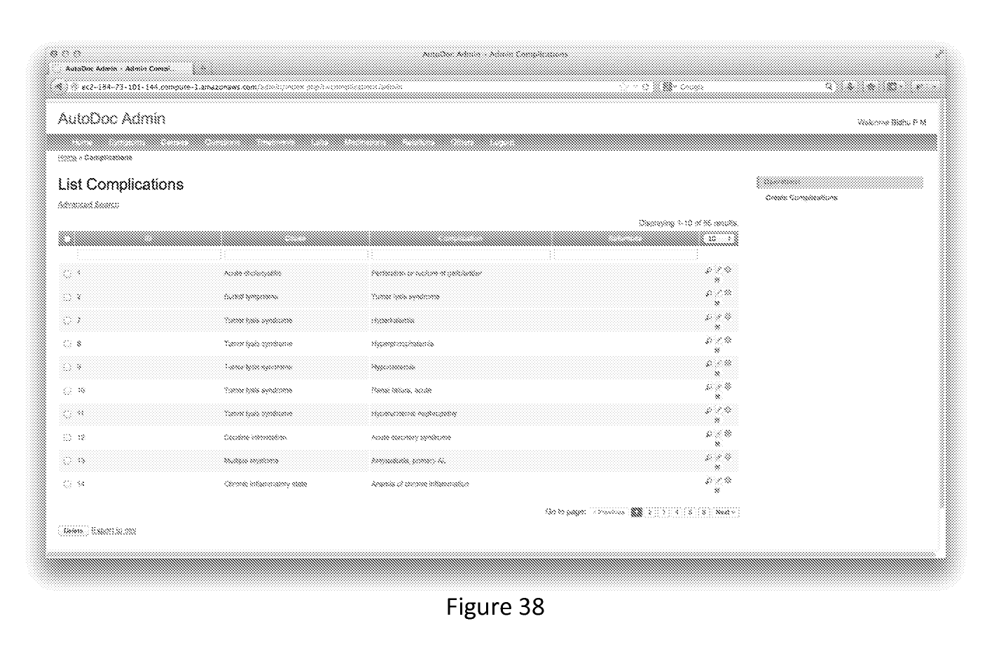

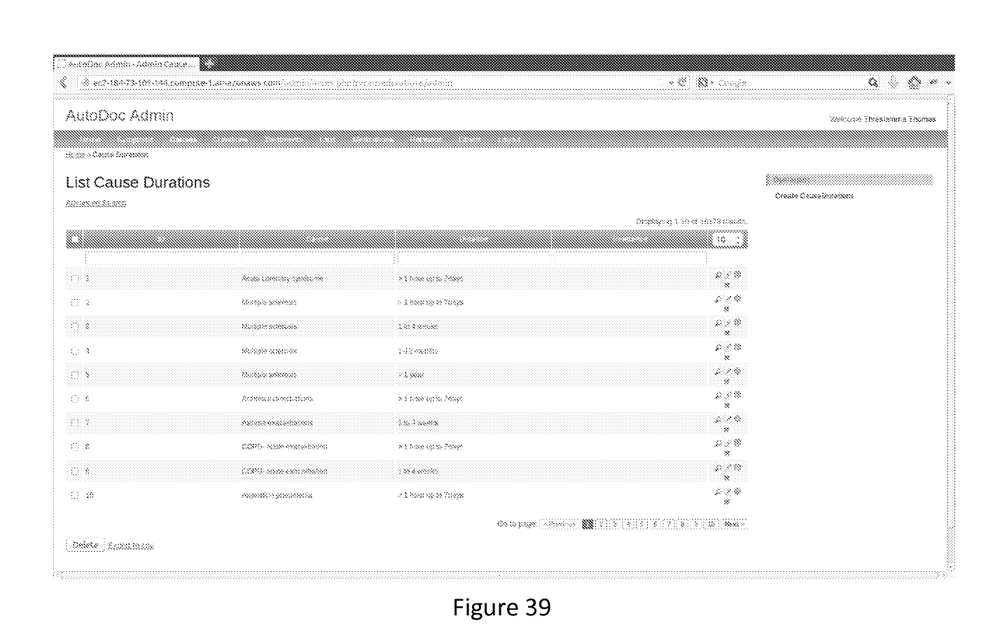

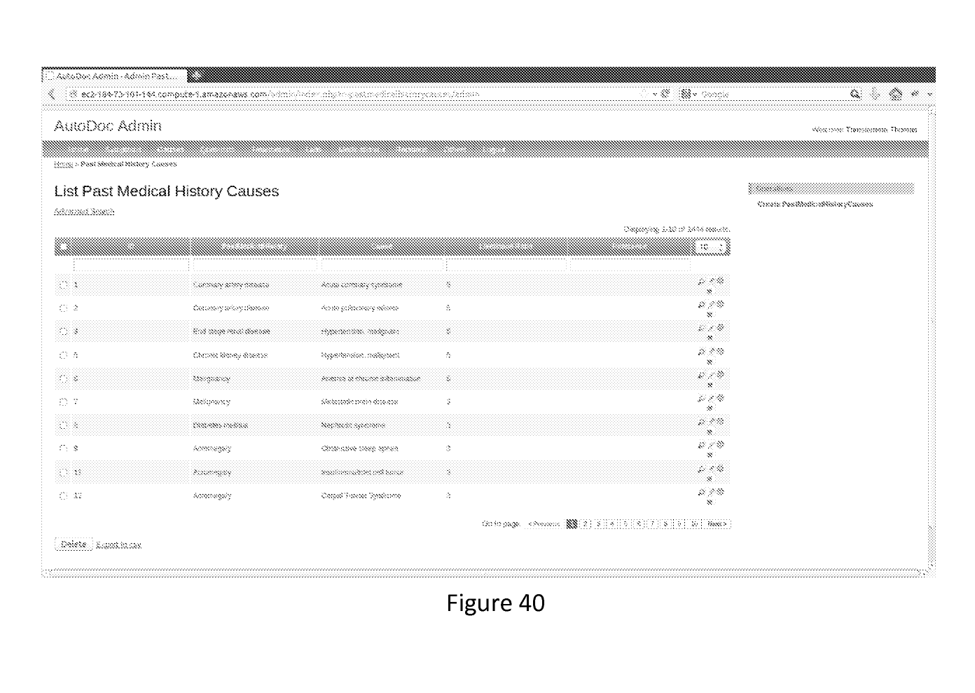

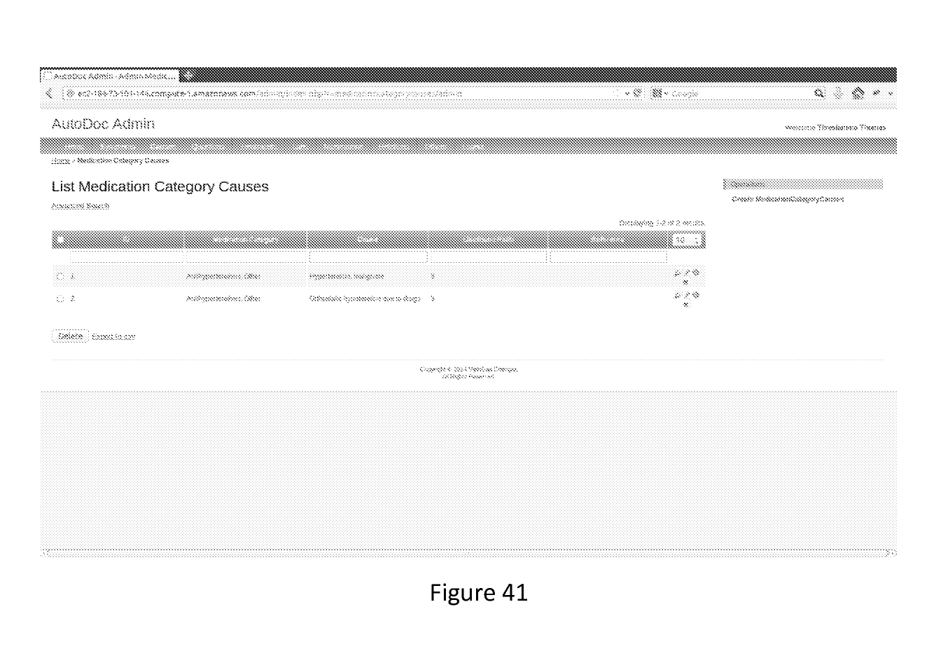

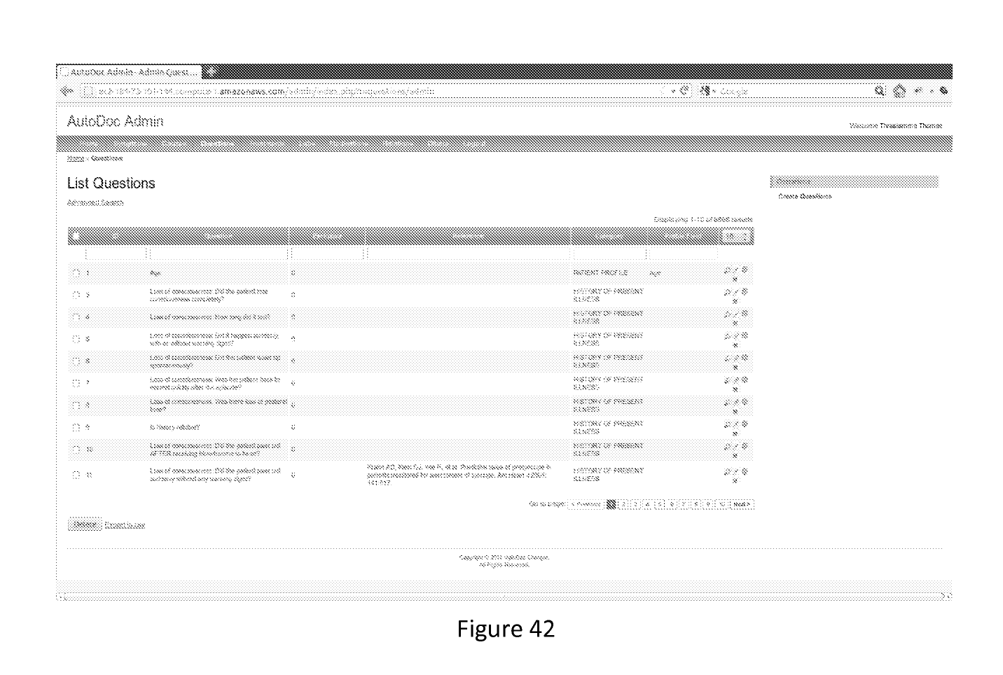

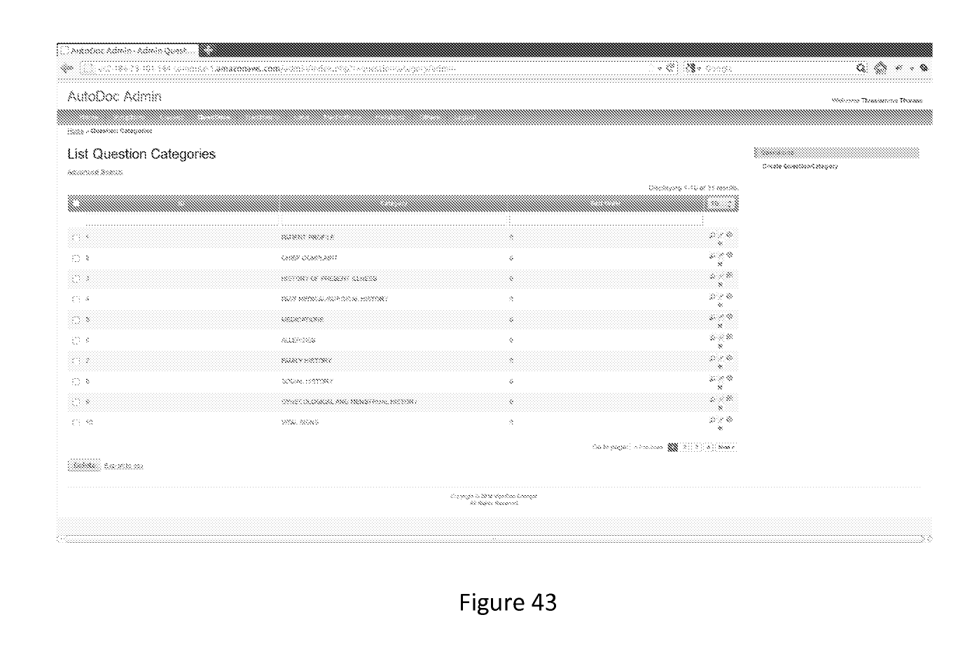

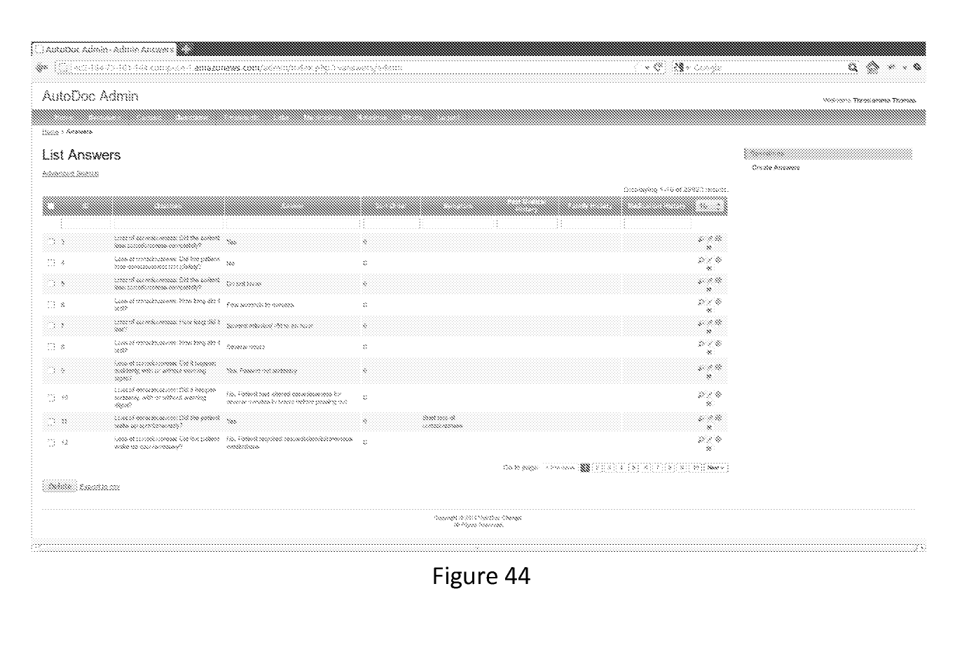

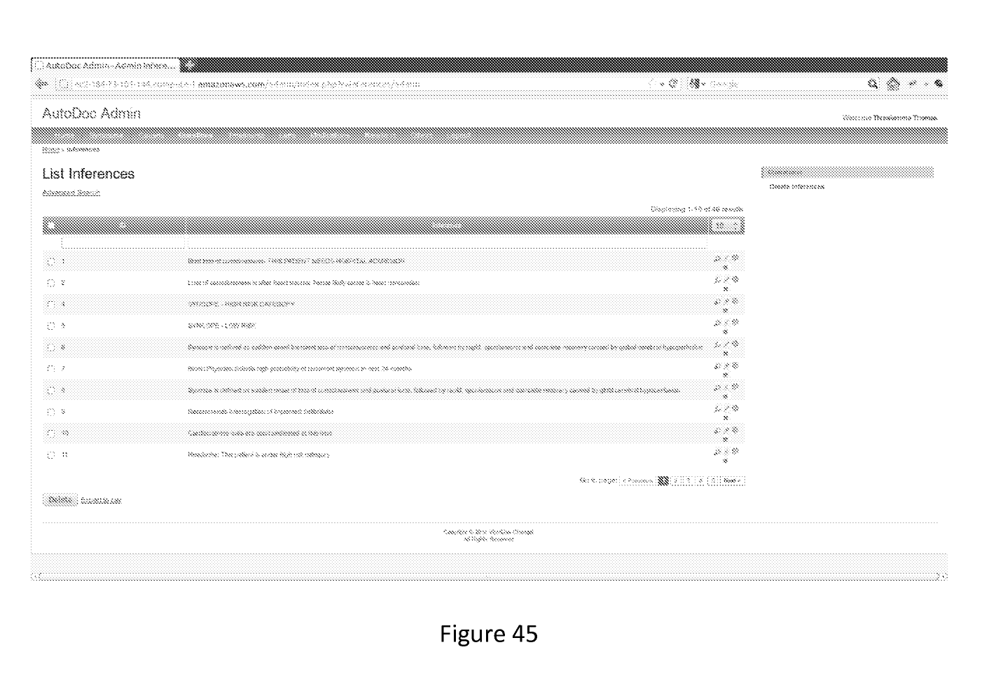

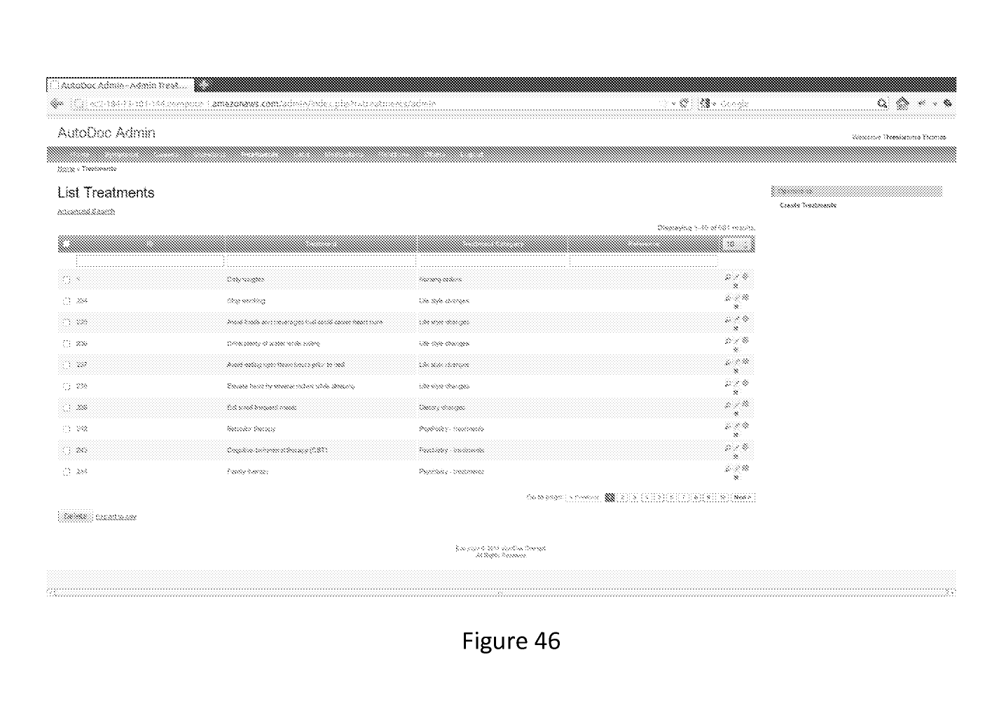

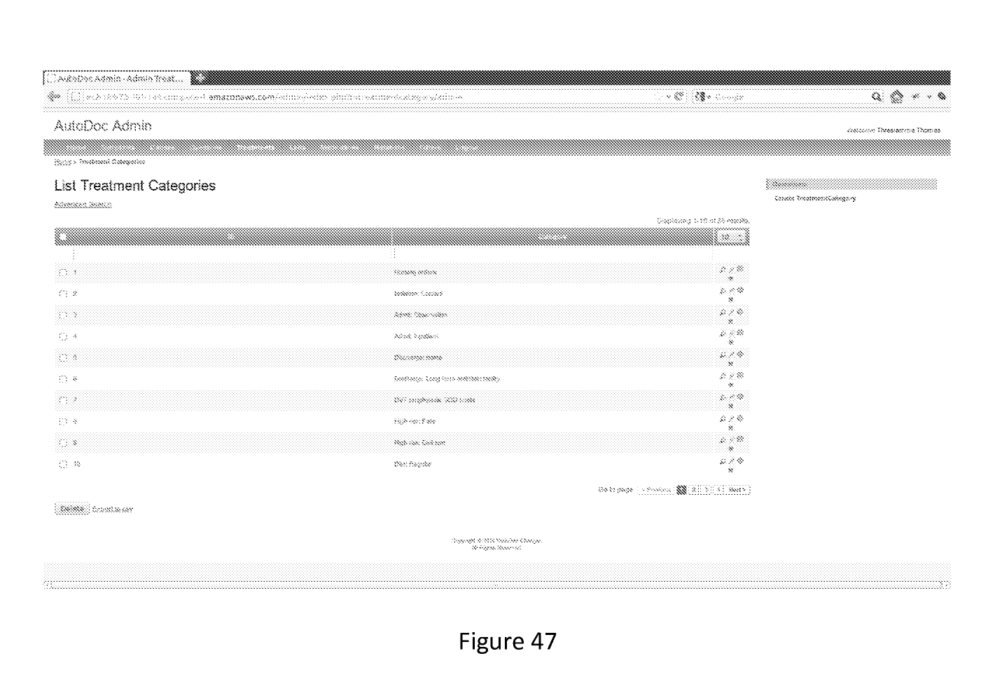

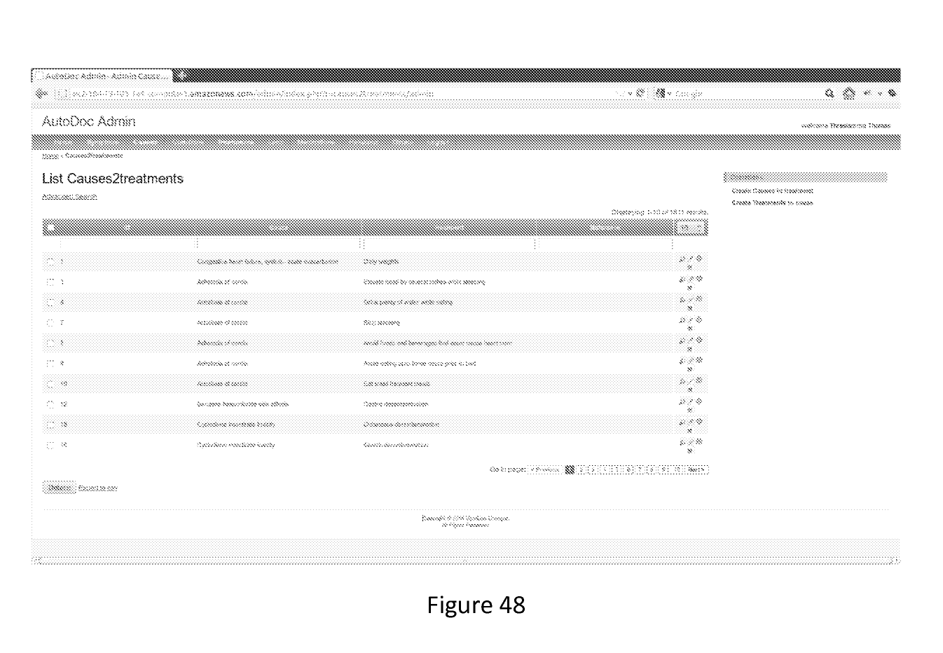

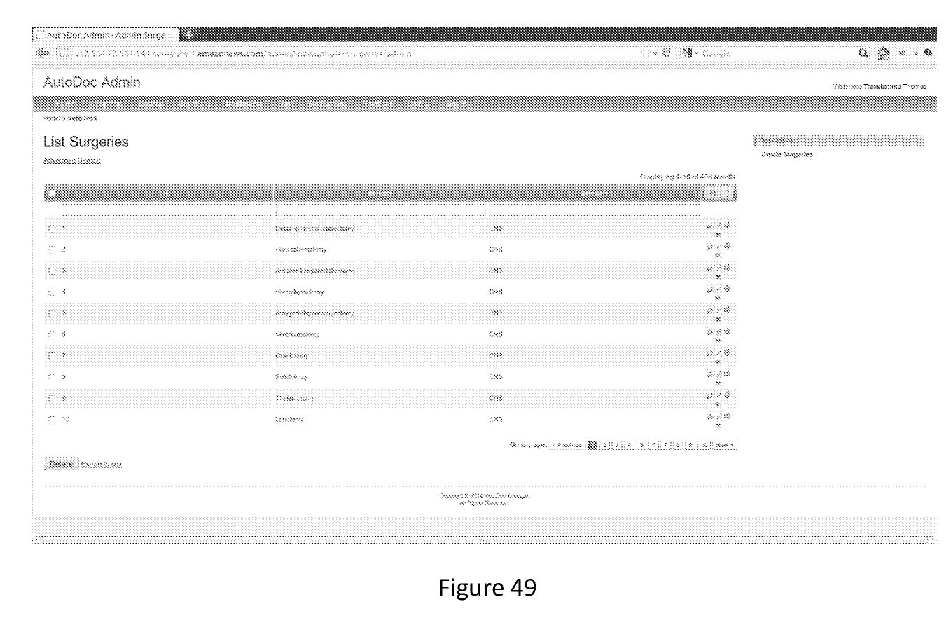

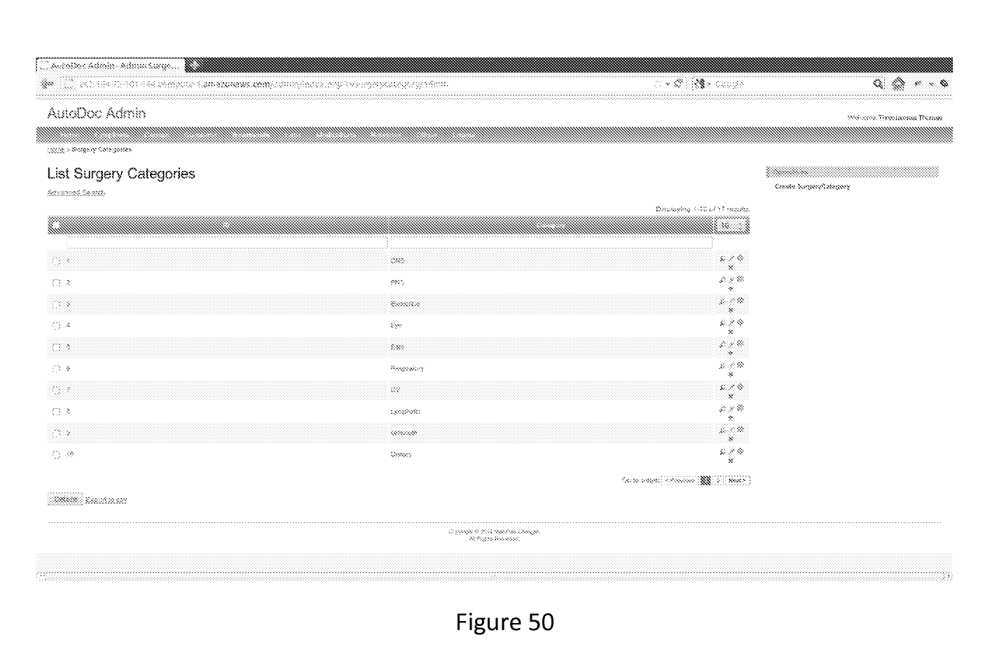

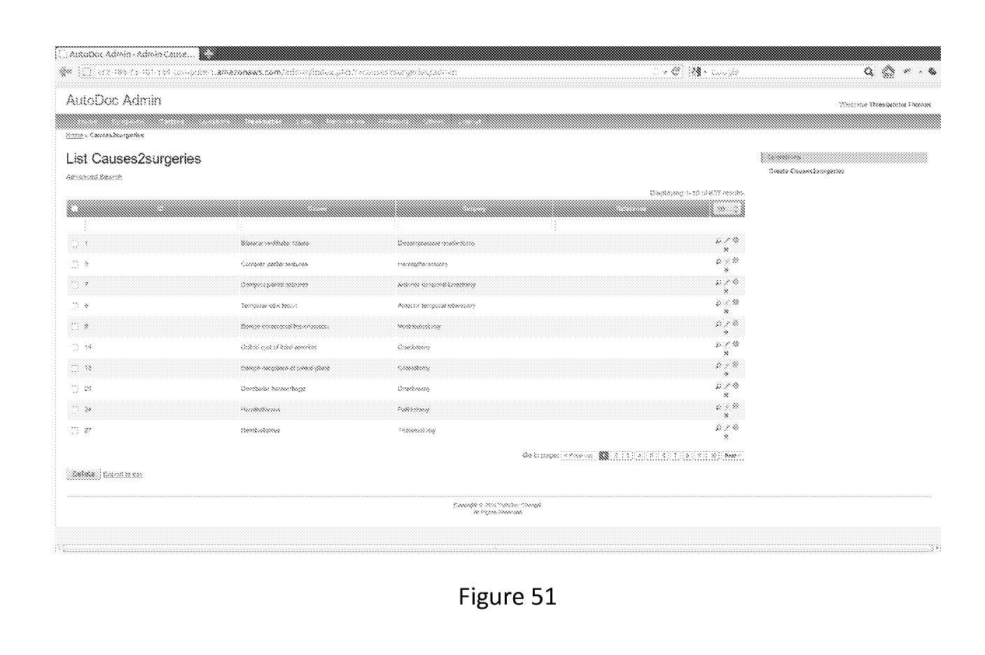

FIG. 30 is a screenshot of the administrator interface where an administrator can create and edit questions, identify cause-question relations, and mark questions high risk if necessary. FIG. 31-32 are screenshots of the administrator interface where an administrator can specify the pre-test probability, a value between 0 and 100, for a cause when a symptom is present. FIG. 33 is a screenshot of the administrator interface where an administrator can create and edit likelihood ratios to control how the post-test probability of a cause changes when a particular question is answered. FIG. 34-35 are screenshots of the administrator interface where an administrator can assign scoring systems to causes. FIG. 36 is a screenshot of the administrator interface where an administrator can assign the treatments that are available for a cause. FIG. 37-39 illustrate how an administrator can assign the surgeries that are required to be performed for a cause, complications associated with a cause, and durations for a cause. FIG. 40-41 are screenshots of the administrator interface where an administrator can assign a likelihood ratio to a cause when another cause or medication exists in the past medical history of the patient. FIG. 42-44 show how an administrator can create questions that the system needs to ask, answer options for each question, categorize them, as well as configuring the answers of questions, linking answers to symptoms, past medical history, family history, medication history, and sorting the answer order display. FIG. 45 is a screenshot of the administrator interface where an administrator can create and edit inferences for causes. FIG. 46-48 shows how an administrator can create and edit treatments, categorize them, and link them to causes. FIG. 49-51 illustrate how an administrator can use the interface to create and edit surgeries, categorize them, and link them to causes.

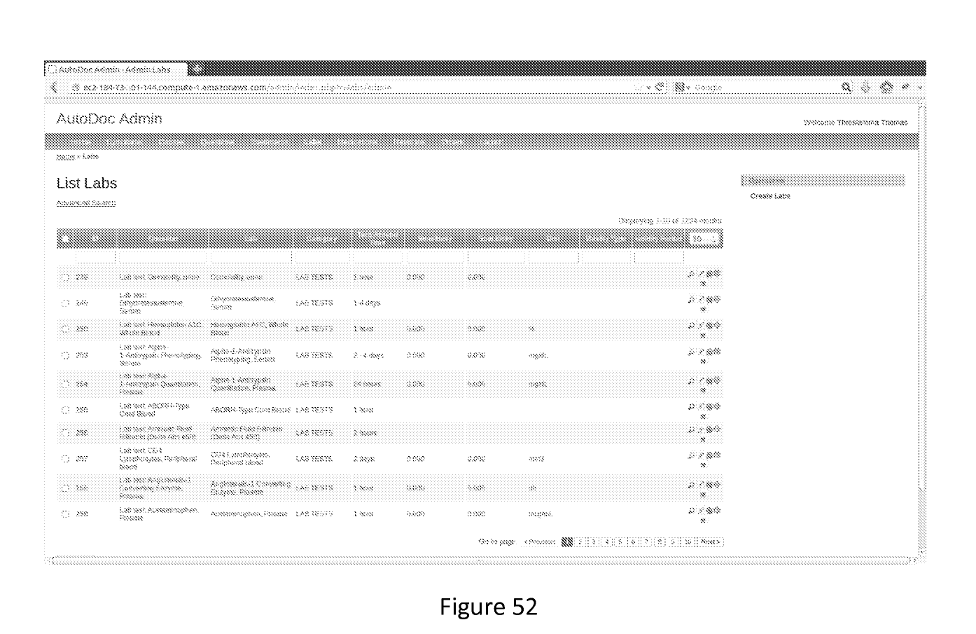

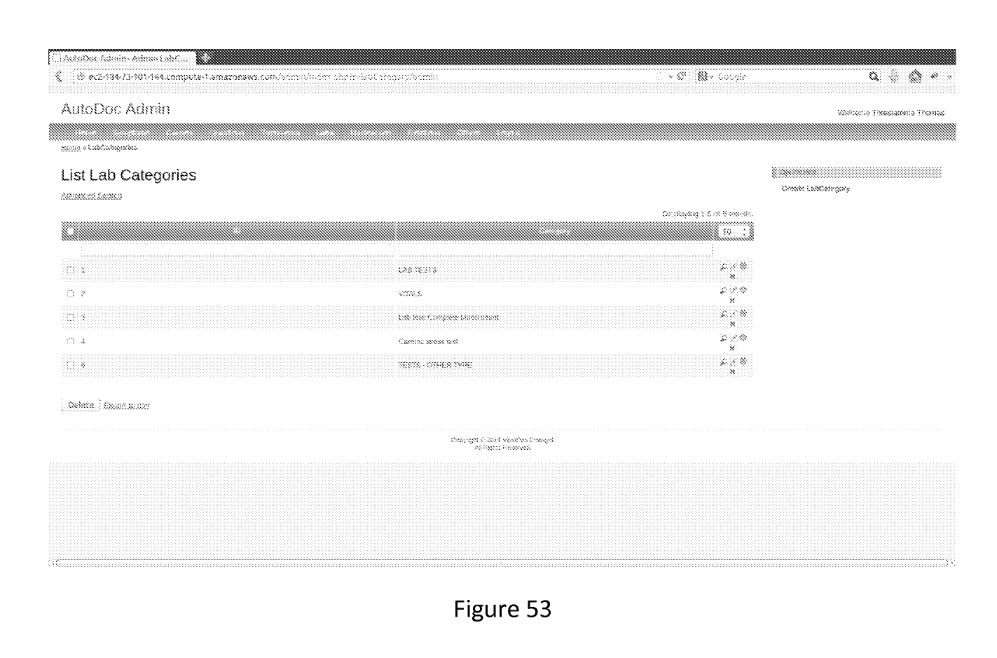

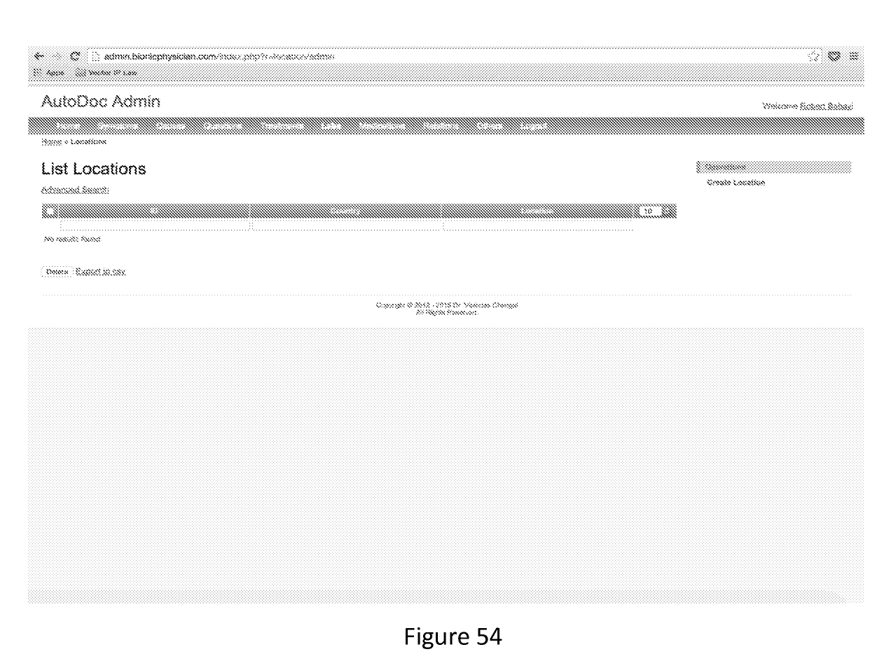

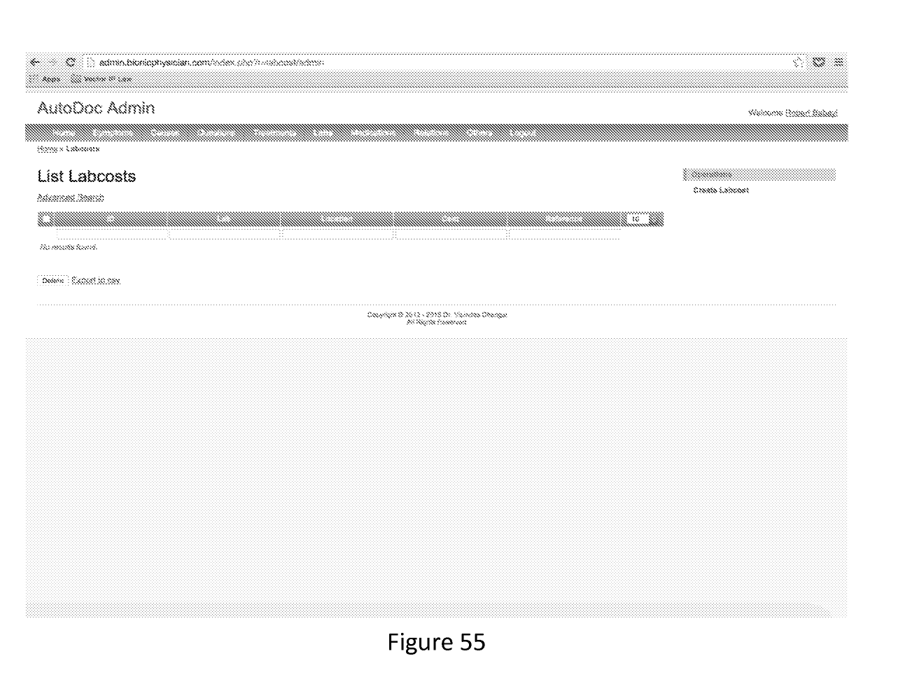

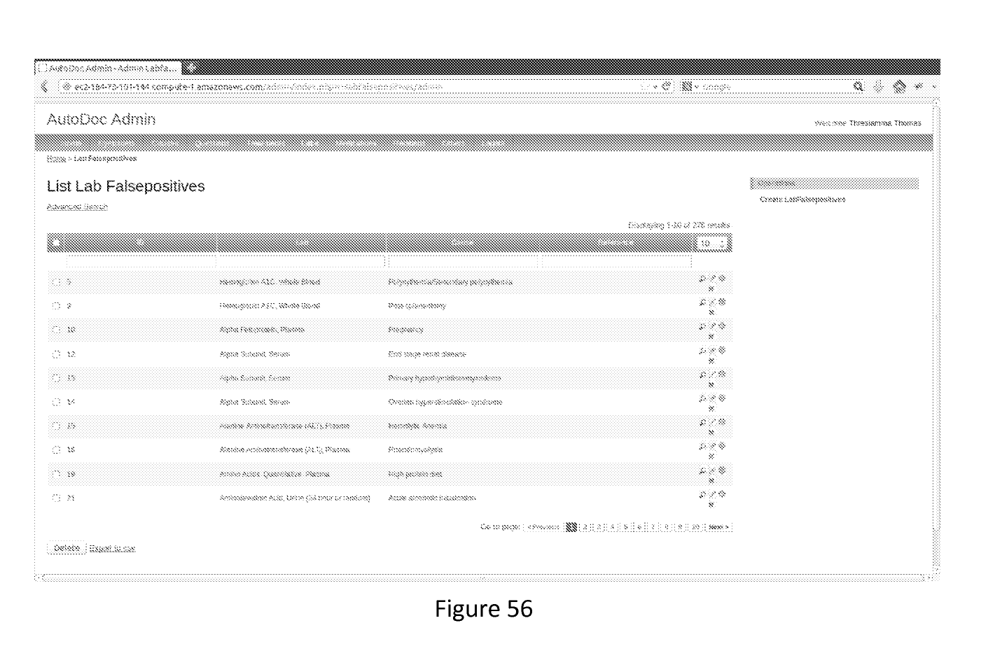

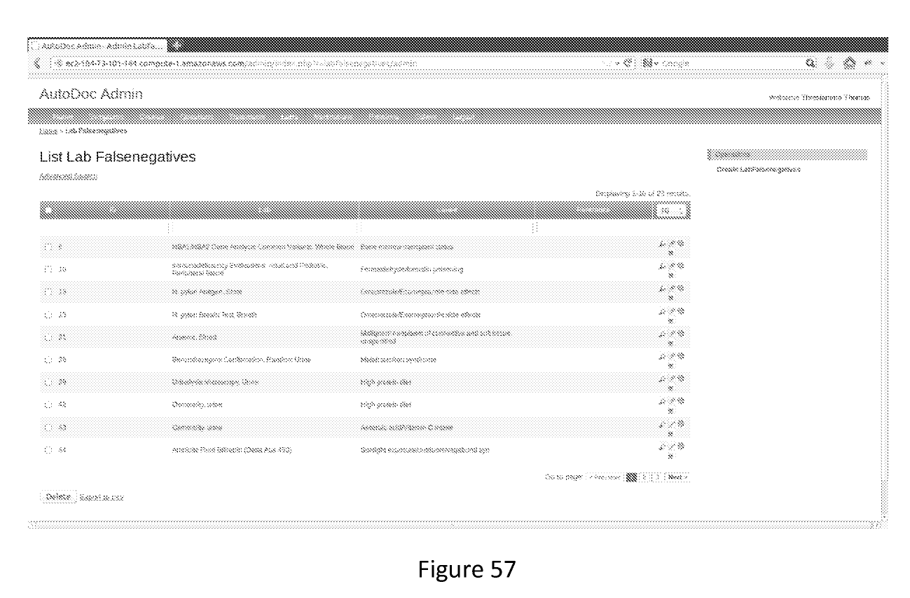

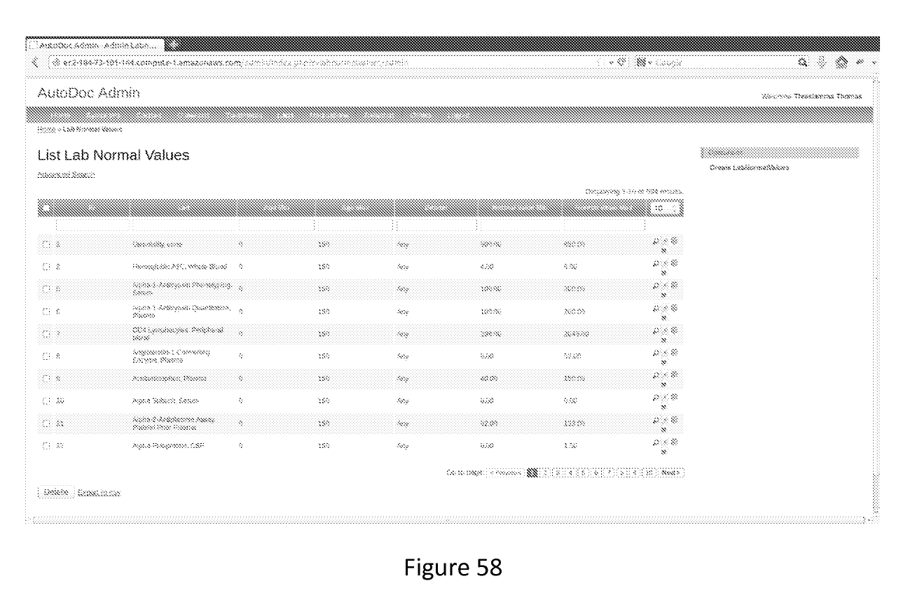

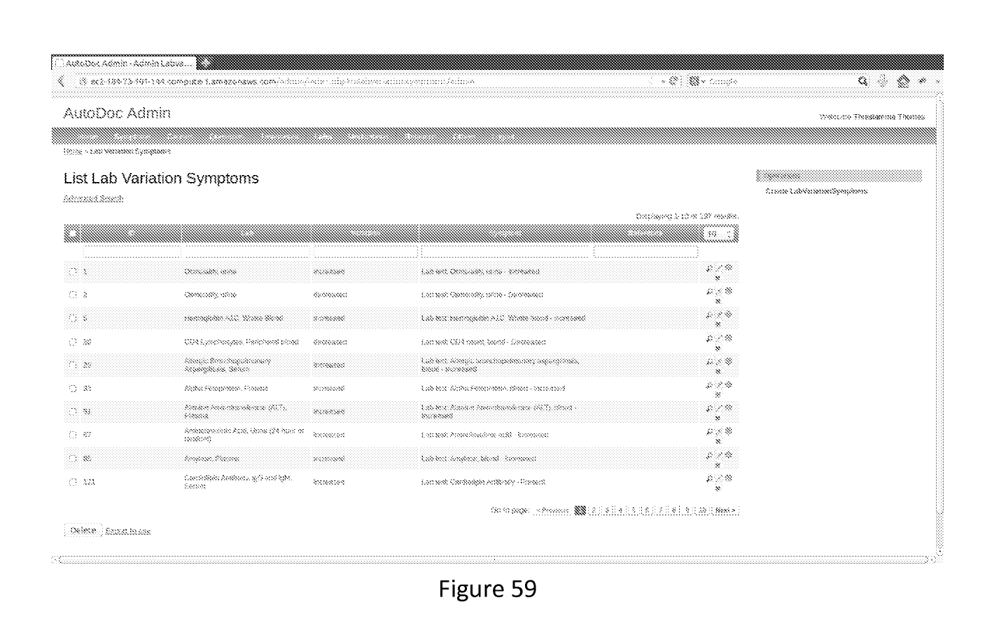

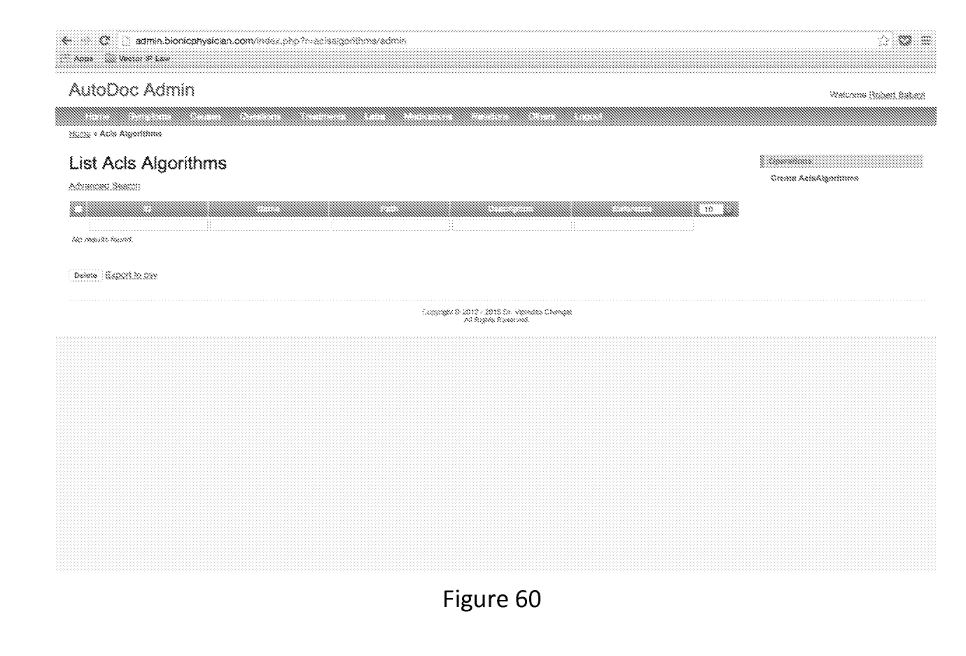

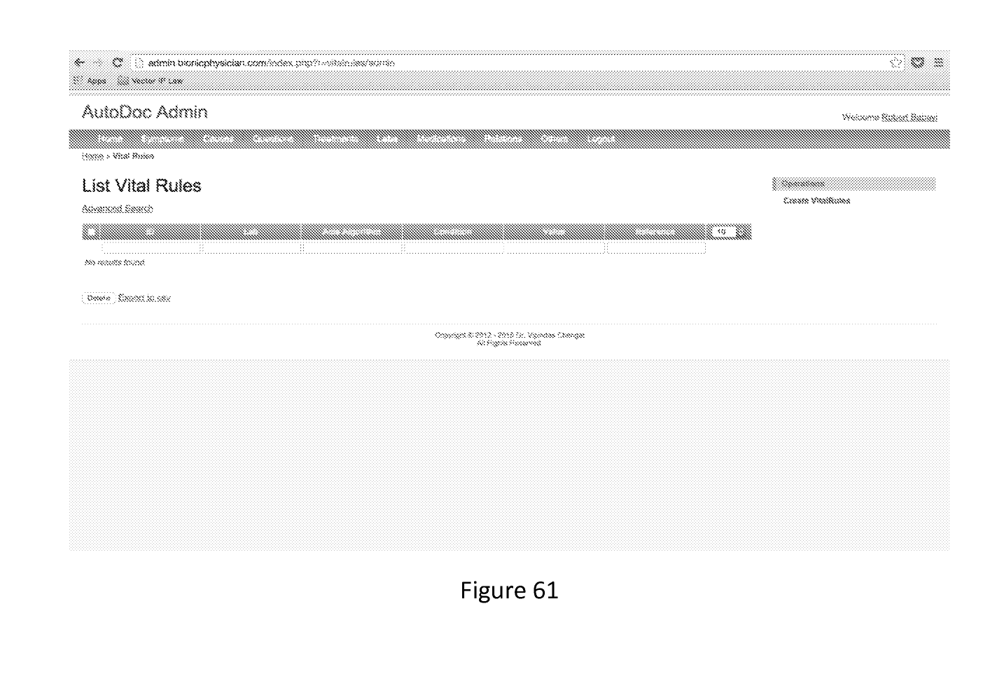

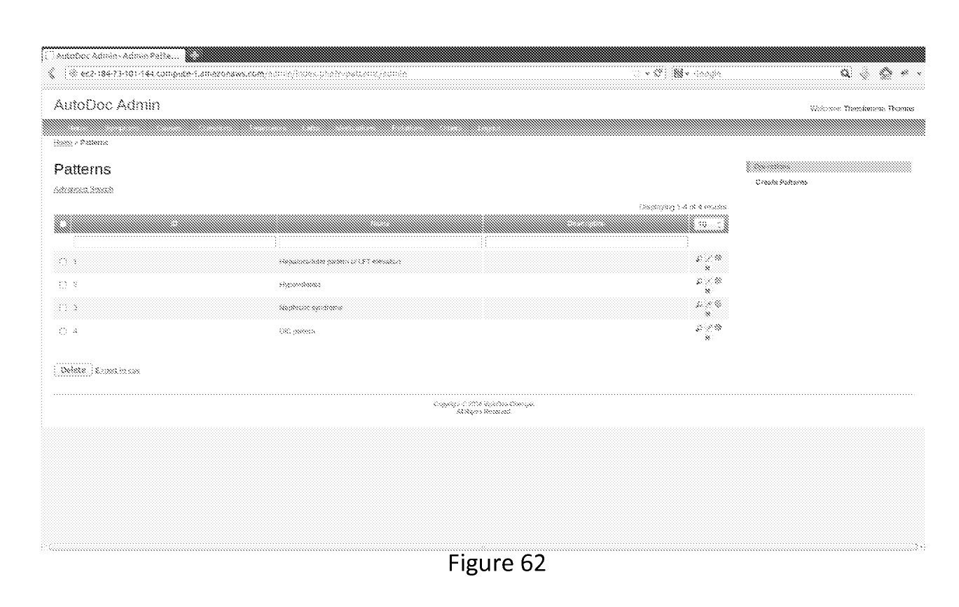

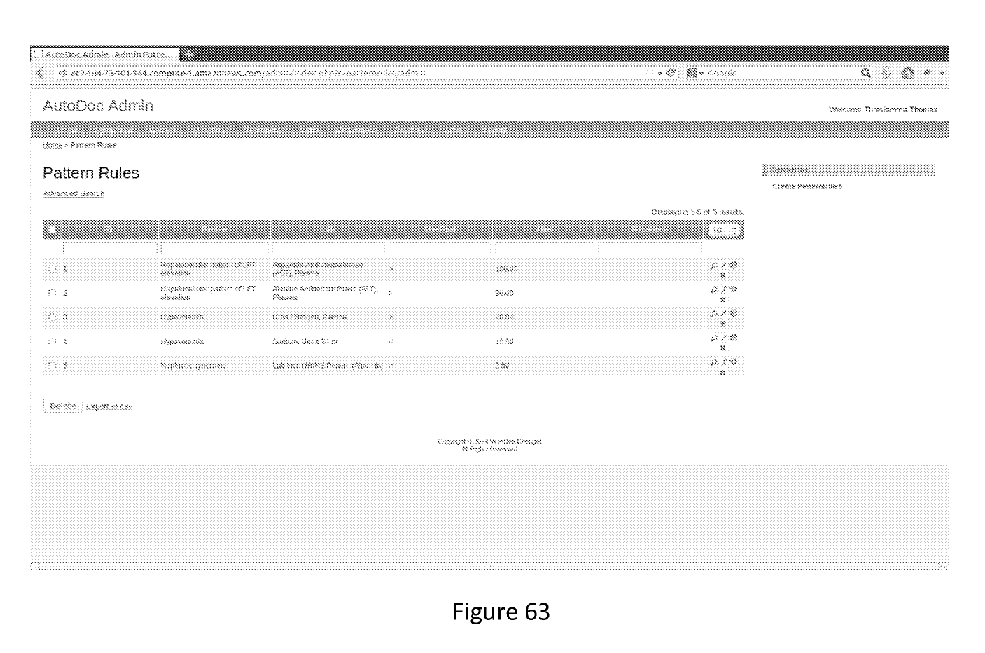

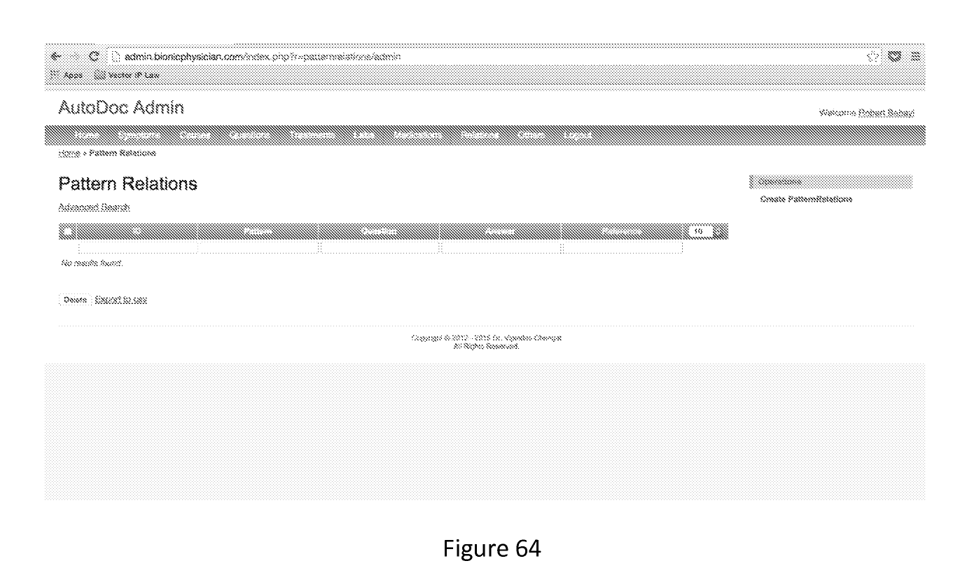

FIG. 52-55 shows how an administrator can create and edit lab tests, categorize them, and enter lab costs for countries and locations for estimating lab costs. An administrator can enter information regarding lab results i.e. normal value range per age group and gender as well as false positives and false negatives according to FIG. 56-58 and further link the variation of lab result from normal values to the related symptom as shown in FIG. 59. FIG. 60-61 illustrate how an administrator can create an ACLS algorithm to create an alert based on vital rules, which trigger an emergency situation. FIG. 62-64 show the interface where an administrator can create lab rules associated with a pattern, which triggers auto-answer for particular questions when that pattern in recognized in a lab result.

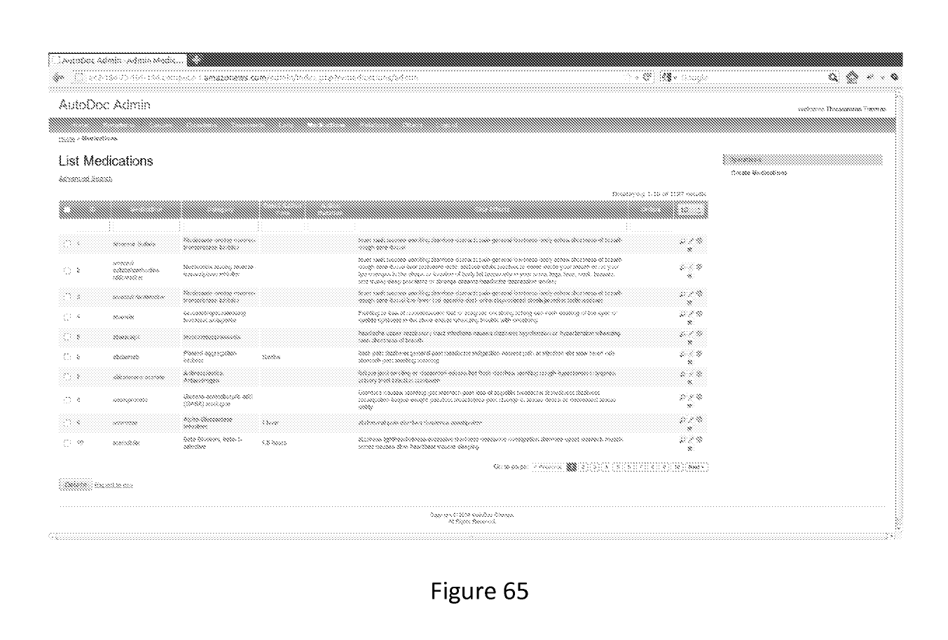

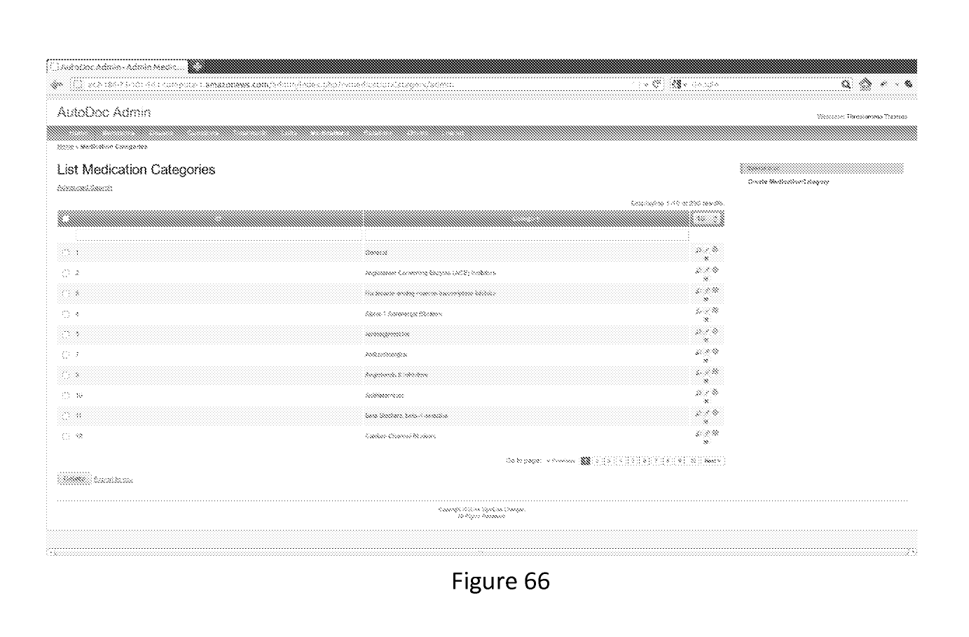

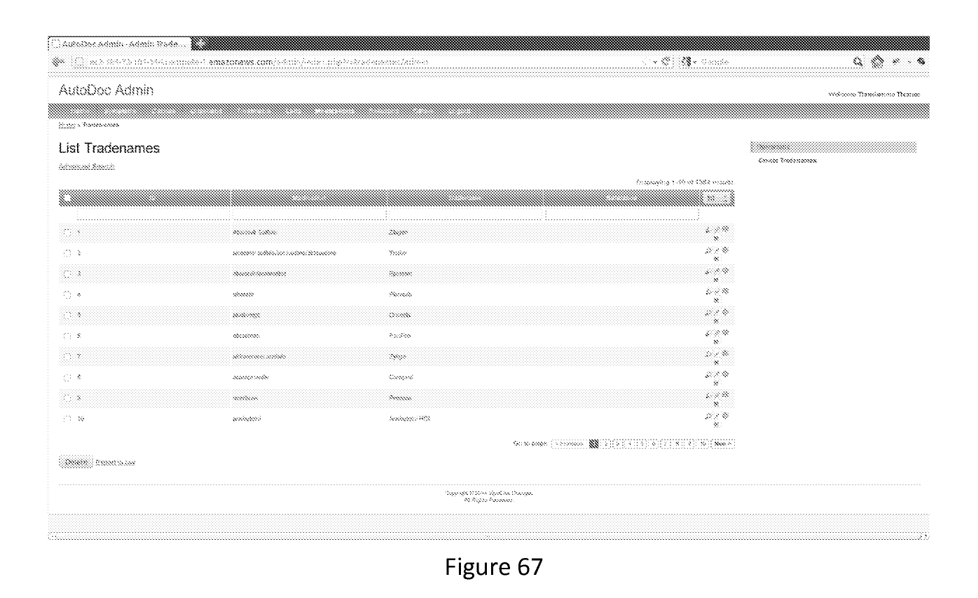

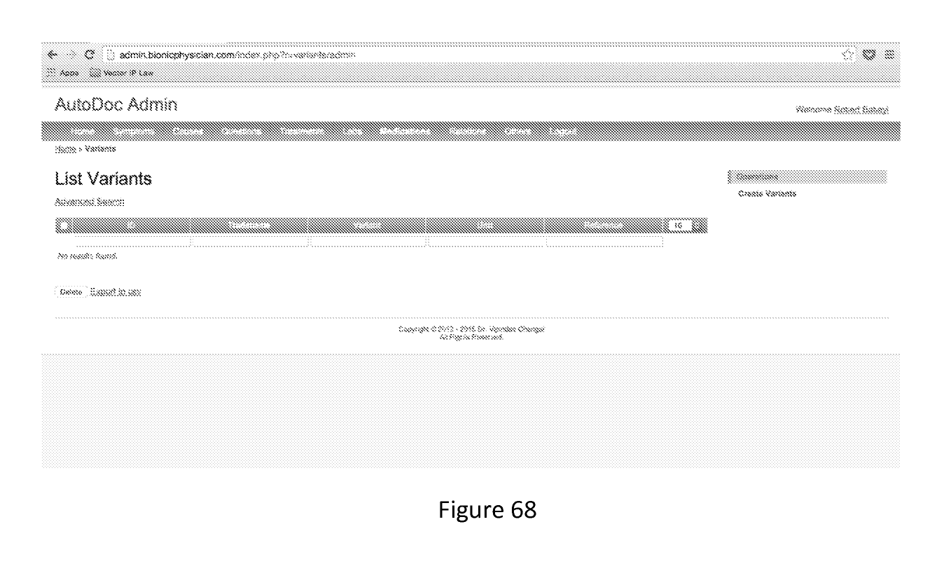

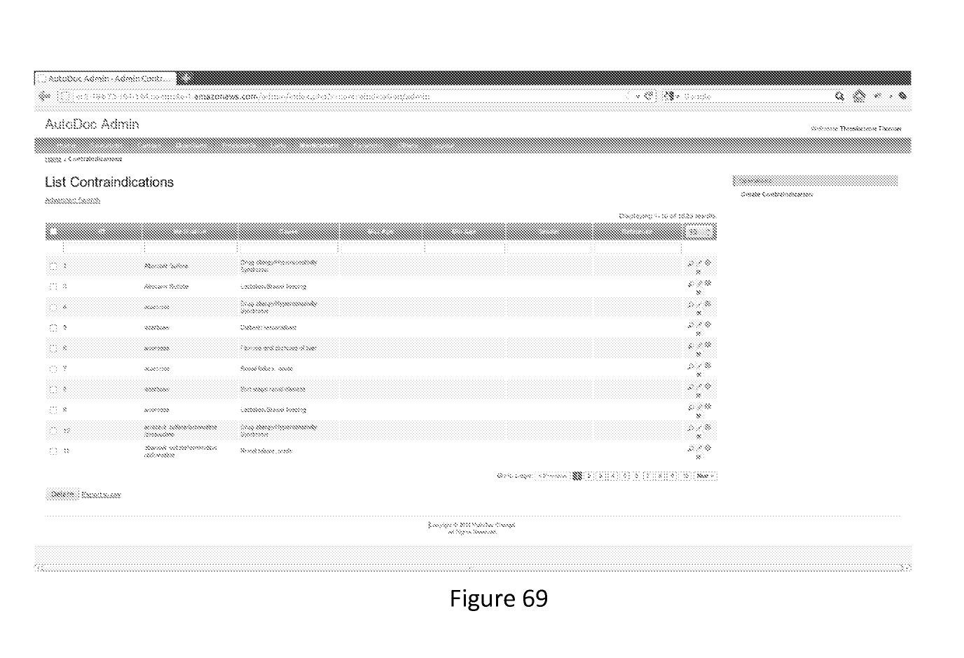

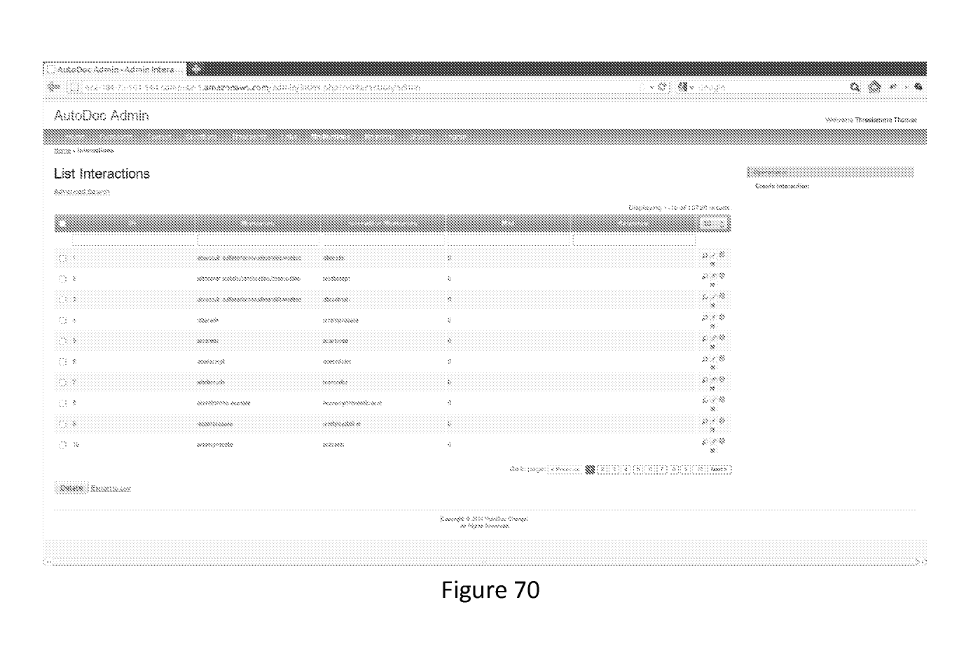

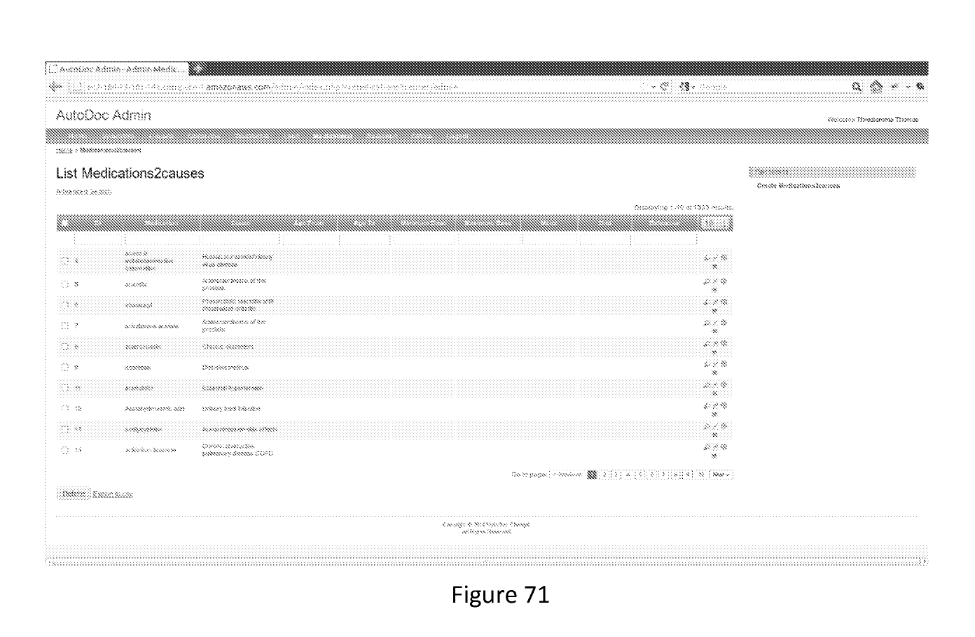

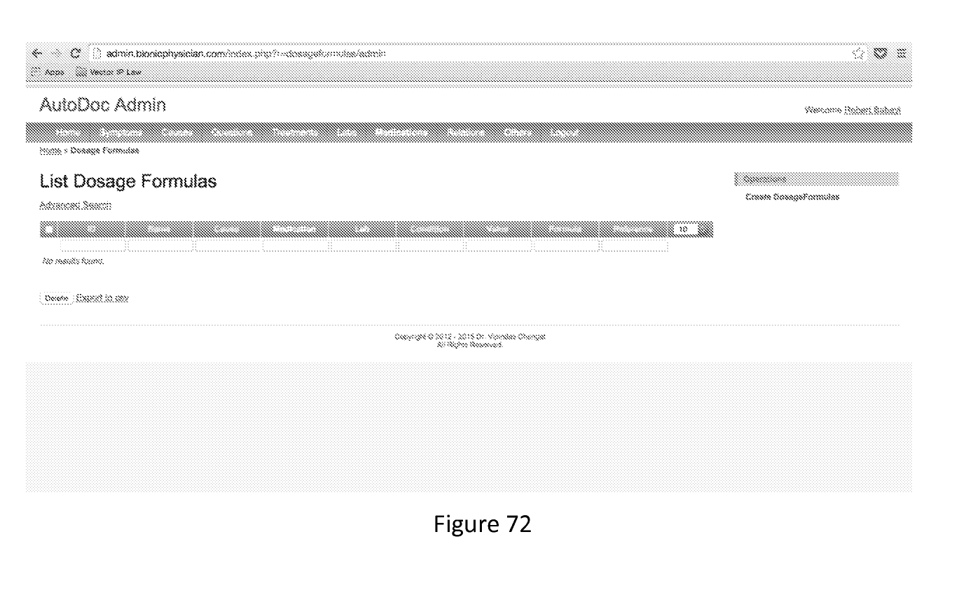

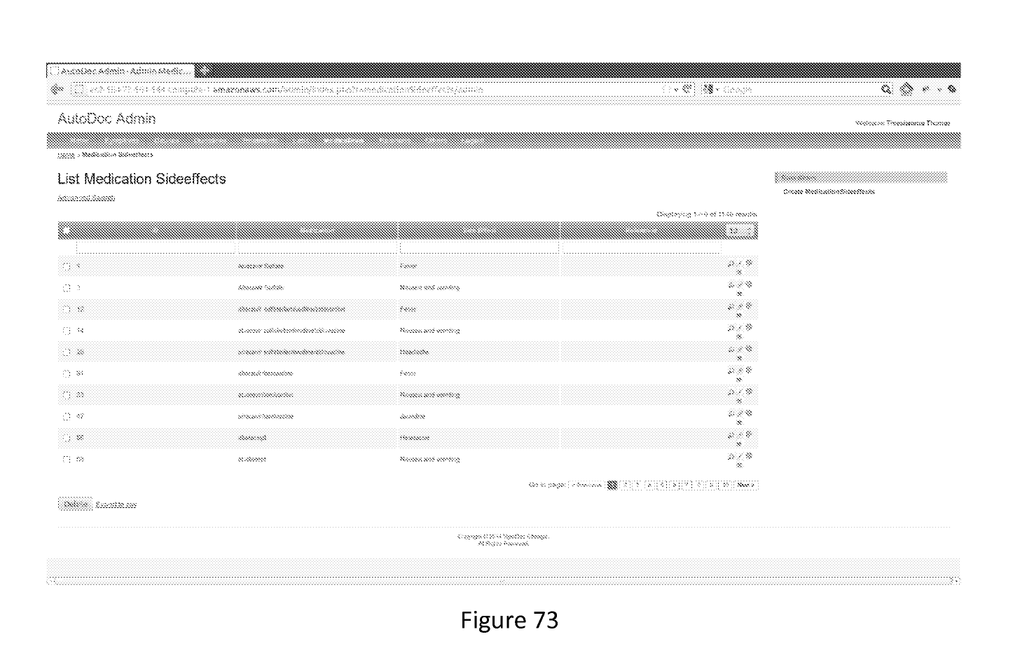

FIG. 65-68 demonstrate how an administrator can create and edit medications, medication trade names, categorize them, and enter multiple variants of a medications trade name, which shows the dosage unit. An administrator can further enter contraindications, which disqualifies a valid medication for a condition based on age range and gender of the patient according to FIG. 69 and can enter interactions between medication chemicals, which can be mild or severe as shown in FIG. 70. FIG. 71-72 describe the way and administrator lists corresponding medications for each cause as well as dosage formulas, which will determine the dosage of medication based on lab values. FIG. 73 shows how an administrator can enter side effects of medicines on the interface.

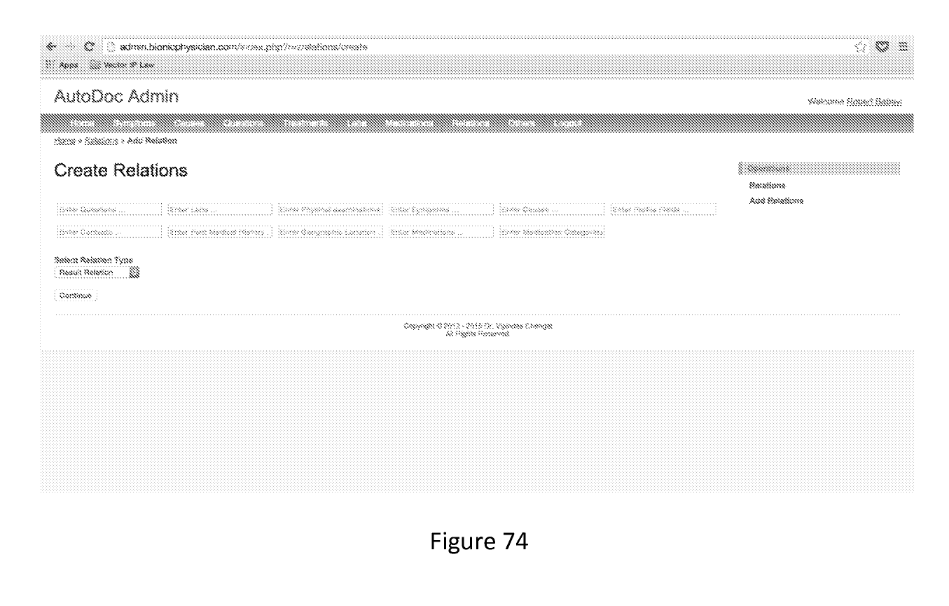

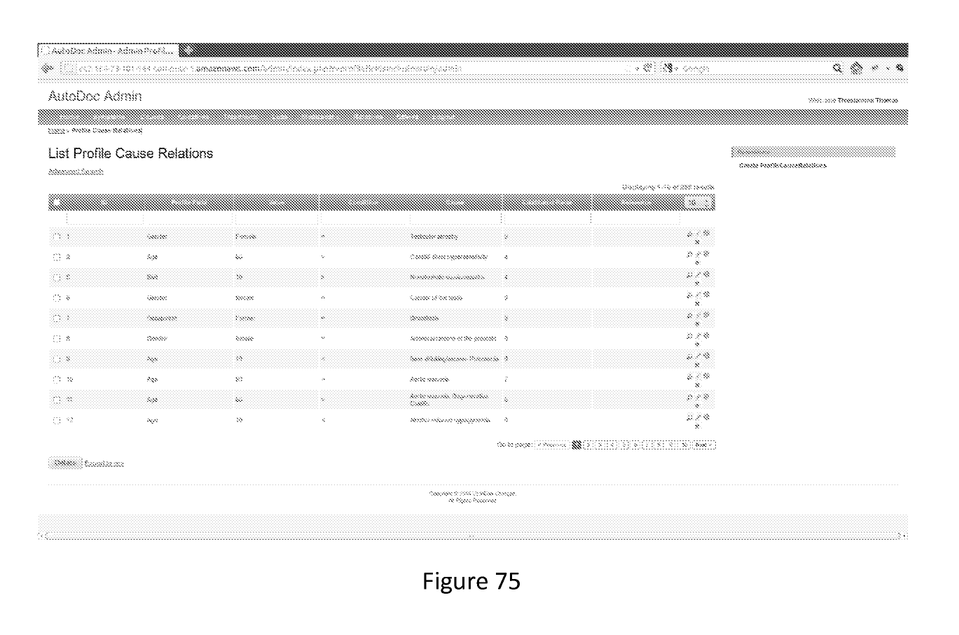

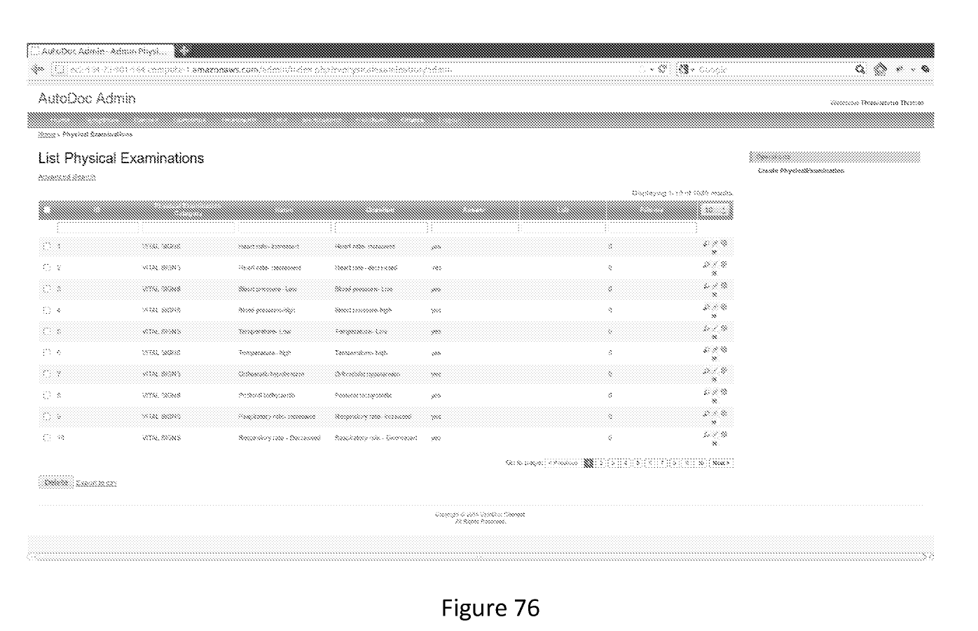

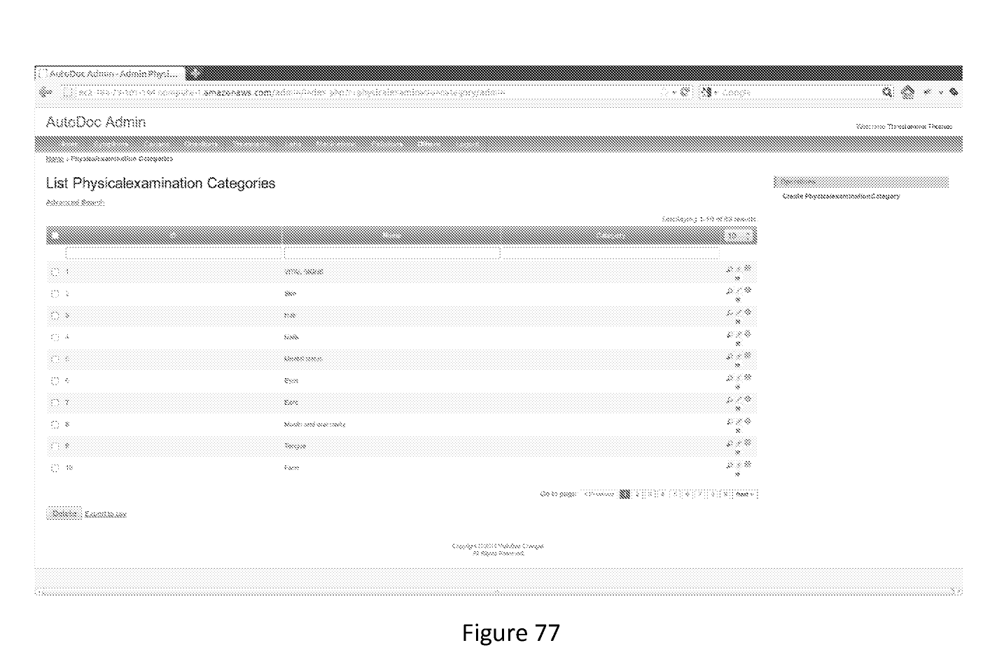

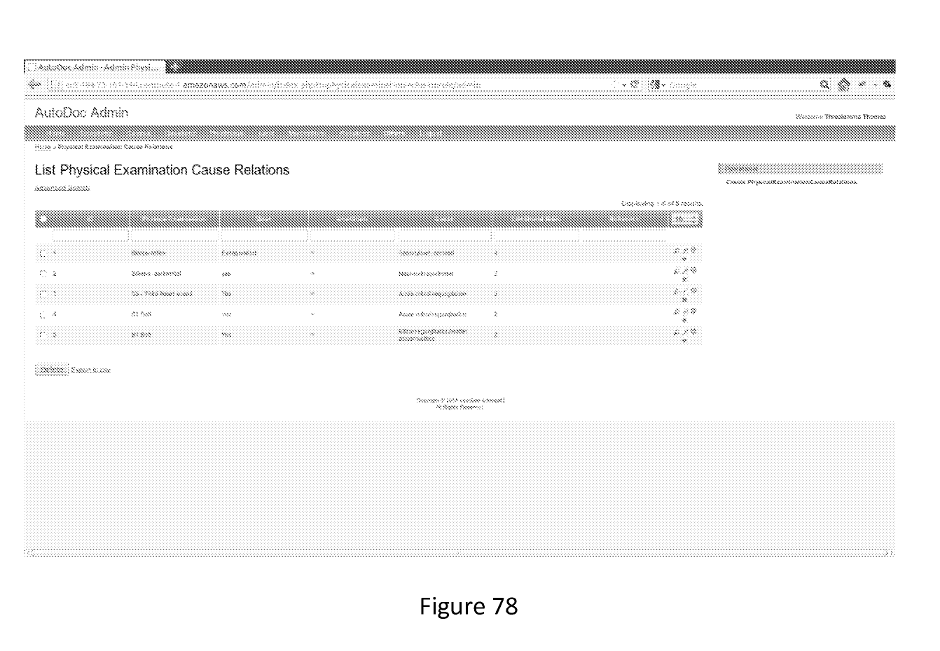

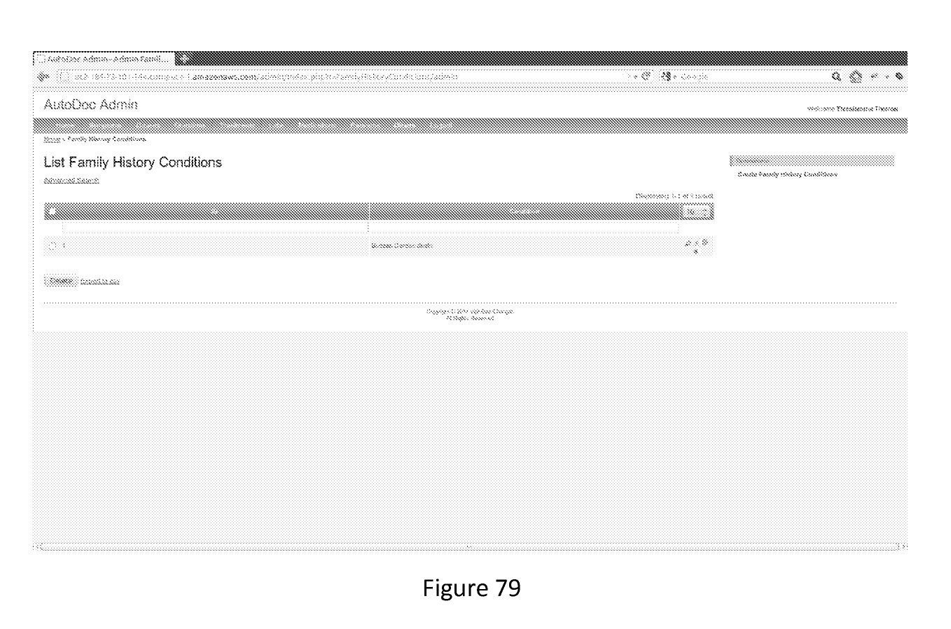

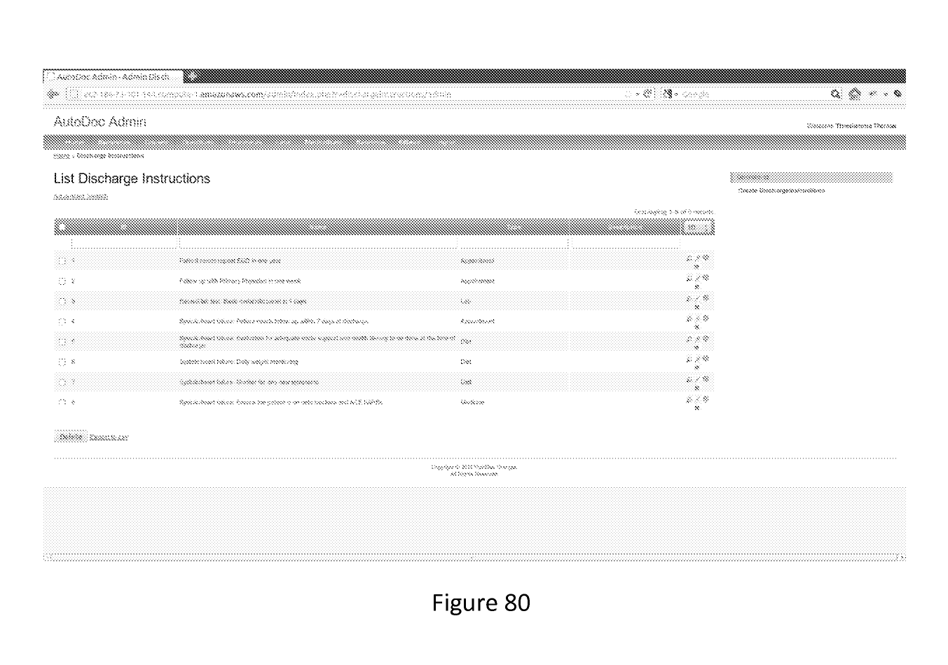

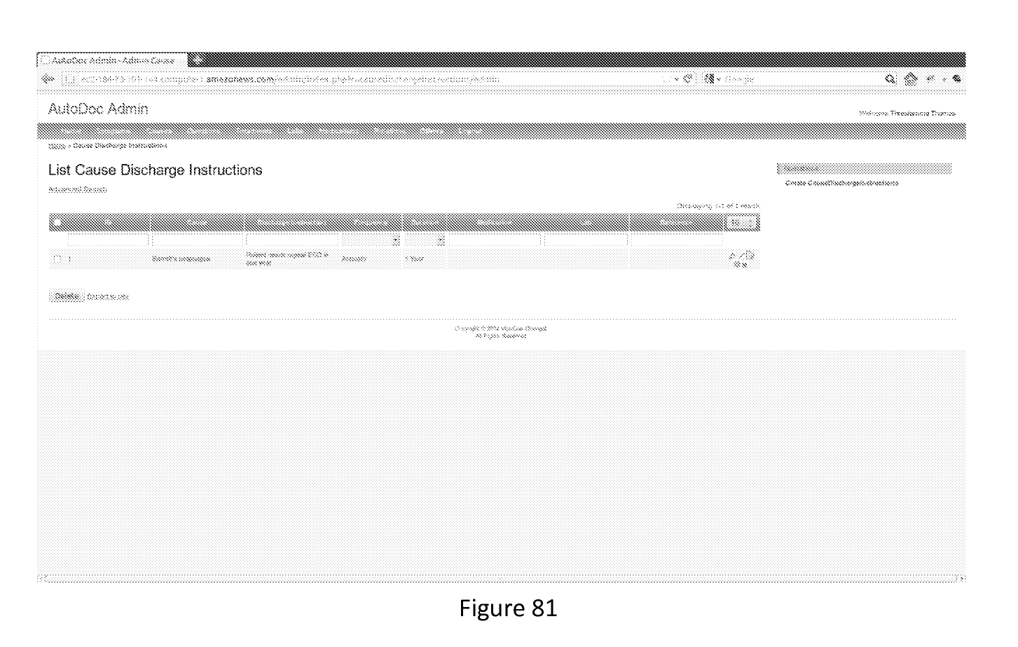

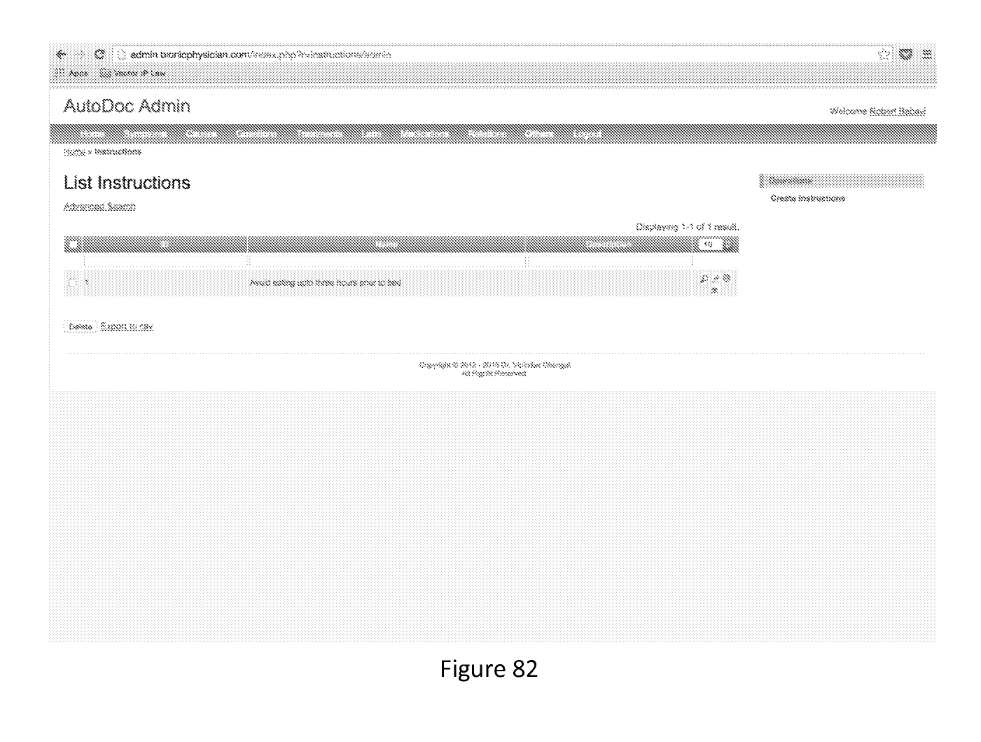

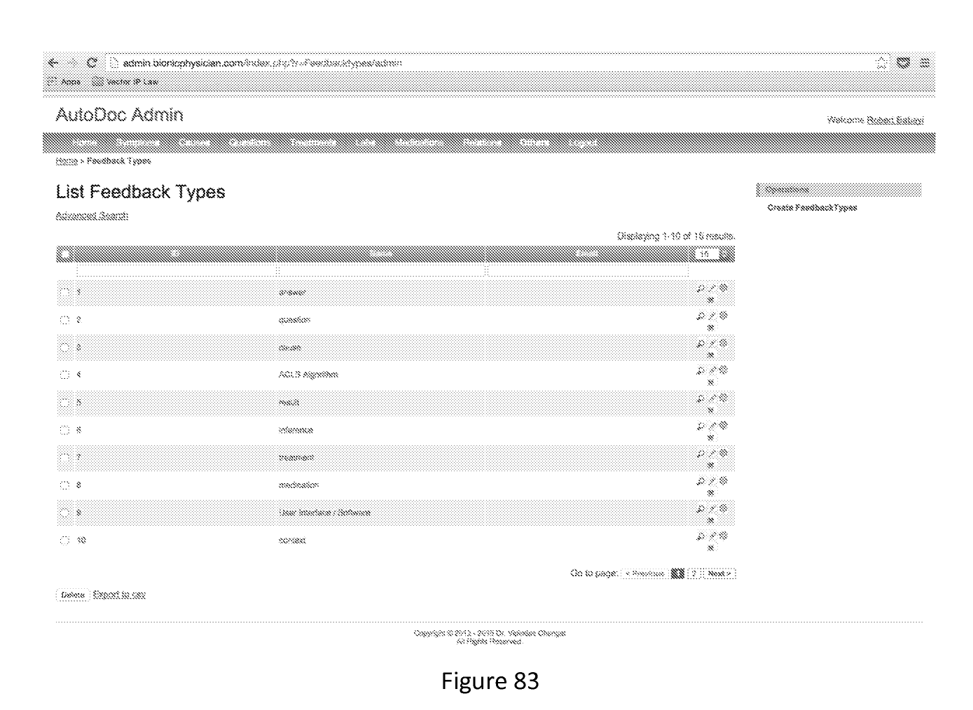

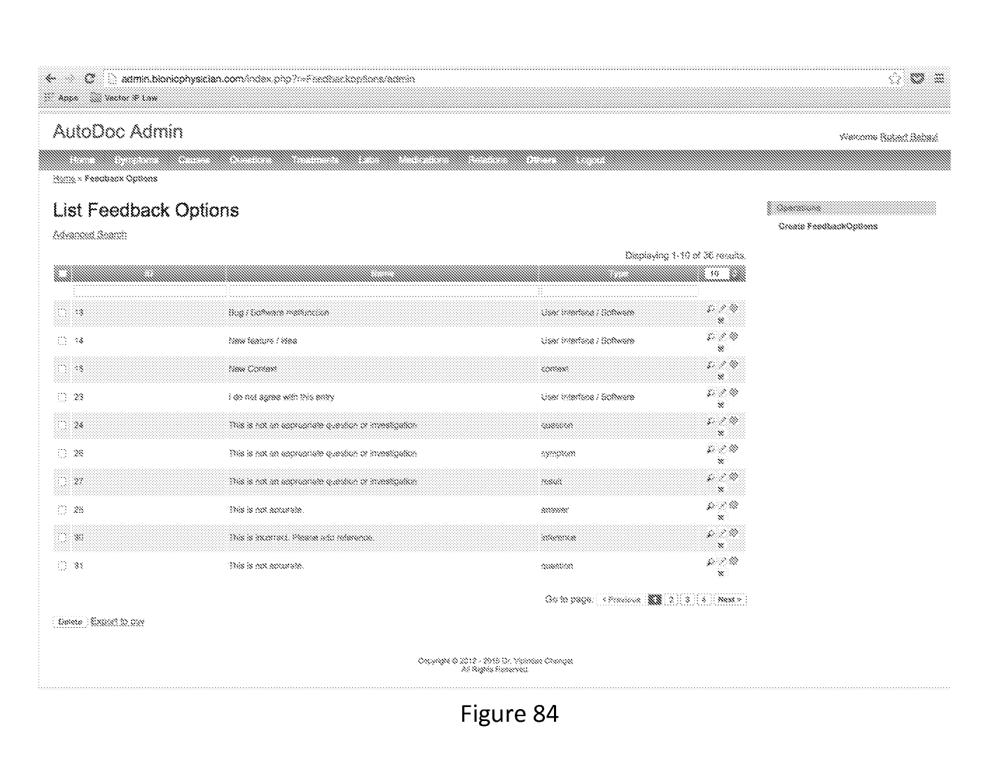

An administrator can look up or create relations of the following types: result relation, question relation, inference relation, risk relation, likelihood ratio relations, and context relations according to FIG. 74. FIG. 75 shows how an administrator can create profile cause relations, which will apply a likelihood ratio to a cause in the possible cause list based on patient profile information. FIG. 76-78 illustrate the way an administrator can create physical examinations, categorize them, link them to answers of questions, and create physical examination cause relations, which will apply a likelihood ratio to a cause in the possible cause list. FIG. 79 describes where an administrator can create and edit family history conditions. FIG. 80-82 illustrate how an administrator can create and edit discharge instructions to be given to a patient at discharge time, which can be medicine, lab, activity, etc., and assign these instructions to causes with frequency and duration, as well as create other instructions when certain conditions are met, such as avoid eating up to three hours before bed. FIG. 83-84 illustrate how an administrator can create and edit feedback types and options, which allow users to give feedback about the system for continual improvement.

Based on the foregoing, it would be appreciated that a cause can have several symptoms, signs and/or lab abnormalities. In one embodiment, various relationships are assigned between a symptom, sign and/or lab abnormalities with a cause. Assigning specific, cardinal and direct relations between a symptom and cause can enable the system to derive appropriate differential diagnosis in the order of relevance.

A direct relation implies that the symptom can be a directly linked with the cause. An indirect relationship, e.g., lack of direct relation implies that the symptom and the cause are related as a complication, for example, a dry mucous membrane and renal failure. Although dry mucous membrane is not a symptom of renal failure, it can point towards volume-depleted status, which can lead to renal failure. This technique enables the relationship between the symptom and cause to be kept although the cause is not considered in the absence of at least one direct symptom. A cardinal symptom is a symptom that must be present in order to even consider a cause. Even though there are multiple symptoms that are directly linked to the cause, if there are cardinal symptoms for the cause and they are not included in the initial query, those causes are not considered. Assigning “specific” to a symptom will make it more relevant if a number of symptoms are being asked as the initial query. A “Specific” designation can be assigned to a symptom or a symptom-cause relationship. This can be derived from a large dataset using statistical methods. System also allows clustering various combinations of symptoms, signs or lab abnormalities, patient markers in order to increase the likelihood of certain causes. Asking contexts early during the analysis allows the system to get to a cause that is relevant to that particular context even before running the entire algorithm. Combining all these strategies allow the HCA to mimic a physician's logic.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A medical diagnosis system, comprising:
one or more databases configured to store a plurality of relational tables within a relational data structure and a non-relational table within a non-relational data structure, wherein the plurality of relational tables comprise:
a symptom table configured to associates a plurality of symptoms having symptom name fields with a corresponding plurality of symptom identifier fields (Symptom ID);
a cause table configured to associate a plurality of causes having caused name fields with a corresponding plurality of cause identifier fields (Cause ID);
a symptom-cause relational table that is linked to the symptom table and the cause table to associate the plurality of cause identifier fields with the plurality of symptom identifier fields, wherein the plurality of symptom identifier fields comprise first foreign keys that link the symptom table to the symptom-cause relational table, and wherein the plurality of symptom identifier fields comprise second foreign keys that link the cause table to the symptom-cause relational table; and
one or more processors that provide interfaces for receiving one or more symptom names and presenting one or more cause names based on associations of symptom names and cause names in the non-relational table, wherein the associations of symptom names and cause names in the non-relational table are derived from mapping the plurality of cause name fields in the cause table and the plurality of symptom name fields in the symptom table into the non-relational table, said mapping being based on the association of the plurality of cause identifier fields with the plurality of symptom identifier fields in the symptom-cause relational table.

2. The medical diagnosis system of claim 1, wherein the processor is configured to provide an interface for a plurality of expert feedback, wherein the processor quantifies differences in the plurality of expert feed back for updating the relational tables.

3. The medical diagnosis system of claim 1, wherein the processor applies predictive analytics configured to define decision points that are relevant to clinical decision-making by generating optimal probabilities and likelihood ratios (LRs) through analysis of information contained in a large database.

4. The medical diagnosis system of claim 1, wherein specific and nonspecific symptoms are differentiated using a Boolean property named “specific” for a symptoms object.

5. The medical diagnosis system of claim 1, wherein a group of symptoms is identified that represent a unique pattern using a classic presentations table in order to assign a likelihood ratio (LR) to a cause, wherein the classic presentation symptoms table associates classic presentation IDs and symptom names in the group.

6. The medical diagnosis system of claim 1, wherein conditional probability is applied in the context of relations between demographic parameters and symptoms (causes?) based on a profile cause relations table containing profile ID, profile value, conditions, likelihood ratio (LR) and cause ID.

7. The medical diagnosis system of claim 1, where a determination is made on whether a symptom is directly linked to a cause or a byproduct of a complication of that cause based on one or more profile based cause inclusion and exclusions tables that associate one or more patient profile specific relations to one or more causes.

8. The medical diagnosis system of claim 1, wherein the processor further provides interfaces for presenting questions and receiving answers based on a symptom-questions table that contains questions associated with a symptom and a question-answer table that associates answers with a question.

9. The medical diagnosis system of claim 8, wherein an answer table that contains a symptom ID that associates an answer with a symptom if the answer is the same as the symptom.

10. The medical diagnosis system of claim 8, wherein a physical signs and labs table contains a question ID field that associates a question to be asked with a physical sign or lab result.

11. The medical diagnosis system of claim 8, the probability of causes is based on likelihood ratios for questions answered.

12. The medical diagnosis system of claim 8, wherein questions generated based on a scoring systems associated with at least one of lab values, physical examinations, patient profile information, symptom context, medical history, medications or family history.

13. The medical diagnosis system of claim 1, wherein one or more contextual relationships between symptoms and symptom contexts are identified, wherein those contextual relations that are common to a maximum number of symptoms are given higher priority so that the effect of combination of symptoms gets higher probability.

14. The medical diagnosis system of claim 1, wherein a symptom qualifier having high immediate impact in reaching a final diagnosis is identified, and wherein a symptom-qualifier rules table is used to assign an LR to a given symptom and a symptom qualifier.

15. The medical diagnosis system of claim 1, wherein a wherein a symptom replacement rules table is used to replace a symptom or group of symptoms with another symptom by identifying a pattern.

16. The medical diagnosis system of claim 1, wherein relations between causes and medical histories are quantified to assign LR to a cause.

17. The medical diagnosis system of claim 1, wherein relations between medications and causes are identified via a medication side effects table that contains a lists side effects of a medication.

18. The medical diagnosis system of claim 1, further including a medication interactions table that contains a list of medications that interact with a given medication.

19. The medical diagnosis system of claim 1, further including a cause-to-cause relation table that contains hierarchical list of causes and sub-causes.

20. The medical diagnosis system of claim 1, further including a lab false positives and lab false negative table that contains a list of false positive and false negative for a given lab respectively.

21. The medical diagnosis system of claim 1, wherein the processor is configured to use natural language processing to derive at relations between causes and symptoms.

22. The medical diagnosis system of claim 1, wherein the processor is configured to rules in and rules out causes based on information contained in an electronic health records.

23. The medical diagnosis system of claim 1, wherein the processor is configured to accesses published clinical cases for incorporating clinical logic that minimizes clinical error.

24. The medical diagnosis system of claim 1, wherein the processor further provides an interface for receiving at least one or more markers, symptom durations, symptom qualifiers and symptom contexts before presenting the one or more cause names.

25. The medical diagnosis system of claim 24, wherein a marker relate to one or more of age, geography, sex and medical history of a patient.

26. The medical diagnosis system of claim 24, wherein a symptom qualifier comprises a high value data related to a symptom that can be used to make a final diagnosis.

27. The medical diagnosis system of claim 24, wherein a symptom context relates to one or circumstances under which a symptom occurs.

28. The medical diagnosis system of claim 1, wherein the processor is responsive to one or more exclusion causes and rule tables that contain fields for exclusion of causes based on the presence or absence of one or more symptoms.

29. The medical diagnosis system of claim 1, wherein information contained in a negative symptom table are used to reduce the probability of presenting a cause name.

30. The medical diagnosis system of claim 1, wherein processor calculates the probability of a cause occurrence based on the number of symptoms that are present for a given cause.

31. The medical diagnosis system of claim 1, wherein a cause has several symptoms, wherein various relationships are assigned between a symptom and several symptoms, wherein a direct relations between a symptom and a cause is used to derive differential diagnosis in order of relevance.

32. The medical diagnosis system of claim 31, wherein a symptom comprises at east one of specific symptom or cardinal symptom.

33. The medical diagnosis system of claim 31, wherein an indirect relationship between a symptom and a cause is used to determine a complication.

34. The medical diagnosis system of claim 31, wherein a “Specific” designation is assigned to a symptom or a symptom-cause relationship.

35. The medical diagnosis system of claim 31, wherein assigning “specific” to a symptom makes such symptom more relevant if a number of symptoms are present.
